(19) United States
(12) Patent Application Publication
(10) Pub. No.: US 2013/0196150 A1
(43) Pub. Date: Aug. 1, 2013

(54) PHYSICALLY FUNCTIONAL FLAME-RETARDANT POLYMER MEMBER AND CHEMICALLY FUNCTIONAL FLAME-RETARDANT POLYMER MEMBER

(71) Applicants: Yusuke Sugino, Ibaraki-shi (JP); Kunio Nagasaki, Ibaraki-shi (JP); Kohei Doi, Ibaraki-shi (JP); Takafumi Hida, Ibaraki-shi (JP); Atsushi Takashima, Ibaraki-shi (JP); Asami Kubo, Ibaraki-shi (JP)

(72) Inventors: Yusuke Sugino, Ibaraki-shi (JP); Kunio Nagasaki, Ibaraki-shi (JP); Kohei Doi, Ibaraki-shi (JP); Takafumi Hida, Ibaraki-shi (JP); Atsushi Takashima, Ibaraki-shi (JP); Asami Kubo, Ibaraki-shi (JP)

(73) Assignee: NITTO DENKO CORPORATION, Osaka (JP)

(21) Appl. No.: 13/877,391

(22) PCT Filed: Jun. 17, 2011
(86) PCT No.: PCT/JP2011/063877

§ 371 Date: Apr. 2, 2013

(30) Foreign Application Priority Data
Oct. 12, 2010 (JP) 2010-229541
Nov. 1, 2010 (JP) 2010-245165
Nov. 17, 2010 (JP) 2010-256677
Dec. 8, 2010 (JP) 2010-273210
Dec. 8, 2010 (JP) 2010-273211
Dec. 8, 2010 (JP) 2010-273212
Dec. 8, 2010 (JP) 2010-273213
Jan. 11, 2011 (JP) 2011-002850
Jan. 25, 2011 (JP) 2011-012676
Jan. 28, 2011 (JP) 2011-016072

(51) Int. Cl. B32B 27/18

(52) U.S. Cl. CPC B32B 27/18
USPC 428/339; 428/688

(57) ABSTRACT

Provided is a flame-retardant member having physical functionality or chemical functionality, flexibility, and a high level of flame retardancy. The physically functional flame-retardant polymer member includes a polymer layer (B), a flame-retardant layer (A), and a physically functional layer (L) in the stated order, in which the flame-retardant layer (A) includes a layer containing a layered inorganic compound (f) in a polymer. The chemically functional flame-retardant polymer member includes a polymer layer (B), a flame-retardant layer (A), and a chemically functional layer (L) in the stated order, in which the flame-retardant layer (A) includes a layer containing a layered inorganic compound (f) in a polymer.

### TECHNICAL FIELD

The present invention relates to a physically functional flame-retardant polymer member and a chemically functional flame-retardant polymer member. The physically functional flame-retardant polymer member of the present invention is excellent in physical functionality, transparency, and flexibility, and can impart physical functionality to various adherends and make the various adherends flame-retardant by being attached to the various adherends. The chemically functional flame-retardant polymer member of the present invention is excellent in chemical functionality, transparency, and flexibility, and can impart chemical functionality to various adherends and make the various adherends flame-retardant by being attached to the various adherends.

### BACKGROUND ART

Criteria for combustibility are classified into five stages, i.e., noncombustible, extremely flame-retardant, flame-retardant, slow-burning, and combustible in order of decreasing difficulty in combustion. In a printed matter to be attached to a building material such as an interior material, exterior material, or decorative laminate for a building or housing, or to an interior material or glass portion in a carrier such as a railway vehicle, a ship, or an aircraft, flame retardancy that can be adopted is specified for each of its applications.

A printed matter to be attached to a wall surface in an ordinary shop or the like, a wall surface in a railway vehicle, or a glass portion inside or outside the railway vehicle is as described below. A pattern to be displayed is printed on one surface of a base material sheet such as paper or a film, a pressure-sensitive adhesive layer is provided on the other surface thereof, and the printed matter is attached through the pressure-sensitive adhesive layer. However, such printed matter is combustible and hence most of the printed matter burns out when its combustion is left.

Accordingly, a possible approach to imparting flame retardancy to the base material sheet is to use a flame-retardant resin sheet as the base material sheet. A halogen-based resin such as a fluorine-based resin or a vinyl chloride resin has been conventionally used as such flame-retardant resin sheet (Patent Literature 1). However, the use of a halogen-based flame-retardant sheet has started to be regulated because of such problems of a halogen-containing substance as described below. The substance produces a toxic gas or produces dioxin when burnt. Accordingly, in recent years, the following method has been widely known for imparting flame retardancy to the resin material of a resin sheet (Patent Literature 2). A non-halogen-based flame retardant such as a phosphate or a metal hydrate is added to the resin. In this case, however, a large amount of the flame retardant must be added, with the result that a problem in that the transparency of the resin sheet reduces or a problem such as a defect in the external appearance of the resin sheet is induced.

To laminate, from above the printed matter on which the pattern has been printed, the flame-retardant resin sheet through the pressure-sensitive adhesive layer is also conceivable. In this case, however, a problem in that the clarity of the pattern on the printed matter reduces arises because the resin sheet is laminated on the printed matter through the pressure-sensitive adhesive layer, though flame retardancy is obtained as in the foregoing.

In addition, a material for the flame-retardant resin sheet is a resin. Accordingly, the sheet shows some degree of flame retardancy but does not have such flame retardancy as to be capable of blocking a flame, and hence its flame retardancy when the sheet is in direct contact with the flame is not sufficient.

Further, in recent years, the flame-retardant sheet has been required to have performance such as physical functionality or chemical functionality.

When conductivity can be imparted to the flame-retardant sheet, the sheet is applicable to, for example, use for electrically connecting objects or shielding use for removing the effect of an electromagnetic wave.

In addition, depending on a place where the flame-retardant sheet is used, the sheet may be exposed to such a situation that a fingerprint is liable to adhere to its surface. When the surface of the flame-retardant sheet has a fingerprint adhering thereto, there arises a problem in that its quality in external appearance is impaired, for example. As a result, it becomes difficult to apply the sheet to an application requiring a satisfactory external appearance.

In addition, depending on a place where the flame-retardant sheet is used, the sheet may be exposed to such a situation that its surface is liable to have a flaw. When the surface of the flame-retardant sheet has a flaw, there arise problems in: that the flame-retardant sheet ruptures, for example, from the site of the flaw; that its flame retardancy reduces; and that its design degrades.

In addition, the conventional flame-retardant resin sheet uses a resin material which hardly absorbs ink, and hence it is difficult to directly print on its surface. Accordingly, there arises a problem in that a flame-retardant resin sheet having printing on its surface is difficult to obtain.

In addition, the conventional flame-retardant sheet is still far from being sufficient in flame retardancy.

In addition, the conventional flame-retardant resin sheet does not have antireflection property or is not sufficient in antireflection property in some cases. In those cases, for example, depending on an application, unnecessary reflection of light or the like becomes a problem.

In addition, when light selective transmission property can be imparted to the flame-retardant resin sheet, an optical filter member or the like having flame retardancy can be provided.

In addition, the conventional flame-retardant resin sheet involves a problem in that when the sheet is exposed to an alkaline environment, its surface is corroded, with the result that a wrinkle, a blister, or the like occurs.

In addition, the conventional flame-retardant resin sheet involves a problem in that when the sheet is exposed to an acidic environment, its surface is corroded, with the result that a wrinkle, a blister, or the like occurs.

In addition, the conventional flame-retardant resin sheet involves a problem in that when the sheet is exposed to a solvent such as an organic solvent, its surface is corroded, with the result that a wrinkle, a blister, or the like occurs.

### CITATION LIST

### Patent Literature

[PTL 1] Japanese Patent Application Laid-open No. 2005-015620

[PTL 2] Japanese Patent Application Laid-open No. 2001-040172

### SUMMARY OF INVENTION

### Technical Problem

An object of the present invention is to provide a flame-retardant member having physical functionality or chemical functionality, flexibility, and a high level of flame retardancy.

### Solution to Problem

The inventors of the present invention have made extensive studies to solve the problems, and as a result, have found that the problems can be solved with the following flame-retardant polymer member. Thus, the inventors have completed the present invention.

A physically functional flame-retardant polymer member of the present invention is a physically functional flame-retardant polymer member, including a polymer layer (B), a flame-retardant layer (A), and a physically functional layer (L) in the stated order, in which the flame-retardant layer (A) is a layer containing a layered inorganic compound (f) in a polymer.

In a preferred embodiment, the physically functional layer (L) has a thickness of 0.005 to 100 μm.

In a preferred embodiment, in a horizontal firing test involving horizontally placing the physically functional flame-retardant polymer member of the present invention with its side of the physically functional layer (L) as a lower surface so that the lower surface is in contact with air, placing a Bunsen burner so that a flame port of the Bunsen burner is positioned at a lower portion distant from the lower surface on the side of the physically functional layer (L) by 45 mm, and bringing a flame of the Bunsen burner having a height of 55 mm from the flame port into contact with the lower surface of the physically functional layer (L) for 30 seconds while preventing the flame from being in contact with an end portion of the flame-retardant polymer member, the flame-retardant polymer member has flame retardancy capable of blocking the flame.

In a preferred embodiment, the physically functional layer (L) is a conductive layer (L).

In a preferred embodiment, the conductive layer (L) contains a conductive substance.

In a preferred embodiment, the conductive substance is at least one kind selected from a conductive metal, a conductive metal oxide, a conductive composite metal compound, and a conductive polymer.

In a preferred embodiment, the physically functional layer (L) is an anti-fingerprint layer (L).

In a preferred embodiment, the anti-fingerprint layer (L) is a layer containing at least one kind selected from a fluorine-based resin, a silicone-based resin, and a urethane-based resin.

In a preferred embodiment, the physically functional layer (L) is a hard coat layer (L).

In a preferred embodiment, the hard coat layer (L) is at least one kind selected from a UV-curing type hard coat layer, a thermosetting type hard coat layer, and an organic-inorganic hybrid type hard coat layer.

In a preferred embodiment, the physically functional layer (L) is an ink-absorbing layer (L).

In a preferred embodiment, the ink-absorbing layer (L) contains a water-soluble resin.

In a preferred embodiment, the water-soluble resin is at least one kind selected from polyvinyl alcohol, polyvinylpyrrolidone, polyacrylic acid, polyethylenimine, and a copolymer of vinylpyrrolidone and vinyl acetate.

In a preferred embodiment, the physically functional layer (L) is an inorganic particle-containing layer (L).

In a preferred embodiment, inorganic particles in the inorganic particle-containing layer (L) are at least one kind selected from silica particles and silica-coated particles.

In a preferred embodiment, the inorganic particles each have an average particle diameter of 100 nm or less.

In a preferred embodiment, the physically functional layer (L) is an antireflection layer (L).

In a preferred embodiment, the antireflection layer (L) has a thickness of 0.005 to 30 μm.

In a preferred embodiment, the physically functional layer (L) is a light selective transmission layer (L).

In a preferred embodiment, the light selective transmission layer (L) is at least one kind selected from a metal thin film and a dielectric thin film.

In a preferred embodiment, the light selective transmission layer (L) is a plurality of layers.

The chemically functional flame-retardant polymer member of the present invention is a chemically functional flame-retardant polymer member, including a polymer layer (B), a flame-retardant layer (A), and a chemically functional layer (L) in the stated order, in which the flame-retardant layer (A) is a layer containing a layered inorganic compound (f) in a polymer.

In a preferred embodiment, the chemically functional layer (L) has a thickness of 0.1 to 100 μm.

In a preferred embodiment, in a horizontal firing test involving horizontally placing the chemically functional flame-retardant polymer member of the present invention with its side of the chemically functional layer (L) as a lower surface so that the lower surface is in contact with air, placing a Bunsen burner so that a flame port of the Bunsen burner is positioned at a lower portion distant from the lower surface on the side of the chemically functional layer (L) by 45 mm, and bringing a flame of the Bunsen burner having a height of 55 mm from the flame port into contact with the lower surface of the chemically functional layer (L) for 30 seconds while preventing the flame from being in contact with an end portion of the flame-retardant polymer member, the flame-retardant polymer member has flame retardancy capable of blocking the flame.

In a preferred embodiment, the chemically functional layer (L) is an alkali-resistant layer (L).

In a preferred embodiment, the alkali-resistant layer (L) contains an alkali-resistant resin.

In a preferred embodiment, the alkali-resistant resin is at least one kind selected from a urethane-based resin, a phenol-based resin, and a fluorine-based resin.

In a preferred embodiment, the chemically functional layer (L) is an acid-resistant layer (L).

Ina preferred embodiment, the acid-resistant layer (L) contains an acid-resistant resin.

In a preferred embodiment, the acid-resistant resin is at least one kind selected from a phenol-based resin, a silicone-based resin, and a fluorine-based resin.

In a preferred embodiment, the chemically functional layer (L) is a solvent-resistant layer (L).

In a preferred embodiment, the solvent-resistant layer (L) contains a solvent-resistant resin.

In a preferred embodiment, the solvent-resistant resin is at least one kind selected from a urethane-based resin, a phenol-based resin, a silicone-based resin, and a fluorine-based resin.

### Advantageous Effects of Invention

The physically functional flame-retardant polymer member of the present invention has the polymer layer (B), the flame-retardant layer (A), which is a layer containing the layered inorganic compound (f) in a polymer, and the physically functional layer (L). The physically functional flame-retardant polymer member of the present invention has the physically functional layer (L) and hence can effectively express physical functionality.

When the physically functional layer (L) is the conductive layer (L), the physically functional flame-retardant polymer member of the present invention can effectively express excellent conductivity.

When the physically functional layer (L) is the anti-fingerprint layer (L), the physically functional flame-retardant polymer member of the present invention can effectively express excellent anti-fingerprint performance.

When the physically functional layer (L) is the hard coat layer (L), the physically functional flame-retardant polymer member of the present invention can effectively express excellent scratch-resistant performance.

When the physically functional layer (L) is the ink-absorbing layer (L), the physically functional flame-retardant polymer member of the present invention can effectively express excellent printing property.

When the physically functional layer (L) is the inorganic particle-containing layer (L), the physically functional flame-retardant polymer member of the present invention can express extremely high flame retardancy as compared to the case where the inorganic particle-containing layer (L) is absent. In addition, the inorganic particle-containing layer (L) is excellent in transparency because inorganic particles having a nano-order average particle diameter can be incorporated into the layer. In addition, when hydrophilic inorganic particles such as silica are used as the inorganic particles to be incorporated into the inorganic particle-containing layer (L), an oily substance hardly adheres to the surface of the inorganic particle-containing layer (L) and hence its contamination resistance can improve.

When the physically functional layer (L) is the antireflection layer (L), the physically functional flame-retardant polymer member of the present invention can effectively express excellent antireflection property.

When the physically functional layer (L) is the light selective transmission layer (L), the physically functional flame-retardant polymer member of the present invention can effectively express excellent light selective transmission property, and hence an optical filter member or the like having flame retardancy can be provided.

The chemically functional flame-retardant polymer member of the present invention has the polymer layer (B), the flame-retardant layer (A), which is a layer containing the layered inorganic compound (f) in a polymer, and the chemically functional layer (L). The chemically functional flame-retardant polymer member of the present invention has the chemically functional layer (L) and hence can effectively express chemical functionality.

When the chemically functional layer (L) is the alkali-resistant layer (L), the chemically functional flame-retardant polymer member of the present invention can effectively express excellent alkali resistance.

When the chemically functional layer (L) is the acid-resistant layer (L), the chemically functional flame-retardant polymer member of the present invention can effectively express excellent acid resistance.

When the chemically functional layer (L) is the solvent-resistant layer (L), the chemically functional flame-retardant polymer member of the present invention can effectively express excellent solvent resistance.

The flame-retardant layer exerts a high level of flame retardancy by virtue of the fact that the layer is a layer containing the layered inorganic compound (f) in the polymer. Despite the fact that the physically functional flame-retardant polymer member of the present invention or the chemically functional flame-retardant polymer member of the present invention has the polymer, the member does not burn and can block a flame for some time even when the member is in direct contact with the flame.

The flame-retardant layer (A) has the polymer, and hence can favorably maintain its flexibility and has so wide a scope of applications as to be applicable to various applications.

There is no need to incorporate any halogen-based resin into the physically functional flame-retardant polymer member of the present invention or the chemically functional flame-retardant polymer member of the present invention.

In addition, the member is excellent in transparency because the ratio of the layered inorganic compound (f) in the polymer in the flame-retardant layer (A) can be controlled so as to be relatively small. In particular, the member can exert flame retardancy even when the content of ash in the flame-retardant layer (A) is a content as small as less than 70 wt %. As described above, the physically functional flame-retardant polymer member of the present invention or the chemically functional flame-retardant polymer member of the present invention can effectively exert its flame retardancy while satisfying its physical functionality or chemical functionality, flexibility, and transparency.

In addition, the physically functional flame-retardant polymer member of the present invention or the chemically functional flame-retardant polymer member of the present invention is excellent in flame retardancy particularly when the physically functional flame-retardant polymer member of the present invention or the chemically functional flame-retardant polymer member of the present invention is obtained by a production method including the step of laminating a syrupy polymerizable composition layer (a) formed of a polymerizable composition (α) containing a polymerizable monomer (m) and the layered inorganic compound (f), and a solid monomer-absorbing layer (b) containing a polymer (p) and capable of absorbing the polymerizable monomer (m), followed by the performance of polymerization, and the step of producing the physically functional layer or the chemically functional layer or when the member is obtained by a production method including the step of laminating a syrupy polymerizable composition layer (a′) formed of a polymerizable composition (α) containing a polymerizable monomer (m1) and the layered inorganic compound (f), and a syrupy polymerizable composition layer (b′) containing a polymerizable monomer (m2) and a polymer (p2), followed by performance of polymerization and the step of producing the physically functional layer or the chemically functional layer.

The physically functional flame-retardant polymer member of the present invention or the chemically functional flame-retardant polymer member of the present invention is environmentally advantageous because there is no need to remove a volatile component (such as an organic solvent or an organic compound) in the polymerizable composition (α) through evaporation upon its production and hence a load on an environment can be reduced.

### BRIEF DESCRIPTION OF DRAWINGS

FIG. 1 is an example of a schematic sectional view of a physically functional flame-retardant polymer member of the present invention or a chemically functional flame-retardant polymer member of the present invention.

FIG. 2 is a schematic view of a method for a horizontal firing test for evaluating the physically functional flame-retardant polymer member of the present invention or the chemically functional flame-retardant polymer member of the present invention for its flame retardancy.

FIG. 3 is an example of a schematic sectional view of the physically functional flame-retardant polymer member of the present invention or the chemically functional flame-retardant polymer member of the present invention and a production method therefor.

FIG. 4 is an example of a schematic sectional view of the physically functional flame-retardant polymer member of the present invention or the chemically functional flame-retardant polymer member of the present invention and the production method therefor.

### DESCRIPTION OF EMBODIMENTS

<<1. Physically Functional Flame-Retardant Polymer Member and Chemically Functional Flame-Retardant Polymer Member>>

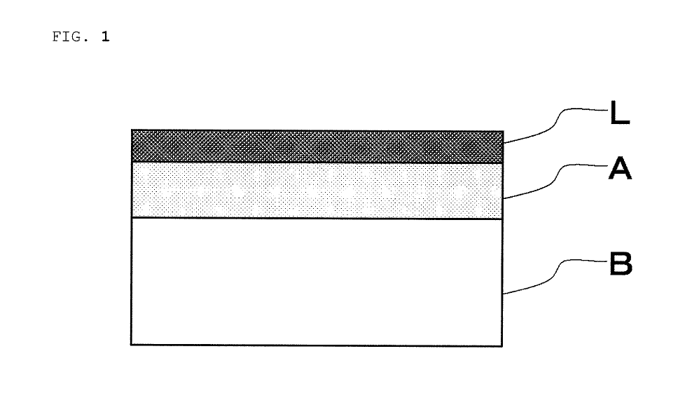

A physically functional flame-retardant polymer member of the present invention includes a polymer layer (B), a flame-retardant layer (A), and a physically functional layer (L) in the stated order. A chemically functional flame-retardant polymer member of the present invention includes the polymer layer (B), the flame-retardant layer (A), and a chemically functional layer (L) in the stated order. The flame-retardant layer (A) is a layer containing a layered inorganic compound (f) in a polymer. FIG. 1 illustrates a schematic view of each of the physically functional flame-retardant polymer member of the present invention and the chemically functional flame-retardant polymer member of the present invention. Although the flame-retardant layer (A) is provided on one surface of the polymer layer (B) in FIG. 1, the flame-retardant layer (A) can be provided on each of both surfaces of the polymer layer (B). When the flame-retardant layer (A) is provided on each of both surfaces of the polymer layer (B), the physically functional layer (L) or the chemically functional layer (L) is provided on a surface of at least one of the two polymer layers (B).

<1-1. Polymer Layer (B)>

The polymer layer (B) contains various polymers at preferably 80 wt % or more, more preferably 90 wt % or more, still more preferably 95 wt % or more, particularly preferably 98 wt % or more, most preferably substantially 100 wt %.

Examples of the polymer in the polymer layer (B) include: an acrylic resin; an urethane-based resin; an olefin-based resin containing an α-olefin as a monomer component such as a polyethylene (PE), a polypropylene (PP), an ethylene-propylene copolymer, or an ethylene-vinyl acetate copolymer (EVA); a polyester-based resin such as a polyethylene terephthalate (PET), a polyethylene naphthalate (PEN), or a polybutylene terephthalate (PBT); a vinyl acetate-based resin; a polyphenylene sulfide (PPS); an amide-based resin such as a polyamide (nylon) or a wholly aromatic polyamide (aramid); a polyimide-based resin; a polyether ether ketone (PEEK); an epoxy resin; an oxetane-based resin; a vinyl ether-based resin; a natural rubber; and a synthetic rubber. The polymer in the polymer layer (B) is preferably an acrylic resin.

The number of kinds of polymers in the polymer layer (B) may be only one, or may be two or more.

The number of kinds of polymerizable monomers that can be used for obtaining the polymer in the polymer layer (B) may be only one, or may be two or more.

Any appropriate polymerizable monomer can be adopted as a polymerizable monomer that can be used for obtaining the polymer in the polymer layer (B).

Examples of the polymerizable monomer that can be used for obtaining the polymer in the polymer layer (B) include a monofunctional monomer, a polyfunctional monomer, a polar group-containing monomer, and any other copolymerizable monomer. Any appropriate content can be adopted as the content of each monomer component such as the monofunctional monomer, the polyfunctional monomer, the polar group-containing monomer, or the other copolymerizable monomer in the polymerizable monomer that can be used for obtaining the polymer in the polymer layer (B) depending on target physical properties of the polymer to be obtained.

Any appropriate monofunctional monomer can be adopted as the monofunctional monomer as long as the monomer is a polymerizable monomer having only one polymerizable group. The number of kinds of the monofunctional monomers may be only one, or may be two or more.

The monofunctional monomer is preferably an acrylic monomer. The acrylic monomer is preferably an alkyl (meth)acrylate having an alkyl group. The number of kinds of the alkyl (meth)acrylates each having an alkyl group may be only one, or may be two or more. It should be noted that the term “(meth)acryl” refers to “acryl” and/or “methacryl.”

Examples of the alkyl (meth)acrylate having an alkyl group include an alkyl (meth)acrylate having a linear or branched alkyl group, and an alkyl (meth)acrylate having a cyclic alkyl group. It should be noted that the alkyl (meth)acrylate as used herein means a monofunctional alkyl (meth)acrylate.

Examples of the alkyl (meth)acrylate having a linear or branched alkyl group include alkyl (meth)acrylates each having an alkyl group having 1 to 20 carbon atoms such as methyl (meth)acrylate, ethyl meth(acrylate), propyl (meth)acrylate, isopropyl (meth)acrylate, butyl (meth)acrylate, isobutyl (meth)acrylate, s-butyl (meth)acrylate, t-butyl (meth)acrylate, pentyl (meth)acrylate, isopentyl (meth)acrylate, hexyl (meth)acrylate, heptyl (meth)acrylate, octyl (meth)acrylate, 2-ethylhexyl (meth)acrylate, isooctyl (meth)acrylate, nonyl (meth)acrylate, isononyl (meth)acrylate, decyl (meth)acrylate, isodecyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, heptadecyl (meth)acrylate, octadecyl (meth)acrylate, nonadecyl (meth)acrylate, and eicosyl (meth)acrylate. Of those, an alkyl (meth)acrylate having an alkyl group having 2 to 14 carbon atoms is preferred, and an alkyl (meth)acrylate having an alkyl group having 2 to 10 carbon atoms is more preferred.

Examples of the alkyl (meth)acrylate having a cyclic alkyl group include cyclopentyl (meth)acrylate, cyclohexyl (meth)acrylate, and isobornyl (meth)acrylate.

Any appropriate polyfunctional monomer can be adopted as the polyfunctional monomer. By adopting the polyfunctional monomer, a cross-linked structure may be given to the polymer in the polymer layer (B). The number of kinds of the polyfunctional monomers may be only one, or may be two or more.

Examples of the polyfunctional monomer include 1,9-nonanediol di(meth)acrylate, 1,6-hexanediol di(meth)acrylate, 1,4-butanediol di(meth)acrylate, (poly)ethylene glycol di(meth)acrylate, (poly)propylene glycol di(meth)acrylate, neopentylglycol di(meth)acrylate, pentaerythritol di(meth)acrylate, pentaerythritol tri(meth)acrylate, dipentaerythritol hexa(meth)acrylate, trimethylolpropane tri(meth)acrylate, tetramethylolmethane tri(meth)acrylate, allyl (meth)acrylate, vinyl (meth)acrylate, divinylbenzene, epoxy acrylate, polyester acrylate, and urethane acrylate. Of those, an acrylate-based polyfunctional monomer is preferred, and 1,9-nonanediol di(meth)acrylate and 1,6-hexanediol di(meth)acrylate are more preferred in terms of having high reactivity and possibly expressing excellent cigarette resistance.

Any appropriate polar group-containing monomer can be adopted as the polar group-containing monomer. The adoption of the polar group-containing monomer can improve the cohesive strength of the polymer in the polymer layer (B), or can increase the adhesive strength of the polymer layer (B). The number of kinds of the polar group-containing monomers may be only one, or may be two or more.

Examples of the polar group-containing monomer include: carboxyl group-containing monomers such as (meth)acrylic acid, itaconic acid, maleic acid, fumaric acid, crotonic acid, and isocrotonic acid, or anhydrides thereof (for example, maleic anhydride); hydroxy group-containing monomers such as a hydroxyalkyl (meth)acrylate such as hydroxyethyl (meth)acrylate, hydroxypropyl (meth)acrylate, or hydroxybutyl (meth)acrylate, vinyl alcohol, and allyl alcohol; amide group-containing monomers such as (meth)acrylamide, N,N-dimethyl (meth)acrylamide, N-methylol (meth)acrylamide, N-methoxymethyl (meth)acrylamide, and N-butoxymethyl (meth)acrylamide; amino group-containing monomers such as aminoethyl (meth)acrylate, dimethylaminoethyl (meth)acrylate, and t-butylaminoethyl (meth)acrylate; glycidyl group-containing monomers such as glycidyl (meth)acrylate and methylglycidyl (meth)acrylate; cyano group-containing monomers such as acrylonitrile and methacrylonitrile; heterocycle-containing vinyl-based monomers such as N-vinyl-2-pyrrolidone and (meth)acryloyl morpholine, as well as N-vinylpyridine, N-vinylpiperidone, N-vinylpyrimidine, N-vinylpiperazine, N-vinylpyrrole, N-vinylimidazole, and N-vinyloxazole; alkoxyalkyl (meth)acrylate-based monomers such as methoxyethyl (meth)acrylate and ethoxyethyl (meth)acrylate; sulfonate group-containing monomers such as sodium vinyl sulfonate; phosphate group-containing monomers such as 2-hydroxyethyl acryloyl phosphate; imide group-containing monomers such as cyclohexyl maleimide and isopropyl maleimide; and isocyanate group-containing monomers such as 2-methacryloyloxyethyl isocyanate. The polar group-containing monomer is preferably a carboxyl group-containing monomer or an anhydride thereof, more preferably acrylic acid.

Any appropriate other copolymerizable monomer can be adopted as the other copolymerizable monomer. The adoption of the other copolymerizable monomer can improve the cohesive strength of the polymer in the polymer layer (B), or can increase the adhesive strength of the polymer layer (B). The number of kinds of the other copolymerizable monomers may be only one, or may be two or more.

Examples of the other copolymerizable monomer include: an alkyl (meth)acrylate such as a (meth)acrylate having an aromatic hydrocarbon group such as phenyl (meth)acrylate; vinyl esters such as vinyl acetate and vinyl propionate; aromatic vinyl compounds such as styrene and vinyl toluene; olefins and dienes such as ethylene, butadiene, isoprene, and isobutylene; vinyl ethers such as a vinyl alkyl ether; vinyl chloride; alkoxyalkyl (meth)acrylate-based monomers such as methoxyethyl (meth)acrylate and ethoxyethyl (meth)acrylate; sulfonate group-containing monomers such as sodium vinyl sulfonate; phosphate group-containing monomers such as 2-hydroxyethyl acryloyl phosphate; imide group-containing monomers such as cyclohexylmaleimide and isopropylmaleimide; isocyanate group-containing monomers such as 2-methacryloyloxyethyl isocyanate; fluorine atom-containing (meth)acrylates; and Silicon atom-containing (meth)acrylates.

The polymer layer (B) may contain a flame retardant. Any appropriate flame retardant can be adopted as the flame retardant. Examples of such flame retardant include: organic flame retardants such as a phosphorus-based flame retardant; and inorganic flame retardants such as magnesium hydroxide, aluminum hydroxide, and a layered silicate.

The polymer layer (B) may contain the layered inorganic compound (f) as a flame retardant as in the flame-retardant layer (A). In this case, the ratio at which the layered inorganic compound (f) is filled into the polymer layer (B) is preferably set so as to be lower than the ratio at which the layered inorganic compound (f) is filled into the flame-retardant layer (A). Thus, the flame-retardant layer (A) and the polymer layer (B) are differentiated from each other in terms of degree of flame retardancy.

Any appropriate thickness can be adopted as the thickness of the polymer layer (B). The thickness of the polymer layer (B) is, for example, preferably 1 to 3,000 μm, more preferably 2 to 2,000 μm, still more preferably 5 to 1,000 μm. In addition, the polymer layer (B) may be a single layer, or may be a laminate formed of a plurality of layers.

Pressure-sensitive adhesive property can be imparted to the polymer layer (B) through the selection of a polymer that is a material for forming the layer. For example, an acrylic resin, an epoxy resin, an oxetane-based resin, a vinyl ether-based resin, a urethane-based resin, and a polyester-based resin function as a base polymer for an acrylic pressure-sensitive adhesive, a base polymer for an epoxy-based pressure-sensitive adhesive, a base polymer for an oxetane-based pressure-sensitive adhesive, a base polymer for a vinyl ether-based pressure-sensitive adhesive, abase polymer for a urethane-based pressure-sensitive adhesive, and a base polymer for a polyester-based pressure-sensitive adhesive, respectively.

<1-2. Flame-Retardant Layer (a)>

The same examples as those of the polymer that can be incorporated into the polymer layer (B) can be given as examples of the polymer in the flame-retardant layer (A).

<1-3. Layered Inorganic Compound (f)>

Examples of the layered inorganic compound (f) to be incorporated into the flame-retardant layer (A) include a layered inorganic substance and an organically treated product thereof. The layered inorganic compound (f) may be a solid, or may have flowability. The number of kinds of the layered inorganic compounds may be only one, or may be two or more.

Examples of inorganics which can form a layered inorganic substance include a silicate and a clay mineral. Of those, a layered clay mineral is preferred as the layered inorganic substance.

Examples of the layered clay mineral include: a smectite such as montmorillonite, beidellite, hectorite, saponite, nontronite, or stevensite; vermiculite; bentonite; and a layered sodium silicate such as kanemite, kenyaite, or makatite. Such layered clay mineral may be yielded as a natural mineral, or may be produced by a chemical synthesis method.

The organically treated product of the layered inorganic substance is a product obtained by treating the layered inorganic substance with an organic compound. An example of the organic compound is an organic cationic compound. Examples of the organic cationic compound include cationic surfactants each having a cation group such as a quarternary ammonium salt or a quarternary phosphonium salt. The cationic surfactant has a cationic group such as a quarternary ammonium salt or a quarternary phosphonium salt on a propylene oxide skeleton, an ethylene oxide skeleton, an alkyl skeleton, or the like. Such cationic group preferably forms a quarternary salt with, for example, a halide ion (such as a chloride ion).

Examples of the cationic surfactant which has a quarternary ammonium salt include lauryltrimethylammonium salt, stearyltrimethylammonium salt, trioctylammonium salt, distearyldimethylammonium salt, distearyldibenzylammonium salt, and an ammonium salt having a methyldiethylpropylene oxide skeleton.

Examples of the cationic surfactant which has a quarternary phosphonium salt include dodecyltriphenyl phosphonium salt, methyltriphenylphosphonium salt, lauryltrimethyl phosphonium salt, stearyltrimethyl phosphonium salt, distearyldimethyl phosphonium salt, and distearylbenzyl phosphonium salt.

The layered inorganic substance such as the layered clay mineral is treated with the organic cationic compound. As a result, a cation between layers can undergo ion exchange with a cationic group of a quaternary salt or the like. Examples of the cation of the clay mineral include metal cations such as a sodium ion and a calcium ion. The layered clay mineral treated with the organic cationic compound is easily swollen and dispersed in the polymer or the polymerizable monomer. An example of the layered clay mineral treated with the organic cationic compound is LUCENTITE series (Co-op Chemical Co., Ltd.). More specific examples of the LUCENTITE series (Co-op Chemical Co., Ltd.) include LUCENTITE SPN, LUCENTITE SAN, LUCENTITE SEN, and LUCENTITE STN.

Examples of the organically treated product of the layered inorganic substance include products obtained by subjecting the surface of the layered inorganic substance to surface treatments with various organic compounds (such as a surface tension-lowering treatment with a silicone-based compound or a fluorine-based compound).

The ratio of the organic compound to the layered inorganic substance in the organically treated product of the layered inorganic substance varies depending on the cation-exchange capacity (“CEC”) of the layered inorganic substance. The CEC relates to the ion-exchange capacity of the layered inorganic compound (f) or the total quantity of positive charge that can be caused to adsorb on the surface of the layered inorganic substance, and is represented by positive charge per unit mass of colloid particles, that is, “coulomb(s) per unit mass” in an SI unit. The CEC may be represented by milliequivalent(s) per gram (meq/g) or milliequivalent(s) per 100 grams (meq/100 g). A CEC of 1 meq/g corresponds to 96.5 C/g in the SI unit. Several CEC values concerning representative clay minerals are as described below. The CEC of montmorillonite falls within the range of 70 to 150 meq/100 g, the CEC of halloysite falls within the range of 40 to 50 meq/100 g, and the CEC of kaolin falls within the range of 1 to 10 meq/100 g.

The ratio of the organic compound to the layered inorganic substance in the organically treated product of the layered inorganic substance is such that the amount of the organic compound is preferably 1,000 parts by weight or less, more preferably 3 to 700 parts by weight, more preferably 5 to 500 parts by weight with respect to 100 parts by weight of the layered inorganic substance.

With regard to the particle diameter (average particle diameter) of the layered inorganic compound (f), its particles are preferably packed as densely as possible in a portion in the flame-retardant layer (A) where the layered inorganic compound (f) is distributed from such a viewpoint that good flame retardancy is obtained. For example, the average of primary particle diameters when the layered inorganic compound (f) is dispersed in a dilute solution is preferably 5 nm to 10 μm, more preferably 6 nm to 5 μm, still more preferably 7 nm to 1 μm in terms of a median diameter in a laser scattering method or a dynamic light scattering method. It should be noted that a combination of two or more kinds of particles having different particle diameters may be used as the particles.

The shape of each of the particles may be any shape, e.g., a spherical shape such as a true spherical shape or an ellipsoidal shape, an amorphous shape, a needle-like shape, a rod-like shape, a flat plate-like shape, a flaky shape, or a hollow tubular shape. The shape of each of the particles is preferably a flat plate-like shape or a flaky shape. In addition, the surface of each of the particles may have a pore, a protrusion, or the like.

The average of maximum primary particle diameters is preferably 5 μm or less, more preferably 5 nm to 5 μm because the transparency of the flame-retardant polymer member may be problematic as the particle diameter of the layered clay mineral increases.

It should be noted that the LUCENTITE SPN (manufactured by Co-op Chemical Co., Ltd.) is obtained by subjecting the layered clay mineral to an organizing treatment with an organic compound having a quaternary ammonium salt, and the ratio of the organic compound is 62 wt %. With regard to its particle diameter, the LUCENTITE SPN has a 25% average primary particle diameter of 19 nm, a 50% average primary particle diameter of 30 nm, and a 99% average primary particle diameter of 100 nm. The LUCENTITE SPN has a thickness of 1 nm and an aspect ratio of about 30.

When particles are used as the layered inorganic compound (f), the layered inorganic compound (f) can contribute to, for example, the formation of surface unevenness by the particles in the surface of the flame-retardant layer (A) in some cases.

In addition, when the product obtained by treating the layered clay mineral with the organic cationic compound is used as the layered inorganic compound (f), the surface resistance value of the flame-retardant layer (A) can be preferably set to 1×10¹⁴ (Q/□) or less, and hence antistatic property can be imparted to the flame-retardant layer (A). The antistatic property can be controlled to desired antistatic property by controlling, for example, the kind, shape, size, and content of the layered inorganic compound (f), and the composition of the polymer component of the flame-retardant layer (A).

As the layered inorganic compound (f) and the polymer are mixed in the flame-retardant layer (A), the layer can exert a characteristic based on the polymer, and at the same time, can exert a characteristic of the layered inorganic compound (f).

The content of ash in the flame-retardant layer (A) (the content of the layered inorganic compound (f) with respect to the total amount of the formation materials for the flame-retardant layer (A), provided that when the layered inorganic compound (f) is an organically treated product of a layered inorganic substance, the content of the layered inorganic substance that has not been subjected to any organic treatment) can be appropriately set depending on the kind of the layered inorganic compound (f). The content is preferably 3 wt % or more and less than 70 wt %. When the content is 70 wt % or more, the layered inorganic compound (f) may not be favorably dispersed. As a result, a lump is apt to be produced and hence it becomes difficult to produce the flame-retardant layer (A) in which the layered inorganic compound (f) has been uniformly dispersed in some cases. When the content is 70 wt % or more, the transparency and flexibility of the flame-retardant polymer member may reduce. On the other hand, when the content is less than 3 wt %, the flame-retardant layer (A) does not have flame retardancy in some cases. The content of the layered inorganic compound (f) in the flame-retardant layer (A) is preferably 3 to 60 wt %, more preferably 5 to 50 wt %.

<1-4. Additive>

Any appropriate additive may be incorporated into the flame-retardant layer (A). Examples of such additive include a surfactant (such as an ionic surfactant, a silicone-based surfactant, or a fluorine-based surfactant), a cross-linking agent (such as a polyisocyanate-based cross-linking agent, a silicone-based cross-linking agent, an epoxy-based cross-linking agent, or an alkyl-etherified melamine-based cross-linking agent), a plasticizer, a filler, an age resister, an antioxidant, a colorant (such as a pigment or a dye), and a solvent (such as an organic solvent).

Any appropriate pigment (coloring pigment) may be incorporated into the flame-retardant layer (A) from the viewpoints of, for example, design and optical characteristics. When a black color is desired, carbon black is preferably used as the coloring pigment. The usage of the pigment (coloring pigment) is, for example, preferably 0.15 part by weight or less, more preferably 0.001 to 0.15 part by weight, still more preferably 0.02 to 0.1 part by weight with respect to 100 parts by weight of the polymer in the flame-retardant layer (A) from such a viewpoint that the degree of coloring and the like are not inhibited.

The flame-retardant layer (A) has a thickness of preferably 3 to 1,000 μm, more preferably 4 to 500 μm, still more preferably 5 to 200 μm. When the thickness of the flame-retardant layer (A) deviates from the range, its flame retardancy may be problematic.

<1-5. Physically Functional Layer (L)>

Any appropriate layer can be adopted as the physically functional layer (L) as long as the layer can express physical functionality. Preferred examples of such physically functional layer (L) include a conductive layer (L), an anti-fingerprint layer (L), a hard coat layer (L), an ink-absorbing layer (L), an inorganic particle-containing layer (L), an antireflection layer (L), and a light selective transmission layer (L).

The thickness of the physically functional layer (L) is preferably 0.005 to 100 μm, more preferably 0.01 to 100 μm, still more preferably 0.1 to 100 μm, particularly preferably 1 to 100 μm. As long as the thickness of the physically functional layer (L) falls within the range, the layer can express sufficient physical functionality without impairing the flame retardancy of the physically functional flame-retardant polymer member of the present invention.

(1-5-1. Conductive Layer (L))

Any appropriate layer can be adopted as the conductive layer (L) as long as the layer can express conductivity.

The conductive layer (L) may be formed only of one layer, or may be formed of two or more layers.

The conductive layer (L) preferably contains a conductive substance. Any appropriate conductive substance can be adopted as the conductive substance as long as the substance can express conductivity. The number of kinds of the conductive substances may be only one, or may be two or more. Examples of the conductive substance include a conductive metal, a conductive metal oxide, a conductive composite metal compound, and a conductive polymer.

Any appropriate conductive metal can be adopted as the conductive metal. Examples of the conductive metal include carbon black, silver, copper, and nickel.

Any appropriate conductive metal oxide can be adopted as the conductive metal oxide. Examples of the conductive metal oxide include indium oxide, tin oxide, zinc oxide, cadmium oxide, and titanium oxide.

Any appropriate conductive composite metal compound can be adopted as the conductive composite metal compound. Examples of the conductive composite metal compound include: compounds each obtained by doping a conductive metal oxide with tin, antimony, aluminum, gallium, or the like (such as tin-containing indium oxide particles (ITO), antimony-containing tin oxide particles (ATO), aluminum-containing zinc oxide particles (AZO), and gallium-containing zinc oxide particles (GZO)); a compound obtained by subjecting ITO to aluminum substitution; and compounds each obtained by coating glass beads, mica, acicular titanium oxide, or the like with a metal or a metal oxide.

Any appropriate conductive polymer can be adopted as the conductive polymer. Examples of the conductive polymer include polyaniline, polypyrrole, and polythiophene.

When the conductive substance is particulate, its average particle diameter is preferably 0.005 to 0.5 μm, more preferably 0.01 to 0.5 μm. When the conductive substance is particulate, as long as its average particle diameter falls within the range, the conductivity of the conductive layer (L) can be expressed at a high level.

The conductive layer (L) may contain any appropriate additive. Examples of such additive include a plasticizer, a filler, a lubricant, a thermal stabilizer, an anti-fogging agent, a stabilizer, an antioxidant, a surfactant, a resin, and a solvent.

The conductive layer (L) can adopt any appropriate form. Examples of such form include an applied layer and a sheet layer.

When the conductive layer (L) is an applied layer, the conductive layer (L) can be formed by applying any appropriate conductive liquid. When the conductive layer (L) is a sheet layer, the conductive layer (L) is, for example, a sheet layer containing a conductive substance. Such sheet layer can be formed by any appropriate forming method.

The thickness of the conductive layer (L) is preferably 0.1 to 100 μm, more preferably 1 to 100 μm. As long as the thickness of the conductive layer (L) falls within the range, the layer can express sufficient conductivity without impairing the flame retardancy of the physically functional flame-retardant polymer member of the present invention.

(1-5-2. Anti-Fingerprint Layer (L))

Any appropriate layer can be adopted as the anti-fingerprint layer (L) as long as the effect of the present invention is obtained. The layer is preferably a layer containing at least one kind of resin selected from a fluorine-based resin, a silicone-based resin, and a urethane-based resin.

The fluorine-based resin is, for example, a fluorine-containing silane compound (general formula (1)) described in Japanese Patent Application Laid-open No. Hei 09-258003. The number of kinds of the fluorine-based resins may be only one, or may be two or more.

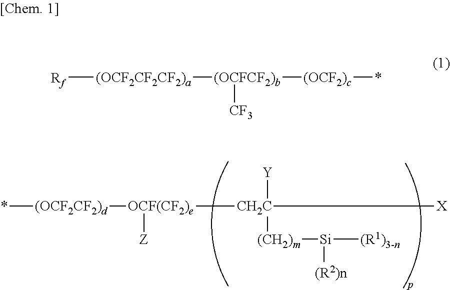

In the general formula (1), R_{f} represents a linear or branched perfluoroalkyl group having 1 to 16 carbon atoms, and preferred examples thereof include CF₃—, C₂F₅—, and C₃F₇—. X represents iodine or hydrogen. Y represents hydrogen or a lower alkyl group. R¹ represents a hydrolyzable group and preferred examples thereof include a halogen, —OR³, —OCOR³, —OC(R³)═C(R⁴)₂, —ON═C(R³)₂, and —ON═CR⁵ (provided that R³ represents an aliphatic hydrocarbon group or an aromatic hydrocarbon group, R⁴ represents hydrogen or a lower aliphatic hydrocarbon group, and R⁵ represents a divalent, aliphatic hydrocarbon group having 3 to 6 carbon atoms). More preferred examples of R¹ include chlorine, —OCH₃, and —OC₂H₅. R² represents hydrogen or an inert, monovalent organic group, preferably, for example, a monovalent hydrocarbon group having 1 to 4 carbon atoms. a, b, c, and d each represent an integer of 0 to 200, preferably 1 to 50 e represents 0 or 1. m and n each represent an integer of 0 to 2, preferably 0. p represents an integer of 1 or more, preferably an integer of 1 to 10.

The molecular weight of the fluorine-containing silane compound represented by the general formula (1) is preferably 5×10² to 1×10⁵, more preferably 5×10² to 1×10⁴.

A preferred structure of the fluorine-containing silane compound represented by the general formula (1) is, for example, a structure represented by a general formula (2). In the general formula (2), q represents an integer of 1 to 50, r represents an integer of 1 or more, preferably an integer of 1 to 10, and the other symbols are the same as those described in the general formula (1).

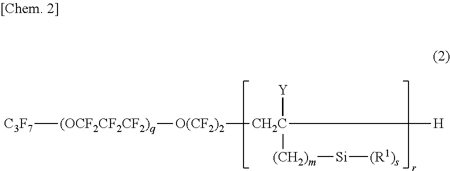

Examples of the silicone-based resin include a dimethylpolysiloxane, a methylhydropolysiloxane, a silicone oil or a silicone varnish, and a silicone-modified acrylic copolymer described in Japanese Patent Application Laid-open No. Hei 09-111185. The number of kinds of the silicone-based resins may be only one, or may be two or more.

Examples of the urethane-based resin include a urethane (meth)acrylate shown in Japanese Patent Application Laid-open No. 2010-248426, and a polyfunctional urethane (meth)acrylate compound obtained by causing a polyfunctional (meth)acrylate compound having active hydrogen and a polyisocyanate compound to react with each other. The number of kinds of the urethane-based resins may be only one, or may be two or more.

Examples of the polyfunctional (meth)acrylate compound having active hydrogen in the polyfunctional urethane (meth)acrylate compound obtained by causing a polyfunctional (meth)acrylate compound having active hydrogen and a polyisocyanate compound to react with each other may include: pentaerythritols such as pentaerythritol tri(meth)acrylate, dipentaerythritol hexa(meth)acrylate, dipentaerythritol penta(meth)acrylate, dipentaerythritol tetra(meth)acrylate, dipentaerythritol tri(meth)acrylate, and dipentaerythritol di(meth)acrylate; methylols such as trimethylolpropane di(meth)acrylate; and epoxy acrylates such as bisphenol A diepoxy acrylate. Preferred examples of such polyfunctional (meth)acrylate compound having active hydrogen include pentaerythritol triacrylate and dipentaerythritol pentaacrylate. The number of kinds of those polyfunctional (meth)acrylates each having active hydrogen may be only one, or may be two or more.

Examples of the polyisocyanate compound in the polyfunctional urethane (meth)acrylate compound obtained by causing a polyfunctional (meth)acrylate compound having active hydrogen and a polyisocyanate compound to react with each other include polyisocyanate compounds each using, as a constituent, a linear saturated hydrocarbon, acyclic saturated hydrocarbon (alicyclic), or an aromatic hydrocarbon. Specific examples thereof include: linear saturated hydrocarbon polyisocyanates such as tetramethylene diisocyanate, hexamethylene diisocyanate, and 2,2,4-trimethylhexamethylene diisocyanate; cyclic saturated hydrocarbon (alicyclic) polyisocyanates such as isophorone diisocyanate, dicyclohexylmethane diisocyanate, methylenebis(4-cyclohexyl isocyanate), hydrogenated diphenylmethane diisocyanate, hydrogenated xylene diisocyanate, and hydrogenated toluene diisocyanate; and aromatic polyisocyanates such as 2,4-tolylene diisocyanate, 1,3-xylylene diisocyanate, p-phenylene diisocyanate, 3,3′-dimethyl-4,4′-diisocyanate, 6-isopropyl-1,3-phenyl diisocyanate, and 1,5-naphthalene diisocyanate. Preferred examples of such polyisocyanate compound include isophorone diisocyanate and hexamethylene diisocyanate. The number of kinds of those polyisocyanate compounds may be only one, or may be two or more.

Upon production of the polyfunctional urethane (meth)acrylate compound, the usage of the polyisocyanate compound with respect to 1 equivalent of an active hydrogen group in the polyfunctional (meth)acrylate compound having active hydrogen is preferably 0.1 to 50 equivalents, more preferably 0.1 to 10 equivalents in terms of an isocyanate group equivalent. A temperature for the reaction is preferably 30 to 150° C., more preferably 50 to 100° C. The endpoint of the reaction is calculated by a method involving causing the remaining isocyanate amount to react with an excess amount of n-butylamine and subjecting the resultant to back titration with 1 N hydrochloric acid, and the time point at which the remaining polyisocyanate amount becomes 0.5 wt % or less is defined as the end.

Upon production of the polyfunctional urethane (meth)acrylate compound, a catalyst may be added for the purpose of reducing the reaction time. Examples of such catalyst include a basic catalyst and an acidic catalyst. Examples of the basic catalyst may include: amines such as pyridine, pyrrole, triethylamine, diethylamine, dibutylamine, and ammonia; and phosphines such as tributylphosphine and triphenylphosphine. Examples of the acidic catalyst include: copper naphthenate, cobalt naphthenate, and zinc naphthenate; metal alkoxides such as tributoxyaluminum, trititanium tetrabutoxide, and zirconium tetrabutoxide; Lewis acids such as aluminum chloride; and tin compounds such as tin 2-ethylhexanoate, octyltin trilaurate, dibutyltin dilaurate, and octyltin diacetate. The addition amount of the catalyst is preferably 0.1 to 1 part by weight with respect to 100 parts by weight of the polyisocyanate.

Upon production of the polyfunctional urethane (meth)acrylate compound, a polymerization inhibitor (such as methoquinone, hydroquinone, methylhydroquinone, or phenothiazine) is preferably used in order that the polymerization of the (meth)acrylate compound during the reaction may be prevented. The usage of such polymerization inhibitor is preferably 0.01 to 1 wt %, more preferably 0.05 to 0.5 wt % with respect to the reaction mixture. A temperature for the reaction is preferably 60 to 150° C., more preferably 80 to 120° C.

The anti-fingerprint layer may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives to be incorporated into the resin composition can be appropriately set depending on purposes.

The anti-fingerprint layer (L) may be formed only of one layer, or may be formed of two or more layers.

The thickness of the anti-fingerprint layer (L) is preferably 0.1 to 100 μm, more preferably 1 to 100 μm. As long as the thickness of the anti-fingerprint layer (L) falls within the range, the layer can express extremely excellent anti-fingerprint property without impairing the flame retardancy of the physically functional flame-retardant polymer member of the present invention.

(1-5-3. Hard Coat Layer (L))

Any appropriate layer can be adopted as the hard coat layer (L) as long as the effect of the present invention is obtained. The layer is preferably at least one kind selected from a UV-curing type hard coat layer, a thermosetting type hard coat layer, and an organic-inorganic hybrid type hard coat layer.

The UV-curing type hard coat layer can be formed from a resin composition containing a UV-curable resin. The thermosetting type hard coat layer can be formed from a resin composition containing a thermosetting resin. The organic-inorganic hybrid type hard coat layer can be formed from a resin composition containing an organic-inorganic hybrid resin.

Examples of such resin as described above include an acrylic resin, an oxetane-based resin, an epoxy resin, and a silicone-based resin. A hard coat layer capable of effectively expressing excellent scratch-resistant performance can be obtained by using a resin composition containing such resin in the formation of the hard coat layer. Of those, an acrylic resin is particularly preferred in terms of, for example, handleability.

Any appropriate acrylic resin can be adopted as the acrylic resin as long as the resin has a repeating unit derived from any of various monofunctional or polyfunctional (meth)acrylates. Examples of the monofunctional (meth)acrylate include isobornyl acrylate, tetrahydrofurfuryl acrylate, 2-hydroxy-3-phenoxypropyl acrylate, butoxyethyl acrylate, lauryl acrylate, stearyl acrylate, benzyl acrylate, hexyl diglycol acrylate, 2-hydroxyethyl acrylate, 2-ethylhexyl acrylate, cyclohexyl acrylate, phenoxyethyl acrylate, dicyclopentadiene acrylate, polyethylene glycol acrylate, polypropylene glycol acrylate, and nonylphenoxyethyl cellosolve acrylate. Examples of the polyfunctional (meth)acrylate include: polyfunctional (meth)acrylates such as polyethylene glycol diacrylate, neopentyl glycol diacrylate, trimethylolpropane triacrylate, and pentaerythritol triacrylate; and polyfunctional (meth)acrylate oligomers such as oligourethane (meth)acrylate and oligoester (meth)acrylate. Those (meth)acrylates may be used alone, or two or more kinds thereof may be mixed and used to form a copolymer.

The resin composition may further contain any appropriate additive depending on purposes. Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives to be incorporated into the resin composition can be appropriately set depending on purposes.

The pencil hardness of the hard coat layer (L) is preferably 2H to 8H, more preferably 4H to 6H. A hard coat layer (L) having excellent scratch resistance can be obtained by setting the pencil hardness of the hard coat layer (L) in such range.

The hard coat layer (L) may be formed only of one layer, or may be formed of two or more layers.

The thickness of the hard coat layer (L) is preferably 0.1 to 100 μm, more preferably 1 to 100 μm. As long as the thickness of the hard coat layer (L) falls within the range, the layer can express extremely excellent scratch resistance without impairing the flame retardancy of the physically functional flame-retardant polymer member of the present invention.

(1-5-4. Ink-Absorbing Layer (L))

Any appropriate layer can be adopted as the ink-absorbing layer (L) as long as a printing effect is obtained.

The ink-absorbing layer (L) preferably contains a water-soluble resin. The content of the water-soluble resin in the ink-absorbing layer (L) is preferably 50 to 100 wt %, more preferably 70 to 100 wt %, still more preferably 90 to 100 wt %, particularly preferably 95 to 100 wt %, most preferably substantially 100 wt %.

Any appropriate water-soluble resin can be adopted as the water-soluble resin. Such water-soluble resin is, for example, at least one kind selected from polyvinyl alcohol, polyvinylpyrrolidone, polyacrylic acid, polyethylenimine, and a copolymer of vinylpyrrolidone and vinyl acetate.

The number of kinds of the water-soluble resins in the ink-absorbing layer (L) may be only one, or may be two or more.

The ink-absorbing layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the ink-absorbing layer (L) can be appropriately set depending on purposes.

The ink-absorbing layer (L) may be formed only of one layer, or may be formed of two or more layers.

The thickness of the ink-absorbing layer (L) is preferably 0.1 to 100 μm, more preferably 1 to 100 μm. As long as the thickness of the ink-absorbing layer (L) falls within the range, the layer can express extremely excellent printing property without impairing the flame retardancy of the physically functional flame-retardant polymer member of the present invention.

(1-5-5. Inorganic Particle-Containing Layer (L))

Any appropriate layer can be adopted as the inorganic particle-containing layer (L) as long as the effect of the present invention is obtained. The inorganic particle-containing layer (L) is preferably a layer containing inorganic particles in a polymer.

Any appropriate polymer can be adopted as the polymer to be incorporated into the inorganic particle-containing layer (L). The same polymers as the various polymers given as examples of the polymers that can be incorporated into the flame-retardant layer (A) and the polymer layer (B) can be given as examples of the polymer.

The inorganic particle-containing layer (L) contains inorganic particles. Any appropriate inorganic particles can be adopted as the inorganic particles. Examples of such inorganic particles include silica particles and silica-coated particles. Any appropriate particles can be adopted as the silica-coated particles as long as the surfaces of the particles are coated with silica. Examples of the silica-coated particles include metals whose surfaces are coated with silica. Examples of such metals include metal simple substances, metal oxides, and metal composite oxides. Such metals are preferably metal oxides, and specific examples thereof include titanium oxide and zinc oxide. The number of kinds of the inorganic particles in the inorganic particle-containing layer (L) may be only one, or may be two or more.

An upper limit for the average particle diameter of the inorganic particles in the inorganic particle-containing layer (L) is preferably 100 nm or less, more preferably 40 nm or less, still more preferably 20 nm or less, particularly preferably 15 nm or less. It should be noted that a lower limit for the average particle diameter of the inorganic particles in the inorganic particle-containing layer (L) is preferably 1 nm or more, more preferably 3 nm or more, still more preferably 5 nm or more. An inorganic particle-containing layer (L) excellent in transparency can be provided as long as the average particle diameter of the inorganic particles in the inorganic particle-containing layer (L) falls within the range.

When the inorganic particles in the inorganic particle-containing layer (L) are hydrophilic inorganic particles made of silica or the like, an oily substance hardly adheres to the surface of the inorganic particle-containing layer (L) and hence its contamination resistance can improve.

The inorganic particle-containing layer (L) can be preferably produced from an inorganic particle-containing layer formation material obtained by compounding, in the polymer, the inorganic particles and, as required, any appropriate additive. More specifically, a method of producing the inorganic particle-containing layer (L) is, for example, a method involving applying the inorganic particle-containing layer formation material onto the flame-retardant layer (A) to form the layer, or a method involving independently producing the inorganic particle-containing layer from the inorganic particle-containing layer formation material and then attaching the layer onto the flame-retardant layer (A).

Any appropriate form can be adopted as the form of each of the inorganic particles to be compounded for obtaining the inorganic particle-containing layer formation material. Examples of such form of each of the inorganic particles include a colloidal particle, a particle treated with a dispersant, a particle subjected to a coupling treatment, and an encapsulated particle.

The content of the inorganic particles in the inorganic particle-containing layer (L) with respect to the polymer in the inorganic particle-containing layer (L) is preferably 20 to 90 wt %, more preferably 25 to 80 wt %, still more preferably 30 to 70 wt %, particularly preferably 35 to 60 wt %. When the content of the inorganic particles in the inorganic particle-containing layer (L) with respect to the polymer in the inorganic particle-containing layer (L) is less than 20 wt %, it may become difficult to express extremely high flame retardancy. When the content of the inorganic particles in the inorganic particle-containing layer (L) with respect to the polymer in the inorganic particle-containing layer (L) exceeds 90 wt %, the inorganic particle-containing layer (L) may become brittle.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives can be appropriately set depending on purposes.

The inorganic particle-containing layer (L) may be formed only of one layer, or may be formed of two or more layers.

The thickness of the inorganic particle-containing layer (L) is preferably 0.1 to 100 μm, more preferably 1 to 100 μm. As long as the thickness of the inorganic particle-containing layer (L) falls within the range, the layer can express extremely high flame retardancy without impairing the transparency and flexibility of the physically functional flame-retardant polymer member.

(1-5-6. Antireflection Layer (L))

Any appropriate layer such as a known antireflection layer can be adopted as the antireflection layer (L) as long as an antireflection effect is obtained.

The antireflection layer (L) may be a single layer formed only of one layer, or may be a plurality of layers formed of two or more layers.

A formation material for the antireflection layer (L) is, for example, a resin-based material such as a UV-curable acrylic resin, a hybrid type material obtained by dispersing inorganic fine particles made of colloidal silica or the like in a resin, or a sol-gel-based material using a metal alkoxide such as tetraethoxysilane or titanium tetraethoxide. Of those formation materials, a formation material containing a fluorine group is preferred for imparting contamination-preventing property to the surface of the layer. Of those formation materials, a formation material having a large inorganic component content is preferred for improving the scratch resistance of the layer. Such formation material having a large inorganic component content is, for example, the sol-gel-based material. The sol-gel-based material may be partially condensed.

An antireflection layer (L) capable of achieving compatibility between scratch resistance and low reflection is, for example, an antireflection layer formed from a material (material described in Japanese Patent Application Laid-open No. 2004-167827) containing: a siloxane oligomer having a number-average molecular weight of from 500 to 10,000 in terms of ethylene glycol; and a fluorine compound having a number-average molecular weight of 5,000 or more in terms of a polystyrene, and having a fluoroalkyl structure and a polysiloxane structure.

An inorganic sol is also given as an example of the formation material for the antireflection layer (L). Examples of the inorganic sol include silica, alumina, and magnesium fluoride.

Hollow, spherical silicon oxide fine particles may be incorporated into the formation material for the antireflection layer (L). Examples of such hollow, spherical silicon oxide fine particles include silica-based fine particles disclosed in Japanese Patent Application Laid-open No. 2001-233611.

Any appropriate temperature can be adopted as each of drying and curing temperatures upon formation of the antireflection layer (L).

For example, application methods such as fountain coating, die coating, spin coating, spray coating, gravure coating, roll coating, and bar coating as wet modes, and vacuum deposition can each be adopted for the formation of the antireflection layer (L).

When the antireflection layer (L) is a plurality of layers formed of two or more layers, the layer is preferably of, for example, a two-layer structure obtained by laminating a silicon oxide layer having a low refractive index (refractive index: about 1.45) on a titanium oxide layer having a high refractive index (refractive index: about 1.8).

The antireflection layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the antireflection layer (L) can be appropriately set depending on purposes.

The thickness of the antireflection layer (L) is preferably 0.005 to 30 μm, more preferably 0.01 to 25 μm, still more preferably 0.01 to 20 μm. As long as the thickness of the antireflection layer (L) falls within the range, the layer can express extremely excellent antireflection property without impairing the flame retardancy of the physically functional flame-retardant polymer member of the present invention.

(1-5-7. Light Selective Transmission Layer (L))

Any appropriate layer can be adopted as the light selective transmission layer (L) as long as a light selective transmission effect is obtained. The light selective transmission layer (L) is preferably at least one kind selected from a metal thin film and a dielectric thin film. Any appropriate metal material can be adopted as a metal material for the metal thin film. Any appropriate dielectric material can be adopted as a dielectric material for the dielectric thin film.

A dielectric multilayer film obtained by alternately laminating a dielectric layer A and a dielectric layer B having a higher refractive index than a refractive index which the dielectric layer A has is suitable as the light selective transmission layer (L).

A material whose refractive index falls within the range of 1.6 or less can be preferably selected as a material for constituting the dielectric layer A, and a material whose refractive index falls within the range of 1.2 to 1.6 can be more preferably selected as the material. Examples of such material include silica, alumina, lanthanum fluoride, magnesium fluoride, and sodium aluminum hexafluoride. The number of kinds of such materials may be only one, or may be two or more.

A material whose refractive index falls within the range of 1.7 or more can be preferably selected as a material for constituting the dielectric layer B, and a material whose refractive index falls within the range of 1.7 to 2.5 can be more preferably selected as the material. Examples of such material include products each obtained by using, as a main component, titanium oxide, zirconium oxide, tantalum pentoxide, niobium pentoxide, lanthanum oxide, yttrium oxide, zinc oxide, zinc sulfide, or indium oxide and incorporating a small amount of titanium oxide, tin oxide, cerium oxide, or the like thereinto. The number of kinds of those materials may be only one, or may be two or more.

The light selective transmission layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the light selective transmission layer (L) can be appropriately set depending on purposes.

The light selective transmission layer (L) may be a single layer formed only of one layer, or may be a plurality of layers formed of two or more layers.

When the light selective transmission layer (L) is a plurality of layers, the light selective transmission layer (L) is preferably at least one kind selected from a multilayer metal thin film and a multilayer dielectric thin film.

The light selective transmission layer (L) is specifically, for example, a multilayer film obtained by alternately laminating a silica layer and a titania layer.

The thickness of the light selective transmission layer (L) is preferably 0.005 to 100 μm, more preferably 0.01 to 50 μm, still more preferably 0.05 to 40 μm, particularly preferably 0.1 to 30 μm. As long as the thickness of the light selective transmission layer (L) falls within the range, the layer can express extremely excellent light selective transmission property without impairing the flame retardancy of the physically functional flame-retardant polymer member of the present invention, and can impart light selective transmission property to the various adherends.

<1-6. Chemically Functional Layer (L)>

Any appropriate layer can be adopted as the chemically functional layer (L) as long as the layer can express chemical functionality. Preferred examples of such chemically functional layer (L) include an alkali-resistant layer (L), an acid-resistant layer (L), and a solvent-resistant layer (L).

The thickness of the chemically functional layer (L) is preferably 0.1 to 100 μm, more preferably 1 to 100 μm. As long as the thickness of the Chemically functional layer (L) falls within the range, the layer can express sufficient chemical functionality without impairing the flame retardancy of the chemically functional flame-retardant polymer member of the present invention.

(1-6-1. Alkali-Resistant Layer (L))

Any appropriate layer can be adopted as the alkali-resistant layer (L) as long as an alkali-resistant effect is obtained.

The alkali-resistant layer (L) preferably contains an alkali-resistant resin. The content of the alkali-resistant resin in the alkali-resistant layer (L) is preferably 50 to 100 wt %, more preferably 70 to 100 wt %, still more preferably 90 to 100 wt %, particularly preferably 95 to 100 wt %, most preferably substantially 100 wt %.

Any appropriate alkali-resistant resin can be adopted as the alkali-resistant resin. Examples of such alkali-resistant resin include at least one kind selected from a urethane-based resin, a phenol-based resin, and a fluorine-based resin. Specific examples of the urethane-based resin include an oil-modified polyurethane resin, an alkyd-based polyurethane resin, a polyester-based polyurethane resin, and a polyether-based urethane resin. Specific examples of the phenol-based resin include a novolac type phenol resin and a resol type phenol resin. Specific examples of the fluorine-based resin include polytetrafluoroethylene, polychlorotrifluoroethylene, polyvinyl fluoride, polyvinylidene fluoride, a tetrafluoroethylene/hexafluoropropylene copolymer, and a chlorofluoroethylene/vinylidene fluoride copolymer.

The number of kinds of the alkali-resistant resins in the alkali-resistant layer (L) may be only one, or may be two or more.

The alkali-resistant layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the alkali-resistant layer (L) can be appropriately set depending on purposes.

The alkali-resistant layer (L) may be formed only of one layer, or may be formed of two or more layers.

The thickness of the alkali-resistant layer (L) is preferably 0.1 to 100 μm, more preferably 1 to 100 μm. As long as the thickness of the alkali-resistant layer (L) falls within the range, the layer can express extremely excellent alkali resistance without impairing the flame retardancy of the chemically functional flame-retardant polymer member of the present invention.

(1-6-2. Acid-Resistant Layer (L))

Any appropriate layer can be adopted as the acid-resistant layer (L) as long as an acid-resistant effect is obtained.

The acid-resistant layer (L) preferably contains an acid-resistant resin. The content of the acid-resistant resin in the acid-resistant layer (L) is preferably 50 to 100 wt %, more preferably 70 to 100 wt %, still more preferably 90 to 100 wt %, particularly preferably 95 to 100 wt %, most preferably substantially 100 wt %.

Any appropriate acid-resistant resin can be adopted as the acid-resistant resin. Examples of such acid-resistant resin include at least one kind selected from a phenol-based resin, a silicone-based resin, and a fluorine-based resin. Specific examples of the phenol-based resin include a novolac type phenol resin and a resol type phenol resin. Specific examples of the silicone-based resin include dimethylpolysiloxane, methylhydropolysiloxane, a silicone oil or a silicone varnish, and a silicone-modified acrylic copolymer shown in Japanese Patent Application Laid-open No. Hei 09-111185. Specific examples of the fluorine-based resin include polytetrafluoroethylene, polychlorotrifluoroethylene, polyvinyl fluoride, polyvinylidene fluoride, a tetrafluoroethylene/hexafluoropropylene copolymer, and a chlorofluoroethylene/vinylidene fluoride copolymer.

The number of kinds of the acid-resistant resins in the acid-resistant layer (L) may be only one, or may be two or more.

The acid-resistant layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the acid-resistant layer (L) can be appropriately set depending on purposes.

The acid-resistant layer (L) may be formed only of one layer, or may be formed of two or more layers.

The thickness of the acid-resistant layer (L) is preferably 0.1 to 100 μm, more preferably 1 to 100 μm. As long as the thickness of the acid-resistant layer (L) falls within the range, the layer can express extremely excellent acid resistance without impairing the flame retardancy of the chemically functional flame-retardant polymer member of the present invention.

(1-6-3. Solvent-Resistant Layer (L))

Any appropriate layer can be adopted as the solvent-resistant layer (L) as long as a solvent-resistant effect is obtained.

The solvent-resistant layer (L) preferably contains a solvent-resistant resin. The content of the solvent-resistant resin in the solvent-resistant layer (L) is preferably 50 to 100 wt %, more preferably 70 to 100 wt %, still more preferably 90 to 100 wt %, particularly preferably 95 to 100 wt %, most preferably substantially 100 wt %.

Any appropriate solvent-resistant resin can be adopted as the solvent-resistant resin. Examples of such solvent-resistant resin include at least one kind selected from a urethane-based resin, a phenol-based resin, a silicone-based resin, and a fluorine-based resin. Specific examples of the urethane-based resin include an oil-modified polyurethane resin, an alkyd-based polyurethane resin, a polyester-based polyurethane resin, and a polyether-based urethane resin. Specific examples of the phenol-based resin include a novolac type phenol resin and a resol type phenol resin. Specific examples of the silicone-based resin include dimethylpolysiloxane, methylhydropolysiloxane, a silicone oil or a silicone varnish, and a silicone-modified acrylic copolymer shown in Japanese Patent Application Laid-open No. Hei 09-111185. Specific examples of the fluorine-based resin include polytetrafluoroethylene, polychlorotrifluoroethylene, polyvinyl fluoride, polyvinylidene fluoride, a tetrafluoroethylene/hexafluoropropylene copolymer, and a chlorofluoroethylene/vinylidene fluoride copolymer.

The number of kinds of the solvent-resistant resins in the solvent-resistant layer (L) may be only one, or may be two or more.

The solvent-resistant layer (L) may further contain any appropriate additive depending on purposes.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives that can be incorporated into the solvent-resistant layer (L) can be appropriately set depending on purposes.

The solvent-resistant layer (L) may be formed only of one layer, or may be formed of two or more layers.

The thickness of the solvent-resistant layer (L) is preferably 0.1 to 100 μm, more preferably 1 to 100 μm. As long as the thickness of the solvent-resistant layer (L) falls within the range, the layer can express extremely excellent solvent resistance without impairing the flame retardancy of the chemically functional flame-retardant polymer member of the present invention.

<1-7. Physically Functional Flame-Retardant Polymer Member>

The thickness of the entirety of the physically functional flame-retardant polymer member is preferably 10 to 5,000 μm, more preferably 20 to 4,000 μm, still more preferably 30 to 3,000 μm because of the following reasons. When the thickness is excessively small, the member may not show sufficient flame retardancy. When the thickness is excessively large, the member is hard to wind in a sheet shape and is hence poor in handleability in some cases. It should be noted that the thickness of the entirety of the physically functional flame-retardant polymer member means the total of the thickness of the flame-retardant layer (A), the thickness of the polymer layer (B), and the thickness of the physically functional layer (L).

In addition, the ratio of the thickness of the flame-retardant layer (A) to the thickness of the entirety of the physically functional flame-retardant polymer member (the total of the thickness of the flame-retardant layer (A), the thickness of the polymer layer (B), and the thickness of the physically functional layer (L)) is preferably 50% or less, more preferably 50 to 0.1%, still more preferably 40 to 1%. When the ratio of the thickness of the flame-retardant layer (A) deviates from the range, its flame retardancy may be problematic or the strength of the flame-retardant layer (A) may be problematic.

<1-8. Chemically Functional Flame-Retardant Polymer Member>

The thickness of the entirety of the chemically functional flame-retardant polymer member is preferably 10 to 5,000 μm, more preferably 20 to 4,000 μm, still more preferably 30 to 3,000 μm because of the following reasons. When the thickness is excessively small, the member may not show sufficient flame retardancy. When the thickness is excessively large, the member is hard to wind in a sheet shape and is hence poor in handleability in some cases. It should be noted that the thickness of the entirety of the chemically functional flame-retardant polymer member means the total of the thickness of the flame-retardant layer (A), the thickness of the polymer layer (B), and the thickness of the chemically functional layer (L).

In addition, the ratio of the thickness of the flame-retardant layer (A) to the thickness of the entirety of the chemically functional flame-retardant polymer member (the total of the thickness of the flame-retardant layer (A), the thickness of the polymer layer (B), and the thickness of the chemically functional layer (L)) is preferably 50% or less, more preferably 50 to 0.1%, still more preferably 40 to 1%. When the ratio of the thickness of the flame-retardant layer (A) deviates from the range, its flame retardancy may be problematic or the strength of the flame-retardant layer (A) may be problematic.

<1-9. Flame Retardancy of Physically Functional Flame-Retardant Polymer Member>

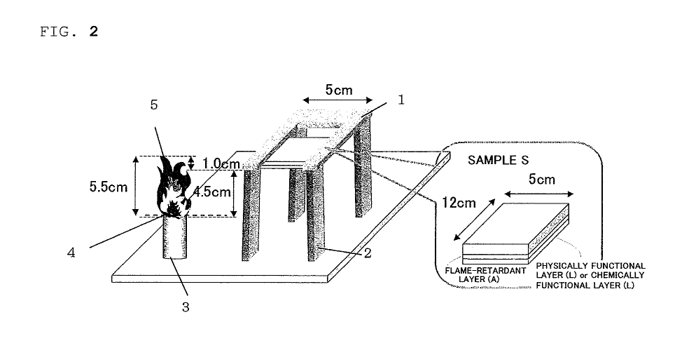

The physically functional flame-retardant polymer member of the present invention preferably satisfies the following flame retardancy. That is, in a horizontal firing test involving horizontally placing the physically functional flame-retardant polymer member of the present invention with its side of the physically functional layer (L) as a lower surface so that the lower surface is in contact with air, placing a Bunsen burner so that the flame port of the Bunsen burner is positioned at a lower portion distant from the lower surface on the side of the physically functional layer (L) by 45 mm, and bringing the flame of the Bunsen burner having a height of 55 mm from the flame port into contact with the lower surface of the physically functional layer (L) for 30 seconds, the member has flame retardancy capable of blocking the flame. The horizontal firing test is a test for blocking property against a flame from the side of the physically functional layer (L) of the oil-repellent flame-retardant polymer member. Therefore, in the horizontal firing test, the flame of the Bunsen burner is brought into contact from the side of the physically functional layer (L) while being prevented from being in contact with the end portion of the physically functional flame-retardant polymer member. In ordinary cases, the test is performed by placing the Bunsen burner so that the flame of the Bunsen burner is in contact with a site distant from each of all end portions of the physically functional flame-retardant polymer member by at least 50 mm or more. Any appropriate size can be adopted as the size of the physically functional flame-retardant polymer member to be subjected to the horizontal firing test. For example, a rectangle measuring 5 to 20 cm wide by 10 to 20 cm long can be used as the size of the physically functional flame-retardant polymer member. In FIG. 2 and Examples, a member of a rectangular shape measuring 5 cm by 12 cm is used.

The horizontal firing test is specifically performed as described below. As illustrated in FIG. 2, both sides of a rectangular, physically functional flame-retardant polymer member S are each horizontally fixed by two upper and lower supporting plates 1 with the side of the physically functional layer (L) of the rectangle as a lower surface. With regard to the supporting plates 1, both sides in the lengthwise direction of the lower supporting plate 1 are provided with columns 2 so that the lower surface of the physically functional flame-retardant polymer member S is in contact with air and a Bunsen burner 3 can be placed. In FIG. 2, the rectangular, physically functional flame-retardant polymer member S measuring 5 cm by 12 cm is used, and each side of the member having a length of 12 cm is fixed by the supporting plates 1 (each having a width of 10 cm). The Bunsen burner 3 is placed so that a distance between its flame port 4 and the lower surface of the physically functional flame-retardant polymer member S is 45 mm. In addition, the flame port 4 of the Bunsen burner 3 is positioned below the center of the physically functional flame-retardant polymer member S. The height of the flame of the Bunsen burner 3 from the flame port is adjusted to 55 mm. Although the Bunsen burner 3 is positioned below the flame-retardant polymer member S, the Bunsen burner 3 is illustrated outside the supporting plates 1 in FIG. 2 for convenience.

The test for flame retardancy can evaluate the flame-blocking property of the physically functional flame-retardant polymer member and the shape-maintaining property of the flame-retardant polymer member when the flame of the Bunsen burner having a size of 1 cm (a difference between the height of the flame from the flame port 4 of the Bunsen burner 3, i.e., 55 mm, and a distance between the lower surface on the side of the physically functional layer (L) and the flame port 4 of the Bunsen burner 3, i.e., 45 mm) is brought into contact for 30 seconds. A propane gas is used as the gas of the Bunsen burner and the test is performed in the air.

As described in Examples, the physically functional flame-retardant polymer member can be evaluated for its flame-blocking property by: placing a White Economy 314-048 (manufactured by Biznet) as copy paper at a position 3 mm above the physically functional flame-retardant polymer member S (above the upper supporting plates 1 on both sides); and observing the presence or absence of the combustion of the copy paper in the horizontal firing test.

<1-10. Flame Retardancy of Chemically Functional Flame-Retardant Polymer Member>

The chemically functional flame-retardant polymer member of the present invention preferably satisfies the following flame retardancy. That is, in a horizontal firing test involving horizontally placing the chemically functional flame-retardant polymer member of the present invention with its side of the chemically functional layer (L) as a lower surface so that the lower surface is in contact with air, placing a Bunsen burner so that the flame port of the Bunsen burner is positioned at a lower portion distant from the lower surface on the side of the chemically functional layer (L) by 45 mm, and bringing the flame of the Bunsen burner having a height of 55 mm from the flame port into contact with the lower surface of the chemically functional layer (L) for 30 seconds, the member has flame retardancy capable of blocking the flame. The horizontal firing test is a test for blocking property against a flame from the side of the chemically functional layer (L) of the oil-repellent flame-retardant polymer member. Therefore, in the horizontal firing test, the flame of the Bunsen burner is brought into contact from the side of the chemically functional layer (L) while being prevented from being in contact with the end portion of the chemically functional flame-retardant polymer member. In ordinary cases, the test is performed by placing the Bunsen burner so that the flame of the Bunsen burner is in contact with a site distant from each of all end portions of the chemically functional flame-retardant polymer member by at least 50 mm or more. Any appropriate size can be adopted as the size of the chemically functional flame-retardant polymer member to be subjected to the horizontal firing test. For example, a rectangle measuring 5 to 20 cm wide by 10 to 20 cm long can be used as the size of the chemically functional flame-retardant polymer member. In FIG. 2 and Examples, a member of a rectangular shape measuring 5 cm by 12 cm is used.

The horizontal firing test is specifically performed as described below. As illustrated in FIG. 2, both sides of a rectangular, chemically functional flame-retardant polymer member S are each horizontally fixed by two upper and lower supporting plates 1 with the side of the chemically functional layer (L) of the rectangle as a lower surface. With regard to the supporting plates 1, both sides in the lengthwise direction of the lower supporting plate 1 are provided with columns 2 so that the lower surface of the chemically functional flame-retardant polymer member S is in contact with air and a Bunsen burner 3 can be placed. In FIG. 2, the rectangular, chemically functional flame-retardant polymer member S measuring 5 cm by 12 cm is used, and each side of the member having a length of 12 cm is fixed by the supporting plates 1 (each having a width of 10 cm). The Bunsen burner 3 is placed so that a distance between its flame port 4 and the lower surface of the chemically functional flame-retardant polymer member S is 45 mm. In addition, the flame port 4 of the Bunsen burner 3 is positioned below the center of the chemically functional flame-retardant polymer member S. The height of the flame of the Bunsen burner 3 from the flame port is adjusted to 55 mm. Although the Bunsen burner 3 is positioned below the flame-retardant polymer member S, the Bunsen burner 3 is illustrated outside the supporting plates 1 in FIG. 2 for convenience.

The test for flame retardancy can evaluate the flame-blocking property of the Chemically functional flame-retardant polymer member and the shape-maintaining property of the flame-retardant polymer member when the flame of the Bunsen burner having a size of 1 cm (a difference between the height of the flame from the flame port 4 of the Bunsen burner 3, i.e., 55 mm, and a distance between the lower surface on the side of the chemically functional layer (L) and the flame port 4 of the Bunsen burner 3, i.e., 45 mm) is brought into contact for 30 seconds. A propane gas is used as the gas of the Bunsen burner and the test is performed in the air.

As described in Examples, the chemically functional flame-retardant polymer member can be evaluated for its flame-blocking property by: placing a White Economy 314-048 (manufactured by Biznet) as copy paper at a position 3 mm above the chemically functional flame-retardant polymer member S (above the upper supporting plates 1 on both sides); and observing the presence or absence of the combustion of the copy paper in the horizontal firing test.

<1-11. Transparency>

Each of the physically functional flame-retardant polymer member of the present invention and the chemically functional flame-retardant polymer member the present invention is preferably substantially transparent, and has a total light transmittance of preferably 60% or more, more preferably 70% or more, still more preferably 80% or more, particularly preferably 90% or more. Further, its haze is preferably 20% or less, more preferably 10% or less, still more preferably 5% or less.

<1-12. Flexibility>

Each of the physically functional flame-retardant polymer member of the present invention and the chemically functional flame-retardant polymer member of the present invention has flexibility peculiar to plastic. For example, in the case where no flaw or crack occurs even when both ends of a side having a length of 5 cm of the physically functional flame-retardant polymer member or chemically functional flame-retardant polymer member measuring 5 cm by 10 cm are repeatedly brought into contact with each other 50 times by bending the side in a mountain fold manner and in a valley fold manner, the member can be judged to have good flexibility. In addition, in the case where no flaw or crack occurs in the physically functional flame-retardant polymer member or chemically functional flame-retardant polymer member measuring 5 cm by 10 cm when the physically functional flame-retardant polymer member or chemically functional flame-retardant polymer member measuring 5 cm by 10 cm is wound around a rod having a diameter of 1 cm and then the wound flame-retardant polymer member is peeled, the member can be judged to have good flexibility.

<1-13. Conductivity>

When the physically functional layer (L) is the conductive layer (L), the physically functional flame-retardant polymer member of the present invention has excellent conductivity. For example, as described in Examples, an evaluation for the conductivity can be performed by exposing a measurement site, and measuring the surface resistivity ρₛ (Ω/□) of the measurement site with a Loresta resistivity meter or a Hiresta resistivity meter (manufactured by Mitsubishi Chemical Corporation). The common logarithm of the measured surface resistivity ρₛ (log(ρₛ)) can be used as an indicator for the conductivity of the physically functional flame-retardant polymer member of the present invention. The conductivity of the physically functional flame-retardant polymer member of the present invention is preferably −3 to 7Ω/□, more preferably −3 to 6Ω/□, still more preferably −3 to 5Ω/□ in terms of a value for the log(ρₛ). The physically functional flame-retardant polymer member of the present invention has excellent conductivity and hence is applicable to, for example, use for electrically connecting objects or shielding use for removing the effect of an electromagnetic wave.

<1-14. Anti-Fingerprint Property>

When the physically functional layer (L) is the anti-fingerprint layer (L), the physically functional flame-retardant polymer member of the present invention has excellent anti-fingerprint property. For example, as described in Examples, an evaluation for the anti-fingerprint property can be performed by causing a fingerprint to adhere onto the member, spreading black paper or the like below the member, and visually observing the portion having the fingerprint adhering thereto from a vertical direction to confirm how the fingerprint looks like.

<1-15. Scratch Resistance>

When the physically functional layer (L) is the hard coat layer (L), the physically functional flame-retardant polymer member of the present invention has excellent scratch resistance. For example, as described in Examples, an evaluation for the scratch resistance can be performed by observing a degree of a flaw occurring when steel wool or the like is rubbed against the surface of the member. In addition, the scratch resistance can be evaluated on the basis of generally well-known pencil hardness as well.

<1-16. Printing Property>

When the physically functional layer (L) is the ink-absorbing layer (L), the physically functional flame-retardant polymer member of the present invention has excellent printing property. For example, as described in Examples, an evaluation for the printing property was performed by performing printing on the surface on the side opposite to the polymer layer (B) of the flame-retardant polymer member with any appropriate inkjet printer, and visually observing the quality of the printing.

<1-17. High Flame Retardancy >

When the physically functional layer (L) is the inorganic particle-containing layer (L), the physically functional flame-retardant polymer member of the present invention can express extremely high flame retardancy.

<1-18. Antireflection Property>

When the physically functional layer (L) is the antireflection layer (L), the physically functional flame-retardant polymer member of the present invention has excellent antireflection property. For example, as described in Examples, an evaluation for the antireflection property can be performed by attaching the member to be evaluated to a black image, and evaluating a degree of unnecessary reflection in a room with a light source such as a fluorescent lamp on.

<1-19. Light Selective Transmission Property>

When the physically functional layer (L) is the light selective transmission layer (L), the physically functional flame-retardant polymer member of the present invention has excellent light selective transmission property. Hence, the member can make various adherends flame-retardant, and at the same time, can impart light selective transmission property to the various adherends, by being flexibly attached to the various adherends. For example, the light selective transmission property can be evaluated by measuring a transmittance of light having wavelengths within a specific range.

<1-20. Alkali Resistance>

When the chemically functional layer (L) is the alkali-resistant layer (L), the chemically functional flame-retardant polymer member of the present invention has excellent alkali resistance. For example, as described in Examples, an evaluation for the alkali resistance can be performed by bringing an alkaline aqueous solution into contact with the surface on the flame-retardant layer (A) side of the flame-retardant polymer member, and observing a change in the surface after the contact.

<1-21. Acid Resistance>

When the chemically functional layer (L) is the acid-resistant layer (L), the chemically functional flame-retardant polymer member of the present invention has excellent acid resistance. For example, as described in Examples, an evaluation for the acid resistance can be performed by bringing an acidic aqueous solution into contact with the surface on the flame-retardant layer (A) side of the flame-retardant polymer member, and observing a change in the surface after the contact.

<1-22. Solvent Resistance>

When the chemically functional layer (L) is the solvent-resistant layer (L), the chemically functional flame-retardant polymer member of the present invention has excellent solvent resistance. For example, as described in Examples, an evaluation for the solvent resistance can be performed by bringing a solvent such as xylene into contact with the surface on the flame-retardant layer (A) side of the flame-retardant polymer member, and observing a change in the surface after the contact.

<<2. Production of Physically Functional Flame-Retardant Polymer Member or Chemically Functional Flame-Retardant Polymer Member>>

Any appropriate production method can be adopted as a method of producing the physically functional flame-retardant polymer member or chemically functional flame-retardant polymer member of the present invention as long as, for example, a construction including the polymer layer (B), the flame-retardant layer (A), and the physically functional layer (L) or the chemically functional layer (L) in the stated order is obtained. In the following description, the physically functional flame-retardant polymer member or chemically functional flame-retardant polymer member of the present invention is sometimes referred to as “flame-retardant polymer member of the present invention.”

<2-1. Flame-Retardant Polymer Member Production Method (1)>

A production method (1) is preferably adopted as a method of producing the flame-retardant polymer member of the present invention because good flame retardancy is obtained. In the production method (1), the flame-retardant polymer member of the present invention is produced by a production method including the step of laminating a syrupy polymerizable composition layer (a) formed of a polymerizable composition (α) containing a polymerizable monomer (m) and the layered inorganic compound (f), and a solid monomer-absorbing layer (b) containing a polymer (p) and capable of absorbing the polymerizable monomer (m), followed by the performance of polymerization, and the step of producing the physically functional layer (L) or the chemically functional layer (L).

According to the production method (1), the flame-retardant layer (A) and the polymer layer (B) can be obtained by: laminating the polymerizable composition layer (a) formed of the polymerizable composition (α) containing the polymerizable monomer (m) and the layered inorganic compound (f) incompatible with a polymer obtained by polymerizing the polymerizable monomer on at least one surface of the solid monomer-absorbing layer (b) containing the polymer (p) and capable of absorbing the polymerizable monomer (m); and then polymerizing the polymerizable monomer.

In the production method (1), as a result of the lamination, part of the polymerizable monomer (m) in the polymerizable composition layer (a) is absorbed by the monomer-absorbing layer (b), and at the same time, the layered inorganic compound (f) moves in the polymerizable composition layer (a). Accordingly, an unevenly distributed polymerizable composition layer (a1) is obtained, in which the layered inorganic compound (f) is unevenly distributed toward the side opposite to the monomer-absorbing layer (b). Then, the polymerizable monomer (m) in the unevenly distributed polymerizable composition layer (a1) and the polymerizable monomer (m) in the monomer-absorbing layer (b) are polymerized and cured. Thus, the flame-retardant layer (A) and the polymer layer (B) are obtained. An unevenly distributed portion (a21) of the layered inorganic compound (f) in an unevenly distributed polymer layer (a2) obtained by curing the unevenly distributed polymerizable composition layer (a1) corresponds to the flame-retardant layer (A). A non-unevenly distributed portion (a22) of the layered inorganic compound (f) in the unevenly distributed polymer layer (a2) and a cured monomer-absorbing layer (b2) formed by polymerizing a monomer-absorbing layer (b1) obtained by the absorption of the polymerizable monomer (m) by the monomer-absorbing layer (b) correspond to the polymer layer (B). In other words, a portion obtained by combining the non-unevenly distributed portion (a22) and the cured monomer-absorbing layer (b2) corresponds to the polymer layer (B).

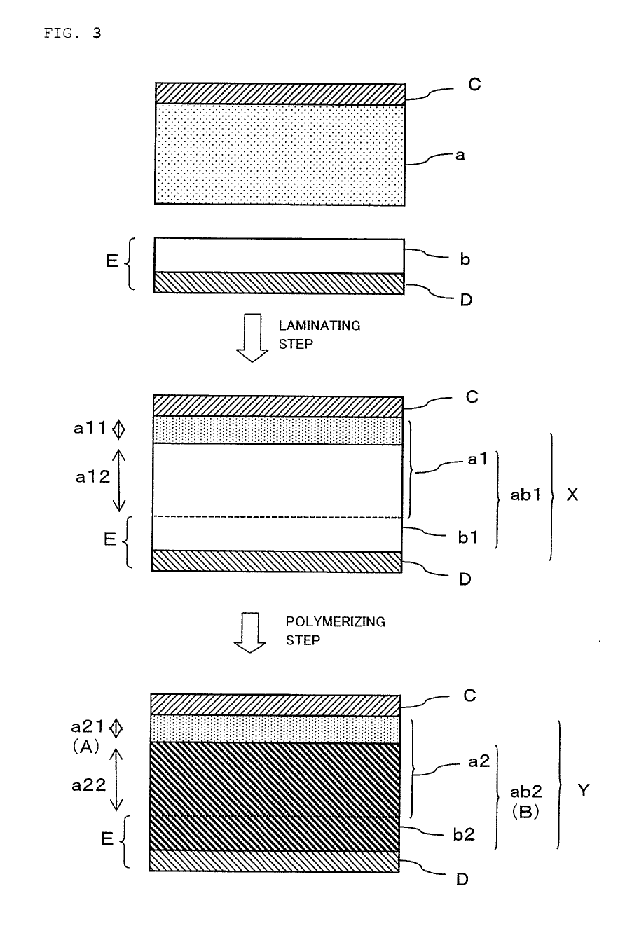

Hereinafter, the “step of laminating the syrupy polymerizable composition layer (a) formed of the polymerizable composition (α) containing the polymerizable monomer (m) and the layered inorganic compound (f), and the solid monomer-absorbing layer (b) containing the polymer (p) and capable of absorbing the polymerizable monomer (m), followed by the performance of polymerization” in the flame-retardant polymer member production method (1) is described with reference to FIG. 3.

First, in a laminating step (1), a laminate (X) is obtained by laminating the polymerizable composition layer (a) and the monomer-absorbing layer (b). The polymerizable composition layer (a) contains the layered inorganic compound (f) and the polymerizable monomer (m) (not shown). Although the polymerizable composition layer (a) can be laminated on at least one side of the monomer-absorbing layer (b), FIG. 3 illustrates the case where the layer is laminated only on one side of the monomer-absorbing layer (b). In FIG. 3, a cover film (C) is provided on the side of the polymerizable composition layer (a) not laminated on the monomer-absorbing layer (b). In addition, in FIG. 3, the monomer-absorbing layer (b) is provided on a base material film (D) and then the entirety is used as a monomer-absorbable sheet (E) with a base material.

In the laminate (X) obtained by the laminating step (1), part of the polymerizable monomer (m) in the polymerizable composition layer (a) is absorbed by the monomer-absorbing layer (b) (not shown). Meanwhile, in the polymerizable composition layer (a), the layered inorganic compound (f) moves, and the layered inorganic compound (f) is unevenly distributed toward the side opposite to the monomer-absorbing layer (b). Thus, the unevenly distributed polymerizable composition layer (a1) having an unevenly distributed portion (a11) and a non-unevenly distributed portion (a12) of the layered inorganic compound (f) is obtained. That is, as a result of the lamination of the polymerizable composition layer (a) and the monomer-absorbing layer (b), the polymerizable monomer (m) in the polymerizable composition layer (a) is absorbed by the monomer-absorbing layer (b), and the layered inorganic compound (f) is unevenly distributed toward the side opposite to the monomer-absorbing layer (b). Thus, the unevenly distributed polymerizable composition layer (a1) is obtained.

The phenomenon of the uneven distribution of the layered inorganic compound (f) in the unevenly distributed polymerizable composition layer (a1) is assumed to be caused by the swelling of the monomer-absorbing layer (b). That is, the monomer-absorbing layer (b) absorbs the polymerizable monomer (m) to swell. Meanwhile, the layered inorganic compound (f) is free of being absorbed by the monomer-absorbing layer (b). Accordingly, the layered inorganic compound (f) may be unevenly distributed in such a manner as to remain in the polymerizable composition layer (a). Therefore, when a base material that does not absorb the polymerizable monomer (m) is used as the monomer-absorbing layer (b), the base material does not swell with respect to the polymerizable monomer (m). Accordingly, even when the polymerizable composition layer (a) is laminated on the base material, the layered inorganic compound (f) is not unevenly distributed and hence the unevenly distributed polymerizable composition layer (a1) is not obtained.

In the flame-retardant polymer member production method (1), the laminate (X) can be subjected to a heating step. The unevenly distributed polymerizable composition layer (a1) including the unevenly distributed portion (a11) in which the layered inorganic compound (f) is unevenly distributed at a high density is obtained by the heating step. A heating temperature and a heating time for the laminate (X) are controlled in the heating step. When such heating step is performed, the monomer-absorbing layer (b) of the laminate (X) absorbs a larger amount of the polymerizable monomer (m) in the polymerizable composition layer (a) than that in the case where the laminating step (1) is merely performed, and hence high-density uneven distribution of the layered inorganic compound (f) becomes significant. As described above, the unevenly distributed portion (a11) in which the layered inorganic compound (f) is unevenly distributed at a high density is obtained by the heating step. Accordingly, even when the unevenly distributed polymerizable composition layer (a1) and the unevenly distributed polymer layer (a2) are thin layers, the layered inorganic compound (f) can be unevenly distributed with efficiency and hence a laminate (Y) having the thin-layered unevenly distributed polymer layer (a2) can be obtained.

The polymerizable monomer (m) in the polymerizable composition layer (a) is subjected to a polymerizing step (2) after part thereof has been absorbed by the monomer-absorbing layer (b). Accordingly, adhesiveness between the unevenly distributed polymer layer (a2) and the cured monomer-absorbing layer (b2) is excellent in the laminated structure of the unevenly distributed polymer layer (a2) and the cured monomer-absorbing layer (b2).

The monomer-absorbing layer (b1) in the laminate (X) is in a swollen state as a result of the absorption of the polymerizable monomer (m) by the monomer-absorbing layer (b). Accordingly, an interface between the non-unevenly distributed portion (a12) of the layered inorganic compound (f) in the unevenly distributed polymerizable composition layer (a1) and the monomer-absorbing layer (b1) cannot be observed (a composite site of these layers is represented as ab1 in FIG. 3). In FIG. 3, the interface is indicated by a broken line for convenience.

Next, the polymerizable monomer (m) in the unevenly distributed polymerizable composition layer (a1) is polymerized by subjecting the laminate (X) to a polymerizing step (2). Thus, the laminate (Y) including the unevenly distributed polymer layer (a2) is obtained. The unevenly distributed polymer layer (a2) is obtained by curing the unevenly distributed polymerizable composition layer (a1) while maintaining the unevenly distributed structure in the layer. The unevenly distributed polymer layer (a2) has the unevenly distributed portion (a21) of the layered inorganic compound (f) and the non-unevenly distributed portion (a22) of the layered inorganic compound (f).

The monomer-absorbing layer (b1) is turned into the cured monomer-absorbing layer (b2) by the polymerizing step (2). Although an interface between the non-unevenly distributed portion (a22) of the layered inorganic compound (f) in the unevenly distributed polymer layer (a2) and the cured monomer-absorbing layer (b2) cannot be observed in the laminate (Y) (a composite site of these layers is represented as ab2 in FIG. 3), the interface is indicated by a broken line in FIG. 3 for convenience.

The production method (1) includes the step of producing the physically functional layer (L) or the chemically functional layer (L). The step of producing the physically functional layer (L) or the chemically functional layer (L) (physically functional layer (L) or chemically functional layer (L)-producing step (3)) can be performed at any appropriate timing in the Production method (1).

(2-1-1. Laminating Step (1))

In the laminating step (1), a laminate having a structure “polymerizable composition layer (a)/monomer-absorbing layer (b)” is produced by laminating the polymerizable composition layer (a) on at least one side of the monomer-absorbing layer (b). The polymerizable composition layer (a) is a layer formed of the polymerizable composition (α).

(2-1-1-1. Polymerizable Composition (α))

The polymerizable composition (α) contains at least the polymerizable monomer (m) and the layered inorganic compound (f).

The polymerizable composition (α) may be a partially polymerized composition obtained by polymerizing part of the polymerizable monomer (m) in terms of, for example, handleability and application property.

The description of the polymerizable monomer in the section <1-1. Polymer layer (B)> can be cited as specific description of the polymerizable monomer (m).

When the flame-retardant polymer member is used in an application where pressure-sensitive adhesive property is demanded of the unevenly distributed polymer layer (a2), the content of an alkyl (meth)acrylate is preferably 70 wt % or more, more preferably 80 wt % or more with respect to the total amount of the polymerizable monomer (m).

When an oil-repellent flame-retardant polymer member is used in an application where hard physical property is demanded of the unevenly distributed polymer layer (a2) (e.g., a film application), the content of an alkyl (meth)acrylate is preferably 95 wt % or less, more preferably 0.01 to 95 wt %, still more preferably 1 to 70 wt % with respect to the total amount of the polymerizable monomer (m).

When the flame-retardant polymer member is used in an application where pressure-sensitive adhesive property is demanded of the unevenly distributed polymer layer (a2), the content of a polyfunctional monomer is preferably 2 wt % or less, more preferably 0.01 to 2 wt %, still more preferably 0.02 to 1 wt % with respect to the total amount of the polymerizable monomer (m). When the content of the polyfunctional monomer exceeds 2 wt % with respect to the total amount of the polymerizable monomer (m), there may arise a problem in that the cohesive strength of a flame-retardant polymer member to be obtained becomes excessively high and the member becomes excessively brittle. In addition, when the content of the polyfunctional monomer is less than 0.01 wt % with respect to the total amount of the polymerizable monomer (m), the purpose of the use of the polyfunctional monomer may not be achieved.

When the flame-retardant polymer member is used in an application where hard physical property is demanded of the unevenly distributed polymer layer (a2), the content of a polyfunctional monomer is preferably 95 wt % or less, more preferably 0.01 to 95 wt %, still more preferably 1 to 70 wt % with respect to the total amount of the polymerizable monomer (m). When the content of the polyfunctional monomer exceeds 95 wt % with respect to the total amount of the polymerizable monomer (m), curing shrinkage at the time of polymerization increases. Accordingly, it may become impossible to obtain a flame-retardant polymer member having a uniform film shape or sheet shape, or a flame-retardant polymer member to be obtained may become excessively brittle. In addition, when the content of the polyfunctional monomer is less than 0.01 wt % with respect to the total amount of the polymerizable monomer (m), it may become impossible to obtain a flame-retardant polymer member having sufficient solvent resistance and heat resistance.

When the flame-retardant polymer member is used in an application where pressure-sensitive adhesive property is demanded of the unevenly distributed polymer layer (a2), the content of a polar group-containing monomer is preferably 30 wt % or less, more preferably 1 to 30 wt %, still more preferably 2 to 20 wt % with respect to the total amount of the polymerizable monomer (m). When the content of the polar group-containing monomer exceeds 30 wt % with respect to the total amount of the polymerizable monomer (m), the cohesive strength of a polymer to be obtained may become excessively high, for example, the unevenly distributed polymer layer (a2) may become excessively hard, and the adhesiveness may reduce. In addition, when the content of the polar group-containing monomer is less than 1 wt % with respect to the total amount of the polymerizable monomer (m), the cohesive strength of a polymer to be obtained may reduce and a high shearing force may not be obtained.

When the flame-retardant polymer member is used in an application where hard physical property is demanded of the unevenly distributed polymer layer (a2), the content of a polar group-containing monomer is preferably 95 wt % or less, more preferably 0.01 to 95 wt %, still more preferably 1 to 70 wt % with respect to the total amount of the polymerizable monomer (m). When the content of the polar group-containing monomer exceeds 95 wt % with respect to the total amount of the polymerizable monomer (m), for example, physical functionality or chemical functionality may become insufficient, which increases a change in quality of the flame-retardant polymer member due to a use environment (such as humidity or moisture). In addition, when the usage ratio of the polar group-containing monomer is 0.01 wt % or less with respect to the total amount of the polymerizable monomer (m), the addition amount of a (meth)acrylate having a high glass transition temperature (Tg) (such as isobornyl acrylate), a polyfunctional monomer, or the like is increased in the case of obtaining hard physical property, and a flame-retardant polymer member to be obtained may become excessively brittle.

The description in the section <1-3. Layered inorganic compound (f)> can be cited as specific description of the layered inorganic compound (f).

The polymerizable composition (α) may contain any appropriate additive. The description in the section <1-4. Additive> can be cited as specific description of such additive.

The polymerizable composition (α) can contain any appropriate polymerization initiator. Examples of the polymerization initiator include a photopolymerization initiator and a thermal polymerization initiator. The number of kinds of the polymerization initiators may be only one, or may be two or more.

As the photopolymerization initiator, any appropriate photopolymerization initiator may be adopted. Examples of the photopolymerization initiator include a benzoin ether-based photopolymerization initiator, an acetophenone-based photopolymerization initiator, an α-ketol-based photopolymerization initiator, an aromatic sulfonyl chloride-based photopolymerization initiator, a photoactive oxime-based photopolymerization initiator, a benzoin-based photopolymerization initiator, a benzyl-based photopolymerization initiator, a benzophenone-based photopolymerization initiator, a ketal-based photopolymerization initiator, and a thioxanthone-based photopolymerization initiator. The number of kinds of the photopolymerization initiators may be only one, or may be two or more.

An example of the ketal-based photopolymerization initiator is 2,2-dimethoxy-1,2-diphenylethan-1-one (such as “Irgacure 651” (trade name; manufactured by Ciba Speciality Chemicals Inc.)). Examples of the acetophenone-based photopolymerization initiator include 1-hydroxycyclohexyl phenyl ketone (such as “Irgacure 184” (trade name; manufactured by Ciba Speciality Chemicals Inc.)), 2,2-diethoxyacetophenone, 2,2-dimethoxy-2-phenylacetophenone, 4-phenoxydichloroacetophenone, and 4-(t-butyl)dichloroacetophenone. Examples of the benzoin ether-based photopolymerization initiator include benzoin methyl ether, benzoin ethyl ether, benzoin propyl ether, benzoin isopropyl ether, and benzoin isobutyl ether. An example of the acylphosphine oxide-based photopolymerization initiator is “Lucirin TPO” (trade name; manufactured by BASF Japan Ltd.). Examples of the α-ketol-based photopolymerization initiator include 2-methyl-2-hydroxypropiophenone and 1-[4-(2-hydroxyethyl)phenyl]-2-methylpropan-1-one. An example of the aromatic sulfonyl chloride-based photopolymerization initiator is 2-naphthalenesulfonyl chloride. An example of the photoactive oxime-based photopolymerization initiator is 1-phenyl-1,1-propanedione-2-(o-ethoxycarbonyl)-oxime. An example of the benzoin-based photopolymerization initiator is benzoin. An example of the benzyl-based photopolymerization initiator is benzyl. Examples of the benzophenone-based photopolymerization initiator include benzophenone, benzoylbenzoic acid, 3,3′-dimethyl-4-methoxybenzophenone, polyvinyl benzophenone, and α-hydroxycyclohexyl phenyl ketone. Examples of the thioxanthone-based photopolymerization initiator include thioxanthone, 2-chlorothioxanthone, 2-methylthioxanthone, 2,4-dimethylthioxanthone, isopropylthioxanthone, 2,4-diisopropylthioxanthone, and dodecylthioxanthone.

The usage of the photopolymerization initiator is, for example, preferably 5 parts by weight or less, more preferably 0.01 to 5 parts by weight, still more preferably 0.05 to 3 parts by weight with respect to 100 parts by weight of the polymerizable monomer (m) in the polymerizable composition (α).

Examples of the thermal polymerization initiator include an azo-based polymerization initiator (such as 2,2′-azobisisobutyronitrile, 2,2′-azobis-2-methylbutyronitrile, dimethyl 2,2′-azobis(2-methylpropionate), 4,4′-azobis-4-cyanovaleric acid, azobisisovaleronitrile, 2,2′-azobis(2-amidinopropane) dihydrochloride, 2,2′-azobis[2-(5-methyl-2-imidazolin-2-yl)propane] dihydrochloride, 2,2′-azobis(2-methylpropionamidine) disulfate, or 2,2′-azobis(N,N′-dimethyleneisobutylamidine)dihydrochloride), a peroxide-based polymerization initiator (such as dibenzoyl peroxide or tert-butyl permaleate), and a redox-based polymerization initiator (such as a combination of: an organic peroxide and a vanadium compound; an organic peroxide and dimethylaniline; or a metal naphthenate and butylaldehyde, aniline, or acetylbutyrolactone).

The usage of the thermal polymerization initiator is, for example, preferably 5 parts by weight or less, more preferably 0.01 to 5 parts by weight, still more preferably 0.05 to 3 parts by weight with respect to 100 parts by weight of the polymerizable monomer (m) in the polymerizable composition (α).

The use of a redox-based polymerization initiator as the thermal polymerization initiator enables the polymerization of the composition at normal temperature.

Whether or not a substance is a substance incompatible with a polymer can be judged by means of visual observation, an optical microscope, a scanning electron microscope (SEM), a transmission electron microscope (TEM), X-ray diffraction, or the like on the basis of the size of the substance or an aggregate thereof dispersed in the polymer in a general method (such as: a method involving dissolving the substance in a polymerizable monomer, polymerizing the polymerizable monomer to provide a polymer, and performing the judgment; a method involving dissolving the polymer in a solvent that dissolves the polymer, adding the substance to the solution, stirring the mixture, removing the solvent after the stirring, and performing the judgment; or a method involving heating the polymer, when the polymer is a thermoplastic polymer, to dissolve the polymer, compounding the substance into the dissolved polymer, cooling the mixture, and performing the judgment after the cooling). Criteria for the judgment are as described below. When the substance or the aggregate thereof can be approximated as a spherical shape such as a sphere, a cube, or an amorphous shape, the substance or the aggregate thereof should have a diameter of 5 nm or more. In addition, when the substance or the aggregate thereof can be approximated as a cylindrical shape such as a rod-like shape, a thin-layer shape, or a rectangular parallelepiped shape, the length of its longest side should be 10 nm or more.

Upon dispersion of the substance in the polymer, when the substance or the aggregate thereof in the polymer can be approximated as a spherical shape such as a sphere, a cube, or an amorphous shape, and the substance or the aggregate thereof which is of a spherical shape has a diameter of 5 nm or more, the substance can be regarded as being incompatible with the polymer. In addition, when the substance or the aggregate thereof in the polymer can be approximated as a cylindrical shape such as a rod-like shape, a thin-layer shape, or a rectangular parallelepiped shape, and the length of the longest side of the substance or the aggregate thereof which is of a cylindrical shape is 10 nm or more, the substance can be regarded as being incompatible with the polymer.

A method of dispersing the layered inorganic compound (f) in the polymerizable composition (α) is, for example, a method involving mixing the polymerizable monomer (m), the layered inorganic compound (f), and as required, any other component (such as a polymerization initiator), and uniformly dispersing the contents by means of ultrasonic dispersion or the like.

The content of the layered inorganic compound (f) in the polymerizable composition (α) is preferably 1 to 300 parts by weight, more preferably 3 to 200 parts by weight, still more preferably 5 to 100 parts by weight with respect to 100 parts by weight of the polymerizable monomer (m). When the content of the layered inorganic compound (f) exceeds 300 parts by weight with respect to 100 parts by weight of the polymerizable monomer (m), it may become difficult to produce the flame-retardant polymer member or a problem in that the strength of the flame-retardant polymer member after the production reduces may arise. When the content of the layered inorganic compound (f) is less than 1 part by weight with respect to 100 parts by weight of the polymerizable monomer (m), it may become hard to obtain the unevenly distributed polymerizable composition layer (a1) or the unevenly distributed polymer layer (a2) after the laminate has been obtained in the laminating step (1), or the unevenly distributed polymer layer (a2) may not have any flame retardancy.

Any appropriate content can be adopted as the content of the layered inorganic compound (f) in the polymerizable composition (α) depending on, for example, the kind of the layered inorganic compound (f). For example, when particles are used as the layered inorganic compound (f), the content of the layered inorganic compound (f) is preferably 0.001 to 70 parts by weight, more preferably 0.01 to 60 parts by weight, still more preferably 0.1 to 50 parts by weight with respect to 100 parts by weight of the polymerizable monomer (m). When the content of the layered inorganic compound (f) as particles is less than 0.001 part by weight with respect to the polymerizable monomer (m), it may become difficult to provide the entirety of the surface to be utilized of a surface uneven sheet with an uneven structure in an average manner. When the content of the layered inorganic compound (f) as particles exceeds 70 parts by weight with respect to the polymerizable monomer (m), the particles may drop during the production of the surface uneven sheet or a problem in that the strength of the surface uneven sheet reduces may arise.

The polymerizable composition (α) is preferably provided with a moderate viscosity suitable for an application operation because the composition is typically formed into a sheet shape by, for example, being applied onto a base material. The viscosity of the polymerizable composition (α) can be adjusted by, for example, compounding any one of the various polymers such as an acrylic rubber and a thickening additive, or polymerizing part of the polymerizable monomer (m) in the polymerizable composition (α) through photoirradiation, heating, or the like. It should be noted that a desired viscosity is as described below. A viscosity set with a BH viscometer under the conditions of a rotor of a No. 5 rotor, a rotational frequency of 10 rpm, and a measurement temperature of 30° C. is preferably 5 to 50 Pa·s, more preferably 10 to 40 Pa·s. When the viscosity is less than 5 Pa·s, the liquid may flow when applied onto the base material. When the viscosity exceeds 50 Pa·s, the viscosity is so high that it may become difficult to apply the liquid.

(2-1-1-2. Polymerizable Composition Layer (a))

The polymerizable composition layer (a) is a layer formed of the polymerizable composition (α).

The polymerizable composition layer (a) is obtained by, for example, applying the polymerizable composition (α) onto abase material such as a PET film to form the composition into a sheet shape.

For the application of the polymerizable composition (α), any appropriate coater may be used, for example. Examples of such coater include a comma roll coater, a die roll coater, a gravure roll coater, a reverse roll coater, a kiss roll coater, a dip roll coater, a bar coater, a knife coater, and a spray coater.

The thickness of the polymerizable composition layer (a) is, for example, preferably 3 to 3,000 μm, more preferably 10 to 1,000 μm, still more preferably 20 to 500 μm. When the thickness of the polymerizable composition layer (a) is less than 3 μm, it may be unable to perform uniform application or the unevenly distributed polymer layer (a2) may not have any flame retardancy. On the other hand, when the thickness of the polymerizable composition layer (a) exceeds 3,000 μm, there is a risk that waviness occurs in the flame-retardant polymer member and hence a smooth oil-repellent flame-retardant polymer member is not obtained.

(2-1-1-3. Monomer-Absorbing Layer (b))

The monomer-absorbing layer (b) is a layer capable of absorbing part of the polymerizable monomer (m) from the polymerizable composition layer (a). It is preferred that the monomer-absorbing layer (b) have a high affinity for the polymerizable monomer (m) and be capable of absorbing the polymerizable monomer (m) at a high rate. It should be noted that a surface provided by the monomer-absorbing layer (b) is referred to as “monomer-absorbing surface.”

The absorption of the polymerizable monomer (m) in the monomer-absorbing layer (b) occurs at the time point when a laminate having a structure “polymerizable composition layer (a)/monomer-absorbing layer (b)” is formed by the laminating step (1). The absorption of the polymerizable monomer (m) in the monomer-absorbing layer (b) occurs more effectively when the heating step is performed. It should be noted that the time point when the absorption of the polymerizable monomer (m) in the monomer-absorbing layer (b) occurs is not limited to any stage prior to the polymerizing step (2) and the absorption may occur at the stage of the polymerizing step (2).

The monomer-absorbing layer (b) can be such a sheet-shaped structure that the monomer-absorbing surface of the monomer-absorbing layer (b) can be in contact with the polymerizable composition layer (a) (hereinafter, referred to as “monomer-absorbable sheet”).

Examples of the monomer-absorbable sheet include a monomer-absorbable sheet constituted only of the monomer-absorbing layer (b) (hereinafter, referred to as “base material-less monomer-absorbable sheet”) and a monomer-absorbable sheet obtained by providing the monomer-absorbing layer (b) on a base material (hereinafter, referred to as “monomer-absorbable sheet with a base material”). It should be noted that when the monomer-absorbable sheet is a base material-less monomer-absorbable sheet, each surface of the sheet may be used as a monomer-absorbing surface. In addition, when the monomer-absorbable sheet is a monomer-absorbable sheet with a base material, the surface on the side of the monomer-absorbing layer (b) serves as a monomer-absorbing surface.

The monomer-absorbing layer (b) contains the polymer (p). The content of the polymer (p) in the monomer-absorbing layer (b) is preferably 80 wt % or more, more preferably 90 wt % or more, still more preferably 95 wt % or more, particularly preferably 98 wt % or more, most preferably substantially 100 wt %. The number of kinds of the polymers (p) in the monomer-absorbing layer (b) may be only one, or may be two or more.

The description of the polymerizable monomer in the section <1-1. Polymer layer (B)> can be cited as specific description of a monomer component to be used for obtaining the polymer (p).

At least one of the monomer components to be used for obtaining the polymer (p) is preferably common to at least one of the polymerizable monomers (m) in the polymerizable composition (α).

The polymer (p) is preferably an acrylic resin obtained by polymerizing a monomer component containing an acrylic monomer.

The polymer (p) can be obtained by any appropriate polymerization method as long as the monomer component to be used for obtaining the polymer (p) can be polymerized by the method. The description of a polymerization method in a section (2-1-3. Polymerizing step (2)) to be described later can be cited as specific description of a preferred polymerization method.

The polymer (p) may be a polymer obtained by polymerizing a polymerizable composition having the same composition as that of the polymerizable composition (α) except that the layered inorganic compound (f) is removed from the polymerizable composition (α).

The monomer-absorbing layer (b) may contain any appropriate additive. The description in the section <1-4. Additive> can be cited as specific description of such additive.

The monomer-absorbing layer (b) may contain a flame retardant as in the polymer layer (B).

The monomer-absorbing layer (b1) in the laminate (X) preferably shows a weight 1.1 or more times as large as the weight of the monomer-absorbing layer (b) to be used in the laminating step (1) as a result of the absorption of the polymerizable monomer (m) in the polymerizable composition layer (a) by the monomer-absorbing layer (b). When the weight increase ratio as a result of the absorption of the polymerizable monomer (m) by the monomer-absorbing layer (b) becomes 1.1 or more, the layered inorganic compound (f) can be unevenly distributed in an effective manner. The weight increase ratio is more preferably 2 or more, still more preferably 3 or more, particularly preferably 4 or more. The weight increase ratio is preferably 50 or less in terms of the maintenance of the smoothness of the monomer-absorbing layer (b).

The weight increase ratio can be calculated as described below. After a lapse of the same time period as the time period from the immersion of the monomer-absorbing layer (b) in the polymerizable monomer (m) through the lamination of the polymerizable composition layer (a) on the monomer-absorbing layer (b) to the performance of the polymerizing step (2), and at the same temperature as the temperature at which the foregoing process is performed, the weight of the monomer-absorbing layer (b) is measured and then the ratio is calculated as a ratio of the weight after the absorption of the polymerizable monomer (m) to the weight before the absorption of the polymerizable monomer (m).

The volume of the monomer-absorbing layer (b) after the absorption of the polymerizable monomer (m) may be constant as compared with that before the absorption, or may change as compared with that before the absorption.

Any appropriate value can be adopted as the gel fraction of the monomer-absorbing layer (b). The flame-retardant polymer member of the present invention can be obtained irrespective of whether cross-linking has progressed to attain a gel fraction of about 98 wt % in the monomer-absorbing layer (b) or nearly no cross-linking has occurred in the layer (e.g., the gel fraction is 10 wt % or less).

Sufficient heat resistance and sufficient solvent resistance can be imparted to the polymer layer (B) in the flame-retardant polymer member to be obtained by providing the monomer-absorbing layer (b) with a high level of cross-linking (such as a gel fraction of 90 wt % or more). Sufficient flexibility and sufficient stress-relaxing property can be imparted to the polymer layer (B) in the flame-retardant polymer member to be obtained by providing the monomer-absorbing layer (b) with a low degree of cross-linking (such as a gel fraction of 10 wt % or less).

The gel fraction can be calculated from, for example, a weight change amount when a measuring object is wrapped with a TEMISH (manufactured by, for example, Nitto Denko Corporation) as a mesh made of tetrafluoroethylene, the wrapped product is immersed in ethyl acetate for 1 week, and then the measuring object is dried.

The flame-retardant polymer member of the present invention can be obtained irrespective of whether the monomer-absorbing layer (b) is a hard layer or a soft layer. When a hard layer (such as a layer having a 100% modulus of 100 N/cm² or more) is used as the monomer-absorbing layer (b), the monomer-absorbing layer (b) can be used as a support (base material). When a soft layer (such as a layer having a 100% modulus of 30 N/cm² or less) is used as the monomer-absorbing layer (b), the monomer-absorbing layer (b) can be used as a pressure-sensitive adhesive layer.

Any appropriate thickness can be adopted as the thickness of the monomer-absorbing layer (b) before the absorption of the polymerizable monomer (m). The thickness of the monomer-absorbing layer (b) before the absorption of the polymerizable monomer (m) is, for example, preferably 1 to 3,000 μm, more preferably 2 to 2,000 μm, still more preferably 5 to 1,000 μm. When the thickness of the monomer-absorbing layer (b) before the absorption of the polymerizable monomer (m) is less than 1 μm, the monomer-absorbing layer (b) may deform in the case where the layer has absorbed a large amount of the polymerizable monomer (m), or the absorption of the polymerizable monomer (m) may not be sufficiently performed.

When the thickness of the monomer-absorbing layer (b) before the absorption of the polymerizable monomer (m) exceeds 3,000 μm, there is a risk that the flame-retardant polymer member to be finally obtained is hard to wind in a sheet shape and is hence poor in handleability.

The monomer-absorbing layer (b) may be a single layer, or may be a laminate of two or more layers.

The monomer-absorbing layer (b) can be produced by applying a composition as a material for forming the monomer-absorbing layer (b) (hereinafter, referred to as “monomer-absorbing layer (b)-forming composition”) onto a predetermined surface of any appropriate support such as a release-treated surface of a base material or cover film to be described later with any appropriate coater or the like. The monomer-absorbing layer (b)-forming composition applied onto the support is subjected to drying and/or curing (such as curing with light) as required.

The viscosity of the monomer-absorbing layer (b)-forming composition may be adjusted so as to be suitable for the application by any appropriate method.

Examples of the base material used when the monomer-absorbing layer (b) is a monomer-absorbable sheet with a base material (base material for a monomer-absorbable sheet) include: a paper-based base material such as paper; a fiber-based base material such as cloth, non-woven fabric, or net; a metal-based base material such as a metal foil or a metal plate; a plastic-based base material such as a plastic film or sheet; a rubber-based base material such as a rubber sheet; a foam body such as a foamed sheet; and a laminate thereof (such as a laminate of a plastic-based base material and any other base material or a laminate of plastic films (or sheets)). Such base material is preferably a plastic-based base material such as a plastic film or sheet. Examples of such plastic include: an olefin-based resin containing α-olefin as a monomer component such as a polyethylene (PE), a polypropylene (PP), an ethylene-propylene copolymer, or an ethylene-vinyl acetate copolymer (EVA); a polyester-based resin such as a polyethylene terephthalate (PET), a polyethylene naphthalate (PEN), or a polybutylene terephthalate (PBT); a polyvinyl chloride (PVC); a vinyl acetate-based resin; a polyphenylene sulfide (PPS); an amide-based resin such as a polyamide (nylon) or a wholly aromatic polyamide (aramid); a polyimide-based resin; and a polyether ether ketone (PEEK). The number of kinds of such plastics may be only one, or may be two or more.

When the monomer-absorbing layer (b) is curable with an active energy ray, the base material for a monomer-absorbable sheet is preferably a sheet that does not inhibit the transmission of the active energy ray.

The surface of the base material for a monomer-absorbable sheet is preferably subjected to any appropriate surface treatment for improving its adhesiveness with the monomer-absorbing layer (b). Examples of such surface treatment include: an oxidation treatment by a chemical or physical method such as a corona treatment, a chromic acid treatment, ozone exposure, flame exposure, high-voltage electric shock exposure, or an ionizing radiation treatment; and a coating treatment with an undercoating agent, a releasing agent, or the like.

Any appropriate thickness can be adopted as the thickness of the base material for a monomer-absorbable sheet depending on, for example, its strength, flexibility, and intended use. The thickness of the base material for a monomer-absorbable sheet is, for example, preferably 400 μm or less, more preferably 1 to 350 μm, still more preferably 10 to 300 μm.

The base material for a monomer-absorbable sheet may be a single layer, or may be a laminate of two or more layers.

(2-1-1-4. Laminate (X))

The laminate (X) is obtained by laminating the polymerizable composition layer (a) and the monomer-absorbing layer (b). A method of obtaining the laminate (X) is, for example, a method involving applying the polymerizable composition (α) to the monomer-absorbing surface of the monomer-absorbing layer (b) to form the polymerizable composition layer (a), or a method involving applying the polymerizable composition (α) onto any appropriate support to form the syrupy polymerizable composition layer (a) and then transferring the polymerizable composition layer (a) onto the monomer-absorbing layer (b).

The ratio of the thickness of the polymerizable composition layer (a) to the thickness of the monomer-absorbing layer (b) is preferably 300% or less, more preferably 200% or less, still more preferably 100% or less. When the ratio of the thickness of the polymerizable composition layer (a) to the thickness of the monomer-absorbing layer (b) exceeds 300%, it may become difficult to produce the flame-retardant polymer member or a problem in that the strength of the flame-retardant polymer member after the production reduces may arise. As the ratio of the thickness of the polymerizable composition layer (a) to the thickness of the monomer-absorbing layer (b) reduces, the ease with which the layered inorganic compound (f) is unevenly distributed is improved, and hence the layered inorganic compound (f) can be unevenly distributed in the unevenly distributed polymerizable composition layer (a1) at a higher density. It should be noted that the ratio of the thickness of the polymerizable composition layer (a) to the thickness of the monomer-absorbing layer (b) is preferably set to 1% or more because the layer can be uniformly produced.

(2-1-1-5. Cover film)

Upon production of the laminate (X), a cover film can be used as the support of the polymerizable composition layer (a). The cover film may have peelability. It should be noted that when a photopolymerization reaction is used in the polymerizing step (2), oxygen in the air is preferably blocked with the cover film in the polymerizing step (2) because the reaction is inhibited by oxygen in the air.

As the cover film, any appropriate cover film may be adopted as long as the cover film is a thin sheet which has low oxygen permeation. When a photopolymerization reaction is used, a preferred cover film is a transparent film such as any appropriate release paper. Specific examples of the cover film include a base material having a layer release-treated (peel-treated) with a release treatment agent (a peel treatment agent) on at least one of its surfaces, a low-adhesive base material formed of a fluorine-based polymer (such as a polytetrafluoroethylene, a polychlorotrifluoroethylene, a polyvinyl fluoride, a polyvinylidene fluoride, a copolymer of tetrafluoroethylene and hexafluoropropylene, or a copolymer of chlorofuluoroethylene and vinylidene fluoride), and a low-adhesive base material formed of a non-polar polymer (such as an olefin-based resin such as a polyethylene or a polypropylene). The surface of a release-treated layer of the base material having the release-treated layer on at least one of its surfaces may be used as a release surface. Each of both surfaces of the low-adhesive base material may be used as a release surface.

Examples of the base material that can be used in the base material having a release-treated layer on at least one of its surfaces include: a plastic-based base material film such as a polyester film (such as a polyethylene terephthalate film), an olefin-based resin film (such as a polyethylene film or a polypropylene film), a polyvinyl chloride film, a polyimide film, a polyamide film (nylon film), and a rayon film; papers (such as woodfree paper, Japanese paper, kraft paper, glassine paper, synthetic paper, and top-coated paper); and a multi-layered laminate obtained by lamination or co-extrusion thereof (laminate of two to three layers). As such base material, a plastic-based base material film having high transparency is preferred, and a polyethylene terephthalate film is particularly preferred.

A release treatment agent that can be used in the base material having a release-treated layer on at least one of its surfaces is, for example, a silicone-based release treatment agent, a fluorine-based release treatment agent, or a long-chain alkyl-based release treatment agent. Only one kind of the release treatment agents may be used, or two or more kinds thereof may be used.

Any appropriate thickness can be adopted as the thickness of the cover film. The thickness of the cover film is, for example, preferably 12 to 250 μm, more preferably 20 to 200 μm in terms of handleability and economical efficiency.

The cover film may be a single layer, or may be a laminate of two or more layers.

(2-1-2. Heating Step)

In the production method (1), the laminate (X) obtained by laminating the polymerizable composition layer (a) and the monomer-absorbing layer (b) can be subjected to a heating step before being subjected to the polymerizing step (2). As a result of the heating step, the layered inorganic compound (f) can be unevenly distributed in the unevenly distributed polymerizable composition layer (a1) at an additionally high density, and hence such a flame-retardant polymer member that the distribution of the layered inorganic compound (f) in the unevenly distributed polymer layer (a2) is made additionally dense can be obtained.

The heating temperature is preferably 25° C. or more and 100° C. or less, more preferably 30° C. or more and 90° C. or less, still more preferably 40° C. or more and 80° C. or less, particularly preferably 50° C. or more and 80° C. or less. The time for the heating step is preferably 1 second or more and 120 minutes or less, more preferably 10 seconds or more and 60 minutes or less, still more preferably 1 minute or more and 30 minutes or less. In particular, a flame-retardant polymer member having a higher density can be obtained as the temperature increases in the heating temperature range or as the time for the heating step lengthens in the range of the time for the heating step. When the heating temperature is less than 25° C., the polymerizable monomer (m) may not be sufficiently absorbed by the monomer-absorbing layer (b). When the heating temperature exceeds 100° C., the polymerizable monomer (m) may volatilize or the cover film may deform. When the time for the heating step is less than 1 second, it may become difficult to perform the step. When the time for the heating step exceeds 120 minutes, there is a risk that waviness occurs in the flame-retardant polymer member and hence a smooth flame-retardant polymer member is not obtained.

The polymerizable composition layer (a) and the monomer-absorbing layer (b) may be exposed to the temperature condition before the laminating step (1). The polymerizable composition (α) may also be exposed to the temperature condition.

Any appropriate heating method can be adopted as a method of heating the laminate (X) in the heating step. Examples of the method of heating the laminate (X) in the heating step include a heating method involving using an oven, a heating method involving using an electrothermal heater, and a heating method involving using an electromagnetic wave such as an infrared ray.

As a result of the laminating step (1) and the heating step to be performed as required, in the laminate (X), the layered inorganic compound (f) moves in the polymerizable composition layer (a), and the layered inorganic compound (f) is substantially absent at an interface between the polymerizable composition layer (a) and monomer-absorbing layer (b) immediately after the lamination. Thus, the unevenly distributed polymerizable composition layer (a1) is obtained, in which the layered inorganic compound (f) is unevenly distributed toward the side opposite to the monomer-absorbing layer (b). Meanwhile, the monomer-absorbing layer (b) absorbs the polymerizable monomer (m) and hence the monomer-absorbing layer (b1) is obtained.

(2-1-3. Polymerizing Step (2))

A laminate (Y) of the unevenly distributed polymer layer (a2) and the cured monomer-absorbing layer (b2) is obtained by performing the polymerizing step (2) of polymerizing the polymerizable monomer (m) in the unevenly distributed polymerizable composition layer (a1) and the polymerizable monomer (m) in the monomer-absorbing layer (b1).

The polymerizing step (2) can be performed by, for example, photoirradiation. Any appropriate condition can be adopted as a condition such as a light source, irradiation energy, an irradiation method, or an irradiation time.

An active energy ray to be used in the photoirradiation is, for example, an ionizing radiation such as an α-ray, a β-ray, a γ-ray, a neutron beam, or an electron beam, or UV light. Of those, UV light is preferred.

Irradiation with the active energy ray is performed by using, for example, a black-light lamp, a chemical lamp, a high-pressure mercury lamp, or a metal halide lamp.

Heating may be performed in the polymerizing step (2). Any appropriate heating method can be adopted as a heating method. Examples of the heating method include a heating method involving using an electrothermal heater and a heating method involving using an electromagnetic wave such as an infrared ray.

The thickness of the unevenly distributed portion (a21) of the layered inorganic compound (f) in the unevenly distributed polymer layer (a2) in the laminate (Y) is preferably 80% or less, more preferably 60% or less, still more preferably 50% or less with respect to the thickness of the polymerizable composition layer (a) (before the lamination). When the ratio of the thickness of the unevenly distributed portion (a21) of the layered inorganic compound (f) to the thickness of the polymerizable composition layer (a) (before the lamination) exceeds 80%, adhesiveness between the unevenly distributed polymer layer (a2) and the cured monomer-absorbing layer (b2) may be problematic, or the strength of the unevenly distributed polymer layer (a2) may be problematic.

The thickness of the unevenly distributed portion (a21) of the layered inorganic compound (f) can be controlled by adjusting the amount of the layered inorganic compound (f).

The unevenly distributed portion (a21) of the layered inorganic compound (f) and the non-unevenly distributed portion (a22) of the layered inorganic compound (f) can be clearly distinguished from each other because the unevenly distributed portion (a21) of the layered inorganic compound (f) has a layer shape.

A trace amount of the layered inorganic compound (f) may be dispersed in the non-unevenly distributed portion (a22) depending on a combination of the monomer-absorbing layer (b) and the polymerizable monomer (m). However, the layered inorganic compound (f) dispersed in a trace amount in the non-unevenly distributed portion (a22) does not affect any characteristic of the flame-retardant polymer member.

The unevenly distributed portion (a21) of the layered inorganic compound (f) corresponds to the flame-retardant layer (A).

In the unevenly distributed portion (a21) of the layered inorganic compound (f), the layered inorganic compound (f) and a polymer component of the unevenly distributed polymer layer (a2) are mixed. Accordingly, the unevenly distributed portion (a21) of the layered inorganic compound (f) can exert a characteristic based on the polymer component of the unevenly distributed polymer layer (a2), a characteristic of the layered inorganic compound (f), and a characteristic based on the uneven distribution of the layered inorganic compound (f) in the unevenly distributed polymer layer (a2).

Examples of the characteristic based on the polymer component of the unevenly distributed polymer layer (a2) include flexibility, hard-coat property, pressure-sensitive adhesive property, stress-relaxing property, and impact resistance. The pressure-sensitive adhesive property is, for example, pressure-sensitive adhesive property upon use of a pressure-sensitive adhesive component as the polymer component.

The characteristic of the layered inorganic compound (f) is, for example, a specific function (such as expansivity, shrink property, absorbability, divergence, or conductivity) upon use of the layered inorganic compound (f) having the specific function.

Examples of the characteristic based on the uneven distribution of the layered inorganic compound (f) in the unevenly distributed polymer layer (a2) include: the control of pressure-sensitive adhesive property by the adjustment of the content of the layered inorganic compound upon use of a pressure-sensitive adhesive component as the polymer component; design such as coloring; and the provision of surface unevenness upon use of particles as the layered inorganic compound (f) and a characteristic based on the surface unevenness (such as re-peelability, anti-blocking property, an antiglare characteristic, design, and light-scattering property).

When the polymer component of the unevenly distributed polymer layer (a2) is a pressure-sensitive adhesive component and the layered inorganic compound (f) is particulate, unevenness is formed on the surface of the unevenly distributed polymer layer (a2) by the particulate, layered inorganic compound (f), and hence a flame-retardant polymer member capable of exerting pressure-sensitive adhesive property (tackiness) and peelability (anti-blocking property) on the surface of the unevenly distributed polymer layer (a2) can be obtained. In such flame-retardant polymer member, the pressure-sensitive adhesive property (tackiness) and peelability (anti-blocking property) of the surface of the unevenly distributed polymer layer (a2) can be controlled by adjusting the amount of the particulate, layered inorganic compound (f) to be incorporated.

The particulate, layered inorganic compound (f) in the unevenly distributed portion (a21) may exist in such a manner that the entirety of the particulate, layered inorganic compound (f) is included in the unevenly distributed portion (a21), or may exist in such a manner that part of the particulate, layered inorganic compound (f) is exposed to the outside of the unevenly distributed polymer layer (a2).

(2-1-4. Physically Functional Layer (L) or Chemically Functional Layer (L)-Producing Step (3))

The physically functional layer (L) or the chemically functional layer (L) can be produced by any appropriate method. Preferred examples of the method of producing the physically functional layer (L) or the chemically functional layer (L) include: a method involving forming the physically functional layer (L) or the chemically functional layer (L) described in the section <1-5. Physically functional layer (L)> or <1-6. Chemically functional layer (L)> (which may contain an additive described in the section <1-5. Physically functional layer (L)> or <1-6. Chemically functional layer (L)>) on the flame-retardant layer (A); and a method involving transferring the physically functional layer (L) or the chemically functional layer (L) (which may contain an additive described in the section <1-5. Physically functional layer (L)> or <1-6. Chemically functional layer (L)>) formed on any appropriate base material onto the flame-retardant layer (A). In addition, the physically functional layer (L) or the chemically functional layer (L) may be formed by using any appropriate paint.

The physically functional layer (L) or chemically functional layer (L)-producing step (3) can be performed at any appropriate timing in the production method (1).

(2-1-4-1. Conductive Layer-Producing Step (3))

The Conductive layer can be produced by any appropriate method.

When the conductive layer (L) is an applied layer, the conductive layer (L) can be formed by applying any appropriate conductive liquid. Specifically, for example, the conductive layer (L) is formed by applying a conductive liquid to the surface of a layer to serve as the flame-retardant layer (A). After its application, the conductive liquid is dried as required. A commercially available conductive liquid may be used as the conductive liquid, or the liquid can be prepared by mixing any appropriate conductive substance and, as required, any other additive with any appropriate solvent. The solvent is preferably, for example, an organic solvent or water. Only one kind of solvent may be used as the solvent, or a mixed solvent of two or more kinds of solvents may be used as the solvent. When the conductive substance and, as required, the other additive are mixed with the solvent, the conductive substance may be mixed in a powder state, or may be mixed in a slurry state or a sol state.

Any appropriate means can be adopted as means for applying the conductive liquid. Examples of such means include gravure coating, spray coating, and dip coating.

After the application of the conductive liquid, the applied product can be dried as required. A heating temperature for the drying is preferably 50 to 200° C. A heating time for the drying is preferably 10 seconds to 60 minutes.

After the performance of the drying, aging may be performed for a necessary time period. The aging can improve the peel strength of the coating film with which the flame-retardant layer (A) is coated.

When the conductive layer (L) is a sheet layer, the sheet layer can be formed by any appropriate forming method. Specifically, for example, a sheet-shaped product is formed by any appropriate forming method and the sheet-shaped product is attached to the surface of a layer to serve as the flame-retardant layer (A).

(2-1-4-2. Anti-Fingerprint Layer-Producing Step (3))

The anti-fingerprint layer can be produced by any appropriate method. The anti-fingerprint layer can be preferably produced by: applying a resin composition (such as a resin composition containing at least one kind of resin selected from a fluorine-based resin, a silicone-based resin and a urethane-based resin) as a formation material; and drying the composition as required. Any appropriate solvent may be added as required upon application of the resin composition as a formation material.

Any appropriate means can be adopted as means for applying the resin composition. Examples of such means include gravure coating, spray coating, and dip coating.

When the resin composition is dried after its application, a heating temperature for the drying is preferably 30 to 180° C., more preferably 50 to 150° C. A heating time for the drying is preferably 10 seconds to 10 minutes.

After the application of the resin composition, the anti-fingerprint layer may be cured by, for example, UV irradiation or heating as required. For example, when a resin composition containing a UV-curable resin is used, the layer is preferably cured by UV irradiation, and when a resin composition containing a thermosetting resin is used, the layer is preferably cured by heating.

After its production, the anti-fingerprint layer may be aged for a necessary time period. The aging can improve the peel strength of the coating film with which the flame-retardant layer (A) is coated.

(2-1-4-3. Hard Coat Layer-Producing Step (3))

The hard coat layer can be produced by any appropriate method. The hard coat layer can be preferably produced by: applying a resin composition (such as a resin composition containing a UV-curable resin, a resin composition containing a thermosetting resin, and a resin composition containing an organic-inorganic hybrid resin) as a formation material; and drying the composition as required. Any appropriate solvent may be added as required upon application of the resin composition as a formation material.

Any appropriate means can be adopted as means for applying the resin composition. Examples of such means include gravure coating, spray coating, and dip coating.

When the resin composition is dried after its application, a heating temperature for the drying is preferably 30 to 180° C., more preferably 50 to 150° C. A heating time for the drying is preferably 10 seconds to 10 minutes.

After the application of the resin composition, the hard coat layer may be cured by, for example, UV irradiation or heating as required. For example, when a resin composition containing a UV-curable resin is used, the layer is preferably cured by UV irradiation, and when a resin composition containing a thermosetting resin is used, the layer is preferably cured by heating.

After its production, the hard coat layer may be aged for a necessary time period. The aging can improve the peel strength of the coating film with which the flame-retardant layer (A) is coated.

(2-1-4-4. Ink-Absorbing Layer-Producing Step (3))

The ink-absorbing layer (L) can be produced by any appropriate method. The ink-absorbing layer (L) can be preferably produced by applying the water-soluble resin described in the section <1-5. Physically functional layer (L)> and drying the resin as required. Any appropriate solvent may be added as required upon application of the water-soluble resin. Examples of the method involving applying the water-soluble resin to form the ink-absorbing layer (L) on the flame-retardant layer (A) include: a method involving directly applying the water-soluble resin onto the flame-retardant layer (A) to form the ink-absorbing layer (L); and a method involving transferring the ink-absorbing layer (L), which has been formed by applying the water-soluble resin onto any appropriate base material, onto the flame-retardant layer (A).

Any appropriate means can be adopted as means for applying the water-soluble resin. Examples of such means include gravure coating, spray coating, and dip coating.

When the water-soluble resin is dried after its application, a heating temperature for the drying is preferably 30 to 180° C., more preferably 50 to 150° C. A heating time for the drying is preferably 10 seconds to 10 minutes.

(2-1-4-5. Inorganic Particle-Containing Layer-Producing Step (3))

The inorganic particle-containing layer (L) can be produced by any appropriate method. The inorganic particle-containing layer (L) can be preferably produced from an inorganic particle-containing layer formation material obtained by compounding, in a polymer, inorganic particles and, as required, any appropriate additive. More specifically, the method of producing the inorganic particle-containing layer (L) is, for example, a method involving applying the inorganic particle-containing layer formation material onto the flame-retardant layer (A) to form the layer, or a method involving independently producing the inorganic particle-containing layer from the inorganic particle-containing layer formation material and then attaching the layer onto the flame-retardant layer (A).

Any appropriate form can be adopted as the form of each of the inorganic particles to be compounded for obtaining the inorganic particle-containing layer formation material. Examples of such form of each of the inorganic particles include a colloidal particle, a particle treated with a dispersant, a particle subjected to a coupling treatment, and an encapsulated particle.

The content of the inorganic particles in the inorganic particle-containing layer formation material with respect to the polymer in the inorganic particle-containing layer formation material is preferably 20 to 90 wt %, more preferably 25 to 80 wt %, still more preferably 30 to 70 wt %, particularly preferably 35 to 60 wt %. When the content of the inorganic particles in the inorganic particle-containing layer formation material with respect to the polymer in the inorganic particle-containing layer formation material is less than 20 wt %, it may become difficult to express extremely high flame retardancy. When the content of the inorganic particles in the inorganic particle-containing layer formation material with respect to the polymer in the inorganic particle-containing layer formation material exceeds 90 wt %, the inorganic particle-containing layer (L) may become brittle.

Examples of the additive include a photopolymerization initiator, a silane coupling agent, a release agent, a curing agent, a curing accelerator, a diluent, an age resister, a modifying agent, a surfactant, a dye, a pigment, a discoloration preventing agent, a UV absorbing agent, a softening agent, a stabilizer, a plasticizer, and an antifoaming agent. The kinds, number, and amounts of additives can be appropriately set depending on purposes.

Any appropriate means can be adopted as means for applying the inorganic particle-containing layer formation material. Examples of such means include gravure coating, spray coating, and dip coating.

When the inorganic particle-containing layer formation material is dried after its application, a heating temperature for the drying is preferably 30 to 180° C., more preferably 50 to 150° C. A heating time for the drying is preferably 10 seconds to 10 minutes.

After the application of the inorganic particle-containing layer formation material, the inorganic particle-containing layer may be cured by, for example, UV irradiation or heating as required. For example, when an inorganic particle-containing layer formation material containing a UV-curable resin is used, the layer is preferably cured by UV irradiation, and when an inorganic particle-containing layer formation material containing a thermosetting resin is used, the layer is preferably cured by heating.

After its production, the inorganic particle-containing layer (L) may be aged for a necessary time period. The aging can improve the peel strength of the coating film with which the flame-retardant layer (A) is coated.

(2-1-4-6. Antireflection Layer-Producing Step (3))

The antireflection layer (L) can be produced by any appropriate method. Preferred examples of the method of producing the antireflection layer (L) include: a method involving forming the antireflection layer described in the section <1-5. Physically functional layer (L)> on the flame-retardant layer (A); and a method involving transferring the antireflection layer formed on any appropriate base material onto the flame-retardant layer (A). In addition, the antireflection layer (L) may be formed by using any appropriate antireflection paint.

(2-1-4-7. Light Selective Transmission Layer-Producing Step (3))

The light selective transmission layer (L) can be produced by any appropriate method. Examples of the method of producing the light selective transmission layer (L) include: a method involving coating the top of the flame-retardant layer (A) with a material for the light selective transmission layer (L) to form the layer; and a method involving depositing the material for the light selective transmission layer (L) from the vapor (e.g., vacuum deposition) onto the flame-retardant layer to form the layer. In addition, the light selective transmission layer (L) may be formed on the flame-retardant layer (A) by laminating the light selective transmission layer (L) on the flame-retardant layer (A). Further, the light selective transmission layer (L) may be formed on the flame-retardant layer (A) by transferring the light selective transmission layer (L) onto the flame-retardant layer (A) after its formation on any appropriate base material.

(2-1-4-8. Alkali-Resistant Layer-Producing Step (3))

The alkali-resistant layer (L) can be produced by any appropriate method. The alkali-resistant layer (L) can be preferably produced by applying the alkali-resistant resin described in the section <1-6. Chemically functional layer (L)> and drying the resin as required. Any appropriate solvent may be added as required upon application of the alkali-resistant resin. Examples of the method involving applying the alkali-resistant resin to form the alkali-resistant layer (L) on the flame-retardant layer (A) include: a method involving directly applying the alkali-resistant resin onto the flame-retardant layer (A) to form the alkali-resistant layer (L); and a method involving transferring the alkali-resistant layer (L), which has been formed by applying the alkali-resistant resin onto any appropriate base material, onto the flame-retardant layer (A).

Any appropriate means can be adopted as means for applying the alkali-resistant resin. Examples of such means include gravure coating, spray coating, and dip coating.

When the alkali-resistant resin is dried after its application, a heating temperature for the drying is preferably 30 to 180° C., more preferably 50 to 150° C. A heating time for the drying is preferably 10 seconds to 10 minutes.

(2-1-4-9. Acid-Resistant Layer-Producing Step (3))

The acid-resistant layer (L) can be produced by any appropriate method. The acid-resistant layer (L) can be preferably produced by applying the acid-resistant resin described in the section <1-6. Chemically functional layer (L)> and drying the resin as required. Any appropriate solvent may be added as required upon application of the acid-resistant resin. Examples of the method involving applying the acid-resistant resin to form the acid-resistant layer (L) on the flame-retardant layer include: a method involving directly applying the acid-resistant resin onto the flame-retardant layer (A) to form the acid-resistant layer (L); and a method involving transferring the acid-resistant layer (L), which has been formed by applying the acid-resistant resin onto any appropriate base material, onto the flame-retardant layer (A).

Any appropriate means can be adopted as means for applying the acid-resistant resin. Examples of such means include gravure coating, spray coating, and dip coating.

When the acid-resistant resin is dried after its application, a heating temperature for the drying is preferably 30 to 180° C., more preferably 50 to 150° C. A heating time for the drying is preferably 10 seconds to 10 minutes.

(2-1-4-10. Solvent-Resistant Layer-Producing Step (3))

The solvent-resistant layer (L) Can be produced by any appropriate method. The solvent-resistant layer (L) can be preferably produced by applying the solvent-resistant resin described in the section <1-6. Chemically functional layer (L)> and drying the resin as required. Any appropriate solvent may be added as required upon application of the solvent-resistant resin. Examples of the method involving applying the solvent-resistant resin to form the solvent-resistant layer (L) on the flame-retardant layer (A) include: a method involving directly applying the solvent-resistant resin onto the flame-retardant layer (A) to form the solvent-resistant layer (L); and a method involving transferring the solvent-resistant layer (L), which has been formed by applying the solvent-resistant resin onto any appropriate base material, onto the flame-retardant layer (A).

Any appropriate means can be adopted as means for applying the solvent-resistant resin. Examples of such means include gravure coating, spray coating, and dip coating.

When the solvent-resistant resin is dried after its application, a heating temperature for the drying is preferably 30 to 180° C., more preferably 50 to 150° C. A heating time for the drying is preferably 10 seconds to 10 minutes.

<2-2. Flame-Retardant Polymer Member Production Method (2)>

In addition to the production method (1), a production method (2) is preferably adopted as the method of producing the flame-retardant polymer member of the present invention. In the production method (2), the flame-retardant polymer member of the present invention is produced by a production method including the step of laminating a solid layered inorganic compound-containing polymer layer (aₚ), which is obtained by polymerizing a polymerizable composition layer (a) formed of a polymerizable composition (α) containing a polymerizable monomer (m) and the layered inorganic compound (f), and a solid monomer-absorbing layer (b) containing a polymer (p) and capable of absorbing the polymerizable monomer (m) and the step of producing the physically functional layer (L) or the chemically functional layer (L).

The solid layered inorganic compound-containing polymer layer (aₚ) can be obtained by: producing the polymerizable composition layer (a) by the same method as the method described in the production method (1); and then performing the polymerization of the polymerizable composition layer (a) by the same method as that in the polymerizing step (2) described in the production method (1). Although the solid layered inorganic compound-containing polymer layer (aₚ) contains a polymer component formed by the polymerization of the polymerizable monomer (m), the polymerizable monomer (m) that has not been polymerized may remain in the layer.

The solid monomer-absorbing layer (b) can be obtained by the same method as the method described in the production method (1).

The lamination of the solid layered inorganic compound-containing polymer layer (aₚ) and the solid monomer-absorbing layer (b) can be performed by any appropriate lamination method. A method for the lamination of the solid layered inorganic compound-containing polymer layer (aₚ) and the solid monomer-absorbing layer (b) is, for example, a method involving producing the solid layered inorganic compound-containing polymer layer (aₚ) on any appropriate base material, separately preparing the monomer-absorbing layer (b) to be provided as a monomer-absorbable sheet, and laminating the layers.

The step of producing the physically functional layer (L) or the chemically functional layer (L) is, for example, the same step as that described in (2-1-4. Physically functional layer (L) or chemically functional layer (L)-producing step (3)). It should be noted that the physically functional layer (L) or chemically functional layer (L)-producing step (3) can be performed at any appropriate timing in the production method (2).

<2-3. Flame-Retardant Polymer Member Production Method (3) >

In addition to the production methods (1) and (2), a production method (3) is preferably adopted as the method of producing the flame-retardant polymer member of the present invention. In the production method (3), the flame-retardant polymer member of the present invention is produced by a production method including the step of laminating a syrupy polymerizable composition layer (a′) formed of a polymerizable composition (α) containing a polymerizable monomer (m1) and the layered inorganic compound (f), and a syrupy polymerizable composition layer (b′) containing a polymerizable monomer (m2) and a polymer (p2), followed by the performance of polymerization, and the step of producing the physically functional layer (L) or the chemically functional layer (L).

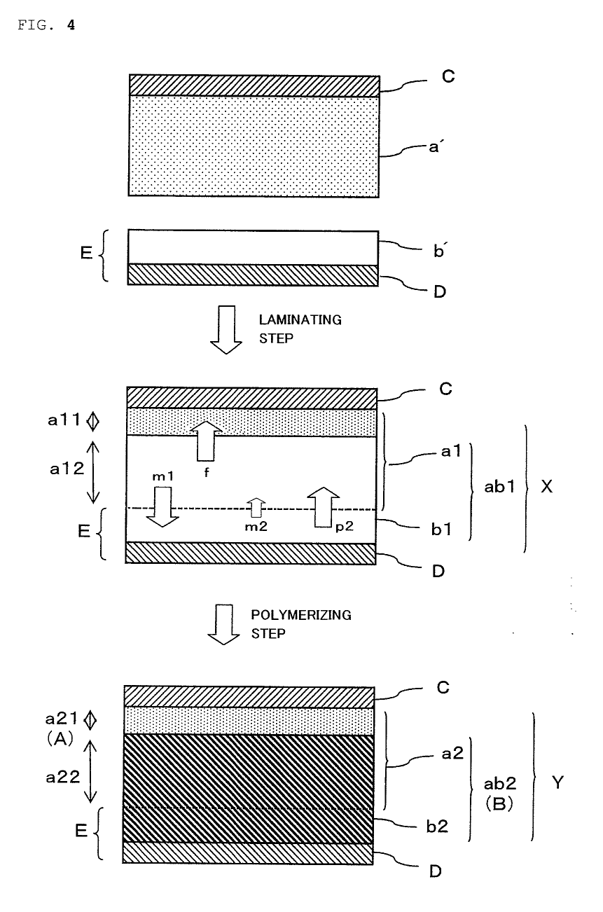

Hereinafter, the “step of laminating the syrupy polymerizable composition layer (a′) formed of the polymerizable composition (α) containing the polymerizable monomer (m1) and the layered inorganic compound (f), and the syrupy polymerizable composition layer (b′) containing the polymerizable monomer (m2) and the polymer (p2), followed by the performance of polymerization” in the flame-retardant polymer member production method (3) is described with reference to FIG. 4.

First, in a laminating step (1), a laminate (X) is obtained by laminating the polymerizable composition layer (a′) and the polymerizable composition layer (b′). The polymerizable composition layer (a′) contains the polymerizable monomer (m1) and the layered inorganic compound (f). The polymerizable composition layer (b′) contains the polymerizable monomer (m2) and the polymer (p2). Although the polymerizable composition layer (a′) can be laminated on at least one surface of the polymerizable composition layer (b′), FIG. 4 illustrates the case where the layer is laminated only on one surface of the polymerizable composition layer (b′).

In FIG. 4, a cover film (C) is provided on the side of the polymerizable composition layer (a′) not laminated on the polymerizable composition layer (b′). In addition, in FIG. 4, the polymerizable composition layer (b′) is provided on a base material film (D).

It is preferred that the polymerizable monomer (m1) in the polymerizable composition layer (a′), and the polymerizable monomer (m2) and the polymer (p2) in the polymerizable composition layer (b′) substantially show compatibility. Thus, in the laminate (X), part of the polymerizable monomer (m1) and part of the polymerizable monomer (m2) can each diffuse in the other layer interactively on the lamination surface of the polymerizable composition layer (a′) and the polymerizable composition layer (b′). Here, when a concentration (c1) of the polymerizable monomer (m1) in the polymerizable composition layer (a′) is higher than a concentration (c2) of the polymerizable monomer (m2) in the polymerizable composition layer (b′), the extent to which the polymerizable monomer (m1) diffuses in the polymerizable composition layer (b′) enlarges, and in accordance therewith, the extent to which the polymer (p2) in the polymerizable composition layer (b′) diffuses in the polymerizable composition layer (a′) enlarges. On the other hand, in the polymerizable composition layer (a′), the unevenly distributed polymerizable composition layer (a1) is obtained, in which the layered inorganic compound (f) is unevenly distributed toward the side opposite to the polymerizable composition layer (b′), and which has, as a result of the distribution, the unevenly distributed portion (a11) and non-unevenly distributed portion (a12) of the layered inorganic compound (f).

The concentration (c1) of the polymerizable monomer (m1) in the polymerizable composition layer (a′) is preferably higher than the concentration (c2) of the polymerizable monomer (m2) in the polymerizable composition layer (b′). A concentration difference between the concentration (c1) and the concentration (c2) is preferably 15 wt % or more, more preferably 20 wt % or more, still more preferably 30 wt % or more. When the concentration difference between the concentration (c1) and the concentration (c2) is set to 15 wt % or more, the layered inorganic compound (f) in the polymerizable composition layer (a′) can be unevenly distributed in an effective manner. It should be noted that when the concentration (c2) is higher than the concentration (c1), there is a risk that the layered inorganic compound (f) in the polymerizable composition layer (a′) cannot be unevenly distributed in a sufficient manner.

The phenomenon of the uneven distribution of the layered inorganic compound (f) in the unevenly distributed polymerizable composition layer (a1) is assumed to be caused by the diffusion of the polymer (p2) from the polymerizable composition layer (b′). The polymerizable monomer (m1) diffuses in the polymerizable composition layer (b′), and in the meantime, the polymer (p2) diffuses in the polymerizable composition layer (a′). Thus, the layered inorganic compound (f) that cannot diffuse toward the polymerizable composition layer (b′) may be unevenly distributed in such a manner as to remain in the polymerizable composition layer (a′). The polymerizable composition layer (b′) absorbs the polymerizable monomer (m1) to turn into the monomer-absorbing layer (b1).

Each component of the polymerizable composition layer (a′) and each component of the polymerizable composition layer (b′) diffuse interactively in the laminate (X). Accordingly, an interface between the non-unevenly distributed portion (a12) of the layered inorganic compound (f) in the unevenly distributed polymerizable composition layer (a1) and the monomer-absorbing layer (b1) cannot be observed (a composite site of these layers is represented as ab1 in FIG. 4). In FIG. 4, the interface is indicated by a broken line for convenience.

Next, the polymerizable monomer (m1) and the polymerizable monomer (m2) in the unevenly distributed polymerizable composition layer (a1) and the monomer-absorbing layer (b1) are polymerized by subjecting the laminate (X) to the polymerizing step (2). Thus, the laminate (Y) in which the unevenly distributed polymer layer (a2), which has been cured while the unevenly distributed structure has been maintained, and the cured monomer-absorbing layer (b2) are laminated is obtained. The unevenly distributed polymer layer (a2) has the unevenly distributed portion (a21) of the layered inorganic compound (f) and the non-unevenly distributed portion (a22) of the layered inorganic compound (f). It should be noted that the monomer-absorbing layer (b1) is turned into the monomer-absorbing layer (b2), in which the polymerizable monomer (m1) and the polymerizable monomer (m2) have been cured, by the polymerizing step (2) because the polymerizable monomer (m1) and the polymerizable monomer (m2) are absorbed by the monomer-absorbing layer (b1). Although an interface between the non-unevenly distributed portion (a22) of the layered inorganic compound (f) in the unevenly distributed polymer layer (a2) and the cured monomer-absorbing layer (b2) cannot be observed in the laminate (Y) (a composite site of these layers is represented as ab2 in FIG. 4), the interface is indicated by a broken line in FIG. 4 for convenience.

Details about the laminating step (1) and details about the polymerizing step (2) are identical to those described in the production method (1). In addition, the heating step described in the production method (1) may be included.

The step of producing the physically functional layer (L) or the chemically functional layer (L) is, for example, the same step as the physically functional layer (L) or chemically functional layer (L)-producing step (3) described in the production method (1). It should be noted that the physically functional layer (L) or chemically functional layer (L)-producing step (3) can be performed at any appropriate timing in the production method (3).

### <<3. Shape of Flame-Retardant Polymer Member>>

Any appropriate shape can be adopted as the shape of the flame-retardant polymer member of the present invention. Examples of the shape of the flame-retardant polymer member of the present invention include a sheet shape and a tape shape. When the shape of the flame-retardant polymer member of the present invention is a sheet shape, the member can be used as a flame-retardant sheet. The flame-retardant polymer member of the present invention may have such a shape that the member of a sheet shape or a tape shape is wound in a roll shape. Alternatively, the flame-retardant polymer member of the present invention may have such a shape that members of sheet shapes or tape shapes are laminated.

When the outermost layer of the flame-retardant polymer member of the present invention is a pressure-sensitive adhesive layer, the flame-retardant polymer member of the present invention can be used as a pressure-sensitive adhesive tape or a pressure-sensitive adhesive sheet. It should be noted that the “tape” and the “sheet” may be collectively referred to as “tape” or “sheet” in a simple manner.

The flame-retardant polymer member of the present invention can also be used as a pressure-sensitive adhesive tape or a pressure-sensitive adhesive sheet by further providing the flame-retardant polymer member of the present invention with a pressure-sensitive adhesive layer formed of any appropriate pressure-sensitive adhesive (such as an acrylic pressure-sensitive adhesive, a rubber-based pressure-sensitive adhesive, a vinyl alkyl ether-based pressure-sensitive adhesive, a silicone-based pressure-sensitive adhesive, a polyester-based pressure-sensitive adhesive, a polyamide-based pressure-sensitive adhesive, a urethane-based pressure-sensitive adhesive, a fluorine-based pressure-sensitive adhesive, or an epoxy-based pressure-sensitive adhesive).

The flame-retardant polymer member of the present invention may have any other layer (such as an intermediate layer or an undercoat layer) to such an extent that the effect of the present invention is not impaired.

In the flame-retardant polymer member of the present invention, the surface of the physically functional layer (L) or the chemically functional layer (L) may be protected with a cover film. The cover film can be peeled upon use of the flame-retardant polymer member of the present invention.

<<4. Flame-Retardant Article>>

A flame-retardant article is obtained by attaching the flame-retardant polymer member of the present invention to an adherend. For example, paper, lumber, a plastic material, a metal, a plaster board, glass, or a composite containing two or more thereof can be used as the adherend. The flame-retardant polymer member of the present invention is attached to at least part of the adherend. It should be noted that the adherend may be a printed matter provided with a pattern layer or the like, or may be an adherend having design.

Examples of the paper as the adherend include woodfree paper, Japanese paper, kraft paper, glassine paper, synthetic paper, and top-coated paper.

Examples of the lumber as the adherend include: broadleaf trees such as oak, paulownia wood, keyaki, teak, and rosewood; coniferous trees such as Japanese cedar, Japanese cypress, pine, and hiba false arborvitae; assembles; and plywood.

Examples of the plastic material as the adherend include an acrylic resin, a polyester (such as a polyethylene terephthalate), an olefin-based resin (such as a polyethylene, a polypropylene, or a polystyrene), a vinyl chloride resin, an epoxy resin, a vinyl ether-based resin, and a urethane-based resin.

Upon lamination of the flame-retardant polymer member of the present invention and the adherend, the member and the adherend may be attached to each other by applying any appropriate pressure-sensitive adhesive by any appropriate application method. When the outermost layer of the flame-retardant polymer member is a pressure-sensitive adhesive layer, the member may be attached to the adherend without being treated. A method of attaching the flame-retardant polymer member and the adherend is, for example, a method involving attaching the member and the adherend with a laminator. The flame-retardant-treated adherend thus obtained can be attached to a wall surface or glass surface of a railway vehicle or the like, or to a wall surface, decorative laminate, glass surface, or the like of a housing or the like through an attachment layer, the attachment layer being provided on the surface opposite to the surface on which the flame-retardant polymer member of the present invention is laminated.

The flame-retardant polymer member of the present invention can be suitably used as a building material in, for example, a wall material, ceiling material, roofing material, flooring material, partitioning material, or curtain of a housing, edifice, or public facility, in particular, a wall material or ceiling material of a kitchen, or a partition of a clean room. In addition, the member can be used in, for example, a surface trim material for fire preventive equipment such as an exhaust duct, a fire door, or a fire shutter, a surface trim material for furniture such as a table, a surface trim material for a door, a surface trim material for window glass, a surface trim material for a signboard or digital signage, or a roll screen. In addition, the member can be used in a wall material, ceiling material, roofing material, or flooring material inside or outside a ship, aircraft, automobile, or railway vehicle, a surface protective material or inkjet media material for a printed matter to be attached to a glass portion inside or outside a railway vehicle, a solar cell member, a cell protective material, or an electrical and electric equipment member such as a partition inside an electrical apparatus. Further, the member can be used as a peripheral tool for an ash tray, a surface trim material for a garbage box, or a protective material for the front panel of a pachinko machine.

### EXAMPLES

Hereinafter, the present invention is described in more detail byway of examples, but the present invention is not limited to these examples.

It should be noted that a biaxially stretched polyethylene terephthalate film having a thickness of 38 μm (trade name: “MRN38,” manufactured by Mitsubishi Chemical Polyester Film) one surface of which had been subjected to a silicone-based release treatment was used as each of cover films and base material films used in the following respective examples.

### <Flame Retardancy>

A polymer sheet was evaluated for the following flame retardancy.

An evaluation for flame retardancy was performed by the horizontal firing test illustrated in FIG. 2. FIG. 2 illustrates a measurement method. Each polymer sheet was cut into a piece measuring 5 cm by 12 cm and then the piece was subjected to the evaluation. It should be noted that the cover films on both surfaces of each polymer sheet were peeled.

In each of the physically functional flame-retardant polymer sheets and chemically functional flame-retardant polymer sheets obtained in Examples, the side of the physically functional layer or chemically functional layer was defined as a lower surface, and in each of flame-retardant polymer sheets (C1) and (C2) obtained in Comparative Examples, the side of the flame-retardant layer was defined as a lower surface.

A Bunsen burner was placed so that the flame port of the Bunsen burner was positioned at a lower portion distant from the central portion of the lower surface of a polymer sheet by 45 mm, and then the flame of the Bunsen burner having a height of 55 mm from the flame port was brought into contact for 30 seconds. A propane gas was used as the gas of the Bunsen burner and the test was performed in the air.

### <<Flame Retardancy: *1>>

A polymer sheet was evaluated for its flame retardancy on the basis of the following criteria by subjecting the polymer sheet to the horizontal firing test and observing the presence or absence of the combustion of the polymer sheet.

o: The polymer sheet does not ignite even after 30 seconds from the flame contact, and maintains its shape.
Δ: The polymer sheet ignites within 30 seconds from the flame contact, but maintains its shape.
x: The polymer sheet ignites within 30 seconds from the flame contact, and does not maintain its shape.

### <<Flame-Blocking Property: *2>>

A polymer sheet was evaluated for its flame-blocking property by: placing a White Economy 314-048 (manufactured by Biznet) as copy paper at a position 3 mm above the polymer sheet; and observing the presence or absence of the combustion of the copy paper through the same horizontal firing test as that described above.

o: The copy paper 3 mm above the polymer sheet does not ignite even after 30 seconds from the flame contact.
Δ: The copy paper 3 mm above the polymer sheet ignites within 30 seconds from the flame contact, but does not ignite within 10 seconds therefrom.
x: The copy paper 3 mm above the polymer sheet ignites within 10 seconds from the flame contact.

<Conductivity: *3>

A measurement site was exposed, and the surface resistivity ρₛ (Ω/□) of the measurement site was measured with a Loresta resistivity meter or a Hiresta resistivity meter (manufactured by Mitsubishi Chemical Corporation). The common logarithm of the measured surface resistivity ρₛ (log (ρₛ)) was used as an indicator for conductivity.

<Anti-Fingerprint Property: *3>

A fingerprint was caused to adhere onto a polymer sheet. Black paper was spread below the sheet, and then the fingerprint was visually observed from a vertical direction and evaluated in accordance with the following criteria.

o: The fingerprint is not observed.
Δ: The fingerprint is slightly observed.
x: The fingerprint is whitely and clearly observed.

### <Scratch Resistance: *3>

A polymer sheet was cut into a piece measuring 25 mm wide by 100 mm or more long, and then the piece was attached as a sample to a glass plate. Next, a Steel Wool #0000 was uniformly attached to a smooth section of a column having a diameter of 25 mm and then the resultant was pressed against the surface of the sample under the condition of a load of 400 g. It should be noted that the column to which the steel wool had been attached was reciprocated at a speed of 100 mm/sec 10 times. After that, whether or not the surface of the sample was free of a flaw, having a width of 10 μm or more was visually observed and evaluated in accordance with the following criteria.

A: No flaw is present.
B: A fine flaw is present.
C: A large flaw is present.

<Printing Property: *3>

Printing was performed on the surface on the flame-retardant layer (A) side of a polymer sheet with an inkjet printer PM-900 manufactured by SEIKO EPSON CORPORATION. The quality of the printing was compared to that in the case of printing on an OHP film for a color inkjet printer (manufactured by Sharp Corporation) through visual observation, and evaluated.

o: The quality of the printing is at a comparable level.
Δ: The image has a dot of ink mixed therein and is blurred.
x: Owing to a lack of ability to absorb ink, ink runs off or a dot of ink is badly mixed.

<High Flame Retardancy: *3>

A polymer sheet was evaluated for its flame retardancy on the basis of the following criteria by subjecting the polymer sheet to the horizontal firing test using a flame of the Bunsen burner having a height of 75 mm from the flame port instead of the flame of the Bunsen burner having a height of 55 mm from the flame port, and observing the presence or absence of the combustion of the polymer sheet.

o: The polymer sheet does not ignite even after 30 seconds from the flame contact, and maintains its shape.
Δ: The polymer sheet ignites within 30 seconds from the flame contact, but maintains its shape.
x: The polymer sheet ignites within 30 seconds from the flame contact, and does not maintain its shape.

<Flame Retardancy of Flame-Retardant-Treated Product: *3>

A flame-retardant-treated product was evaluated for its flame retardancy as described below. A sample was obtained by attaching a White Economy 314-048 (manufactured by Biznet) as copy paper to the upper surface of a polymer sheet, and then the presence or absence of the combustion of the sample as an article subjected to a flame-retardant treatment was observed through the same horizontal firing test as that described above.

o: The flame-retardant-treated product does not ignite even after 30 seconds from the flame contact.
Δ: The flame-retardant-treated product ignites within 30 seconds from the flame contact, but does not ignite within 10 seconds from the flame contact.
x: The flame-retardant-treated product ignites within 10 seconds from the flame contact.

<Antireflection Property: *3>

The polymer layer side of a polymer sheet was attached to a black image, and a degree of unnecessary reflection was evaluated through visual observation in a room with a fluorescent lamp on.

A: The unnecessary reflection of the fluorescent lamp is ignorable.
B: The unnecessary reflection of the fluorescent lamp is slightly observed, but is ignorable for the most part.
C: The unnecessary reflection of the fluorescent lamp is observed, but is at an acceptable level.
D: The unnecessary reflection of the fluorescent lamp is noticeably observed, and the unnecessary reflection cannot be ignored.

<Light Selective Transmission Property: *3>

Transmittances at wavelengths of 400 to 600 nm and 750 to 1,000 nm were measured with a spectrophotometer (Shimadzu UV-3100, manufactured by SHIMADZU CORPORATION).

<Alkali Resistance: *3>

Qualitative filter paper (product name: “No. 2,” size: “φ55 mm,” manufactured by ADVANTEC) sufficiently impregnated with a 10-wt % aqueous solution of sodium hydroxide was placed on the flame-retardant layer (A) side of a polymer sheet for 30 minutes, and then the state of the polymer sheet after the removal of the qualitative filter paper was observed.

o: No change is observed.
x: The surface has a wrinkle or a blister.

<Acid Resistance: *3>

Qualitative filter paper (product name: “No. 2,” size: “φ55 mm,” manufactured by ADVANTEC) sufficiently impregnated with a 10-vol % aqueous solution of sulfuric acid was placed on the flame-retardant layer (A) side of a polymer sheet for 30 minutes, and then the state of the polymer sheet after the removal of the qualitative filter paper was observed.

o: No change is observed.
x: The surface has a wrinkle or a blister.

<Solvent Resistance: *3>

Qualitative filter paper (product name: “No. 2,” size: “φ55 mm,” manufactured by ADVANTEC) sufficiently impregnated with xylene was placed on the flame-retardant layer (A) side of a polymer sheet for 30 minutes, and then the state of the polymer sheet after the removal of the qualitative filter paper was observed.

o: No change is observed.
x: The surface has a wrinkle or a blister.

### Synthesis Example 1

### Preparation of Syrup (b-1)

50 Parts by weight of isobornyl acrylate, 50 parts by weight of lauryl acrylate, 0.1 part by weight of a photopolymerization initiator (trade name: “IRGACURE 651,” manufactured by Ciba Specialty Chemicals Inc.), and 0.1 part by weight of a photopolymerization initiator (trade name: “IRGACURE 184,” manufactured by Ciba Specialty Chemicals Inc.) were stirred in a four-necked separable flask provided with a stirring machine, a temperature gauge, a nitrogen gas-introducing tube, and a cooling tube until the mixture became uniform. After that, bubbling was performed with a nitrogen gas for 1 hour to remove dissolved oxygen. After that, UV light was applied from the outside of the flask by using a black-light lamp to perform polymerization. At the time point when a moderate viscosity was obtained, the lamp was turned off and the blowing of nitrogen was stopped. Thus, a syrupy composition having a rate of polymerization of 7% part of which had been polymerized was prepared (hereinafter, the composition is referred to as “syrup (b-1)”).

### Synthesis Example 2

### Preparation of Syrup (a-1) Containing Layered Inorganic Compound

30 Parts by weight of a layered clay mineral (trade name: “LUCENTITE SPN,” manufactured by Co-op Chemical Co., Ltd., shape: flat plate-like shape) were added to a monomer mixture formed of 100 parts by weight of cyclohexyl acrylate, 0.2 part by weight of 1,6-hexanediol diacrylate, 0.2 part by weight of a photopolymerization initiator (trade name: “IRGACURE 651,” manufactured by Ciba Specialty Chemicals Inc.), and 0.2 part by weight of a photopolymerization initiator (trade name: “IRGACURE 184,” manufactured by Ciba Specialty Chemicals Inc.), and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-1) containing a layered inorganic compound was prepared. It should be noted that the monomer mixture to which the layered clay mineral had been added became transparent as a result of the ultrasonic treatment.

### Synthesis Example 3

### Production of Monomer-Absorbable Sheet (B-1) with Base Material

A syrup composition prepared by uniformly mixing 100 parts by weight of the syrup (b-1) prepared in Synthesis Example 1 with 0.5 part by weight of a photopolymerization initiator (trade name: “IRGACURE 651,” manufactured by Ciba Specialty Chemicals Inc.) was applied to the peel-treated surface of the base material film so as to have a thickness of 100 μm after its curing. Thus, a syrup composition layer was formed. Then, the cover film was attached onto the layer in such a manner that its release-treated surface was in contact with the layer, and then both surfaces of the resultant were simultaneously irradiated with UV light (illuminance: 5 mW/cm²) by using a black-light lamp for 5 minutes. As a result, the layer was cured to form a monomer-absorbing layer. Thus, a monomer-absorbable sheet (B-1) with a base material in which the surface of the monomer-absorbing layer was protected with the cover film was produced.

### Synthesis Example 4

### Production of Flame-Retardant Polymer Sheet (P-1)

A polymerizable composition layer (thickness: 100 μm) was formed by applying the syrup (a-1) to the release-treated surface of the cover film. The resultant was attached to the monomer-absorbable sheet (B-1) with a base material, the monomer-absorbing layer of which had been exposed by peeling the cover film, in such a manner that the monomer-absorbing layer and the polymerizable composition layer were in contact with each other. Thus, a laminate was formed.

Next, the laminate was left to stand at room temperature for 15 minutes. Thus, an unevenly distributed polymerizable composition layer was obtained. After that, both of its surfaces were irradiated with UV light (illuminance: 5 mW/cm²) by using a black-light lamp as a light source for 5 minutes. As a result, the unevenly distributed polymerizable composition layer was photo-cured to form an unevenly distributed polymer layer. Thus, a flame-retardant polymer sheet (P-1) was produced.

### Synthesis Example 5

### Preparation of Syrup (a-2) Containing Layered Inorganic Compound

30 Parts by weight of a layered clay mineral (trade name: “LUCENTITE SPN,” manufactured by Co-op Chemical Co., Ltd., shape: flat plate-like shape) were added to a monomer mixture formed of 100 parts by weight of 1,6-hexanediol diacrylate and 0.5 part by weight of a photopolymerization initiator (trade name: “IRGACURE 819,” manufactured by Ciba Specialty Chemicals Inc.), and then the whole was left at rest at room temperature (25° C.) for 24 hours. Thus, the monomer mixture (opaque) to which the layered clay mineral had been added was obtained. After that, the monomer mixture to which the layered clay mineral had been added was irradiated with an ultrasonic wave from an ultrasonic disperser (manufactured by NIPPON SEIKI CO., LTD.) at an irradiation intensity of 500 mW for 3 minutes. Thus, a syrup (a-2) containing a layered inorganic compound was prepared.

### Synthesis Example 6

### Preparation of Acrylic Oligomer (A)

70 Parts by weight of isobornyl acrylate, 30 parts by weight of lauryl acrylate, and 3.8 parts by weight of thioglycolic acid were stirred in a four-necked separable flask provided with a stirring machine, a temperature gauge, a nitrogen gas-introducing tube, and a cooling tube until the mixture became uniform. After that, bubbling was performed with a nitrogen gas for 1 hour to remove dissolved oxygen. After that, the temperature was increased to 70° C., and the mixture was stirred at 70° C. for 30 minutes. Then, 0.05 part by weight of a thermal polymerization initiator (trade name: “PERHEXYL O,” manufactured by NOF CORPORATION) and 0.02 part by weight of a thermal polymerization initiator (trade name: “PERHEXYL D,” manufactured by NOF CORPORATION) were added. The temperature was further increased to 100° C., the mixture was stirred at 100° C. for 60 minutes, and then the temperature was increased to 140° C. After that, the mixture was stirred at 140° C. for 60 minutes, the temperature was then increased to 180° C., and the mixture was stirred at 180° C. for 60 minutes. Thus, an acrylic oligomer (A) was prepared. It should be noted that the weight-average molecular weight of the resultant acrylic oligomer (A) was 5,000.

### Synthesis Example 7

### Preparation of Syrup (b-2)

20 Parts by weight of cyclohexyl acrylate, 80 parts by weight of the acrylic oligomer (A) prepared in Synthesis Example 6, and 0.5 part by weight of a photopolymerization initiator (trade name: “IRGACURE 819,” manufactured by Ciba Specialty Chemicals Inc.) were stirred in a flask provided with a stirring machine until the mixture became uniform. Thus, a syrupy composition was prepared (hereinafter, the composition is referred to as “syrup (b-2)”).

### Synthesis Example 8

### Production of Flame-Retardant Polymer Sheet (P-2)

The syrup (a-2) was applied onto a supporting base material so that its thickness after curing was 50 μm. Thus, the polymerizable composition layer (a′) was formed. The syrup (b-2) was applied onto another supporting base material so that its thickness after curing was 50 μm. Thus, the polymerizable composition layer (b′) was formed. The polymerizable composition layer (a′) and the polymerizable composition layer (b′) were attached to each other in such a manner that no air bubble was included while the layers were brought into contact with each other, and 5 minutes after the attachment, the resultant was irradiated with UV light (illuminance: 9 mW/cm², light quantity: 1,200 mJ/cm²) by using a black-light lamp and a metal halide lamp to cure the polymerizable composition layer (a′) and the polymerizable composition layer (b′). Thus, a flame-retardant polymer sheet (P-2) having the supporting base materials on both sides thereof was produced.

### Synthesis Example 9

### Production of Inorganic Particle-Containing Layer Formation Material

90 Parts by weight of water, raw material monomers including 95 parts by weight of butyl acrylate and 5 parts by weight of acrylic acid, and 3 parts by weight of an HS-10 (manufactured by DAI-ICHI KOGYO SEIYAKU CO., LTD.) as an emulsifier were compounded with each other and then mixed by stirring with a homomixer. Thus, a monomer emulsion was prepared.

Next, 50 parts by weight of water, 0.01 part by weight of a polymerization initiator (ammonium persulfate), and an amount corresponding to 10 wt % out of the monomer emulsion prepared in the foregoing were added to a reaction vessel provided with a cooling tube, a nitrogen-introducing tube, a temperature gauge, and a stirring machine. While being stirred, the mixture was subjected to emulsion polymerization at 75° C. for 1 hour. After that, 0.05 part by weight of an additional polymerization initiator (ammonium persulfate) was added. Next, while the mixture was stirred, the entirety of the remaining monomer emulsion (an amount corresponding to 90 wt %) was added over 3 hours, and then the whole was subjected to a reaction at 75° C. for 3 hours. Next, the resultant was cooled to 30° C., and ammonia water having a concentration of 10 wt % was added to adjust the pH to 8. Thus, an aqueous dispersion of an acrylic emulsion-based polymer (41 wt %) was prepared.

Colloidal silica (manufactured by ADEKA CORPORATION, ADELITE AT-50, average particle diameter: 20 to 30 nm) was compounded in the resultant acrylic emulsion resin at a solid ratio (by weight) of 40:60. Thus, an inorganic particle-containing layer formation material was produced.

### Example 1-1

### Production of Conductive Flame-Retardant Polymer Sheet (1)

A conductive liquid was prepared by uniformly mixing 50 parts by weight of a polypyrrole aqueous dispersion (manufactured by MARUBISHI OIL CHEMICAL CO., LTD., PPY-12), 40 parts by weight of a polyglycerin having an average degree of polymerization of 10, and 10 parts by weight of an acetylene glycol-based surfactant (manufactured by Air Products and Chemicals, Inc., Surfynol).

The resultant conductive liquid was applied onto the flame-retardant layer of the flame-retardant polymer sheet (P-1) obtained in Synthesis Example 4, and then dried at 120° C. for 1 minute. Thus, a conductive flame-retardant polymer sheet (1) was produced.

In the resultant conductive flame-retardant polymer sheet (1), the thickness of the polymer layer (B) was 175 μm, the thickness of the flame-retardant layer (A) was 25 μm, and the thickness of the conductive layer (L) was 5 μm.

### Example 1-2

### Production of Conductive Flame-Retardant Polymer Sheet (2)

A conductive liquid was prepared by uniformly mixing 50 parts by weight of a polypyrrole aqueous dispersion (manufactured by MARUBISHI OIL CHEMICAL CO., LTD., PPY-12), 40 parts by weight of a polyglycerin having an average degree of polymerization of 10, and 10 parts by weight of an acetylene glycol-based surfactant (manufactured by Air Products and Chemicals, Inc., Surfynol).

The resultant conductive liquid was applied onto the flame-retardant layer of the flame-retardant polymer sheet (P-2) obtained in Synthesis Example 8, and then dried at 120° C. for 1 minute. Thus, a conductive flame-retardant polymer sheet (2) was produced.

In the resultant conductive flame-retardant polymer sheet (2), the thickness of the polymer layer (B) was 85 μm, the thickness of the flame-retardant layer (A) was 15 μm, and the thickness of the conductive layer (L) was 5 μm.

### Comparative Example 1

### Production of Flame-Retardant Polymer Sheet (C1)

The cover film on the flame-retardant layer side of the flame-retardant polymer sheet (P-1) obtained in Synthesis Example 4 was peeled to expose the flame-retardant layer. Thus, a flame-retardant polymer sheet (C1) was obtained.

In the resultant flame-retardant polymer sheet (C1), the thickness of the polymer layer (B) was 175 μm and the thickness of the flame-retardant layer (A) was 25 μm.

The polymer sheets of the examples and the comparative example were subjected to the evaluations. Table 1 shows the results.

TABLE 1

| | Flame | Flame-blocking | Conductivity*³ |
|---|---|---|---|
| | retardancy*¹ | property*² | (Ω/□) |
| Example 1-1 | ∘ | ∘ | 4.2 |
| Example 1-2 | ∘ | ∘ | 4.5 |
| Comparative | ∘ | ∘ | 10.5 |
| Example 1 | | | |

Each of the conductive flame-retardant polymer sheet (1) obtained in Example 1-1 and the conductive flame-retardant polymer sheet (2) obtained in Example 1-2 has excellent conductivity, and at the same time, a high degree of flame retardancy.

### Example 2-1

### Production of Anti-Fingerprint Flame-Retardant Polymer Sheet (1)

A syrup composition obtained by uniformly mixing 95 parts by weight of a polyfunctional acrylate (trade name: “Beam Set 575,” manufactured by ARAKAWA CHEMICAL INDUSTRIES, LTD.), 5 parts by weight of a fluorine-based resin (trade name: “OPTOOL DAC,” manufactured by DAIKIN INDUSTRIES, LTD.), and 0.5 part by weight of a photopolymerization initiator (trade name: “IRGACURE 819,” manufactured by Ciba Specialty Chemicals Inc.) was applied to the release-treated surface of the base material film so that its thickness after curing was 5 μm. Thus, a syrup composition layer was formed. Then, the flame-retardant layer side of the flame-retardant polymer sheet (P-1) obtained in Synthesis Example 4 was attached onto the layer, and then both surfaces of the resultant were simultaneously irradiated with UV light (illuminance: 5 mW/cm²) by using a black-light lamp for 5 minutes. As a result, the layer was cured to form the anti-fingerprint layer (L). Thus, an anti-fingerprint flame-retardant polymer sheet (1) was produced.

In the resultant anti-fingerprint flame-retardant polymer sheet (1), the thickness of the polymer layer (B) was 175 μm, the thickness of the flame-retardant layer (A) was 25 μm, and the thickness of the anti-fingerprint layer (L) was 5 μm.

### Example 2-2

### Production of Anti-Fingerprint Flame-Retardant Polymer Sheet (2)

A syrup composition obtained by uniformly mixing 95 parts by weight of a polyfunctional acrylate (trade name: “Beam Set 575,” manufactured by ARAKAWA CHEMICAL INDUSTRIES, LTD.), 5 parts by weight of a fluorine-based resin (trade name: “OPTOOL DAC,” manufactured by DAIKIN INDUSTRIES, LTD.), and 0.5 part by weight of a photopolymerization initiator (trade name: “IRGACURE 819,” manufactured by Ciba Specialty Chemicals Inc.) was applied to the release-treated surface of the base material film so that its thickness after curing was 5 μm. Thus, a syrup composition layer was formed. Then, the flame-retardant layer side of the flame-retardant polymer sheet (P-2) obtained in Synthesis Example 8 was attached onto the layer, and then both surfaces of the resultant were simultaneously irradiated with UV light (illuminance: 5 mW/cm²) by using a black-light lamp for 5 minutes. As a result, the layer was cured to form the anti-fingerprint layer (L). Thus, an anti-fingerprint flame-retardant polymer sheet (1) was produced.

In the resultant anti-fingerprint flame-retardant polymer sheet (2), the thickness of the polymer layer (B) was 85 μm, the thickness of the flame-retardant layer (A) was 15 μm, and the thickness of the anti-fingerprint layer (L) was 5 μm.

The polymer sheets of the examples and the comparative example were subjected to the evaluations. Table 2 shows the results.

TABLE 2

| | Flame | Flame-blocking | Anti-fingerprint |
|---|---|---|---|
| | retardancy*¹ | property*² | property*³ |
| Example 2-1 | ∘ | ∘ | ∘ |
| Example 2-2 | ∘ | ∘ | ∘ |
| Comparative | ∘ | ∘ | x |
| Example 1 | | | |

Each of the anti-fingerprint flame-retardant polymer sheet (1) obtained in Example 2-1 and the anti-fingerprint flame-retardant polymer sheet (2) obtained in Example 2-2 has excellent anti-fingerprint property, and at the same time, a high level of flame retardancy.

### Example 3-1

### Production of Scratch-Resistant Flame-Retardant Polymer Sheet (1)

An epoxy acrylate-based UV-curable resin (trade name: “Beam Set 374A,” manufactured by ARAKAWA CHEMICAL INDUSTRIES, LTD.) was applied onto the flame-retardant layer of the flame-retardant polymer sheet (P-1) obtained in Synthesis Example 4, and was then dried at 100° C. for 1 minute. After that, the dried product was irradiated with UV light (light quantity: 300 mJ/cm²) by using a metal halide lamp to form the hard coat layer (L). Thus, a scratch-resistant flame-retardant polymer sheet (1) was produced.

In the resultant scratch-resistant flame-retardant polymer sheet (1), the thickness of the polymer layer (B) was 175 μm, the thickness of the flame-retardant layer (A) was 25 μm, and the thickness of the hard coat layer (L) was 5 μm.

### Example 3-2

### Production of Scratch-Resistant Flame-Retardant Polymer Sheet (2)

An epoxy acrylate-based UV-curable resin (trade name: “Beam Set 374A,” manufactured by ARAKAWA CHEMICAL INDUSTRIES, LTD.) was applied onto the flame-retardant layer of the flame-retardant polymer sheet (P-2) obtained in Synthesis Example 8, and was then dried at 100° C. for 1 minute. After that, the dried product was irradiated with UV light (light quantity: 300 mJ/cm²) by using a metal halide lamp to form the hard coat layer (L). Thus, a scratch-resistant flame-retardant polymer sheet (2) was produced.

In the resultant scratch-resistant flame-retardant polymer sheet (2), the thickness of the polymer layer (B) was 85 μm, the thickness of the flame-retardant layer (A) was 15 μm, and the thickness of the hard-coat layer (L) was 5 μm.

The polymer sheets of the examples and the comparative example were subjected to the evaluations. Table 3 shows the results.

TABLE 3

| | Flame | Flame-blocking | Scratch |
|---|---|---|---|
| | retardancy*1 | property*2 | resistance*3 |
| Example 3-1 | ∘ | ∘ | A |
| Example 3-2 | ∘ | ∘ | A |
| Comparative | ∘ | ∘ | C |
| Example 1 | | | |

Each of the scratch-resistant flame-retardant polymer sheet (1) obtained in Example 3-1 and the scratch-resistant flame-retardant polymer sheet (2) obtained in Example 3-2 has excellent scratch-resistant property, and at the same time, has high transparency and a high level of flame retardancy.

### Example 4-1

### Production of Printing Flame-Retardant Polymer Sheet (1)

A20% aqueous solution of a polyvinyl alcohol (KURARAY POVAL “PVA-224,” manufactured by KURARAY CO., LTD.) was applied onto the flame-retardant layer of the flame-retardant polymer sheet (P-1) obtained in Synthesis Example 4, and was then dried at 110° C. for 5 minutes to form the ink-absorbing layer (L). Thus, a printing flame-retardant polymer sheet (1) was produced.

In the resultant printing flame-retardant polymer sheet (1), the thickness of the polymer layer (B) was 175 μm, the thickness of the flame-retardant layer (A) was 25 μm, and the thickness of the ink-absorbing layer (L) was 10 μm.

### Example 4-2

### Production of Printing Flame-Retardant Polymer Sheet (2)

A 20% aqueous solution of a polyvinyl alcohol (KURARAY POVAL “PVA-224,” manufactured by KURARAY CO., LTD.) was applied onto the flame-retardant layer of the flame-retardant polymer sheet (P-2) obtained in Synthesis Example 8, and was then dried at 110° C. for 5 minutes to form the ink-absorbing layer (L). Thus, a printing flame-retardant polymer sheet (2) was produced.

In the resultant printing flame-retardant polymer sheet (2), the thickness of the polymer layer (B) was 85 μm, the thickness of the flame-retardant layer (A) was 15 μm, and the thickness of the ink-absorbing layer (L) was 10 μm.

The polymer sheets of the examples and the comparative example were subjected to the evaluations. Table 4 shows the results.

TABLE 4

| | Flame | Flame-blocking | Printing |
|---|---|---|---|
| | retardancy*¹ | property*² | property*³ |
| Example 4-1 | ∘ | ∘ | ∘ |
| Example 4-2 | ∘ | ∘ | ∘ |
| Comparative | ∘ | ∘ | x |
| Example 1 | | | |

Each of the printing flame-retardant polymer sheet (1) obtained in Example 4-1 and the printing flame-retardant polymer sheet (2) obtained in Example 4-2 has excellent printing property, and at the same time, a high level of flame retardancy.

### Example 5-1

### Production of Flame-Retardant Polymer Sheet (1)

The inorganic particle-containing layer formation material obtained in Synthesis Example 9 was applied onto the flame-retardant layer of the flame-retardant polymer sheet (P-1) obtained in Synthesis Example 4 with a bar coater, and was then dried at 100° C. for 2 minutes to form the inorganic particle-containing layer (L). Thus, a flame-retardant polymer sheet (1) was produced.

In the resultant flame-retardant polymer sheet (1), the thickness of the polymer layer (B) was 175 μm, the thickness of the flame-retardant layer (A) was 25 μm, and the thickness of the inorganic particle-containing layer (L) was 2 μm.

### Example 5-2

### Production of Flame-Retardant Polymer Sheet (2)

The inorganic particle-containing layer formation material obtained in Synthesis Example 9 was applied onto the flame-retardant layer of the flame-retardant polymer sheet (P-2) obtained in Synthesis Example 8 with a bar coater, and was then dried at 100° C. for 2 minutes to form the inorganic particle-containing layer (L). Thus, a flame-retardant polymer sheet (2) was produced.

In the resultant flame-retardant polymer sheet (2), the thickness of the polymer layer (B) was 85 μm, the thickness of the flame-retardant layer (A) was 15 μm, and the thickness of the inorganic particle-containing layer (L) was 2 μm.

### Comparative Example 2

### Production of Polymer Sheet (C2)

The inorganic particle-containing layer formation material obtained in Synthesis Example 9 was applied onto the release-treated surface of a cover film, and was then dried at 100° C. for 2 minutes. Thus, a polymer sheet (C2) was obtained.

The thickness of the resultant polymer sheet (C2) was 50 μm.

The polymer sheets of the examples and the comparative example were subjected to the evaluations. Table 5 shows the results.

TABLE 5

| | | | | Flame retardancy |
|---|---|---|---|---|
| | | | Flame- | of flame- |
| | Flame | High flame | blocking | retardant-treated |
| | retardancy*¹ | retardancy*³ | property*² | product*³ |
| Example 5-1 | ∘ | ∘ | ∘ | ∘ |
| Example 5-2 | ∘ | ∘ | ∘ | ∘ |
| Comparative | ∘ | Δ | ∘ | ∘ |
| Example 1 | | | | |
| Comparative | x | x | x | x |
| Example 2 | | | | |

Each of the flame-retardant polymer sheet (1) obtained in Example 5-1 and the flame-retardant polymer sheet (2) obtained in Example 5-2 has high transparency and extremely high flame retardancy.

### Example 6-1

### Production of Antireflection Flame-Retardant Polymer Sheet (1)

Alumina was deposited from the vapor in a vacuum onto the flame-retardant layer of the flame-retardant polymer sheet (P-1) obtained in Synthesis Example 4 with a vacuum deposition apparatus (model number: VE-2030, manufactured by VACUUM DEVICE INC.) to form the antireflection layer (L). Thus, an antireflection flame-retardant polymer sheet (1) was produced.

In the resultant antireflection flame-retardant polymer sheet (1), the thickness of the polymer layer (B) was 175 μm, the thickness of the flame-retardant layer (A) was 25 μm, and the thickness of the antireflection layer (L) was 0.125 μm.

### Example 6-2

### Production of Antireflection Flame-Retardant Polymer Sheet (2)

Alumina was deposited from the vapor in a vacuum onto the flame-retardant layer of the flame-retardant polymer sheet (P-2) obtained in Synthesis Example 8 with a vacuum deposition apparatus (model number: VE-2030, manufactured by VACUUM DEVICE INC.) to form the antireflection layer (L). Thus, an antireflection flame-retardant polymer sheet (2) was produced.

In the resultant antireflection flame-retardant polymer sheet (2), the thickness of the polymer layer (B) was 85 μm, the thickness of the flame-retardant layer (A) was 15 μm, and the thickness of the antireflection layer (L) was 0.125 μm.

The polymer sheets of the examples and the comparative example were subjected to the evaluations. Table 6 shows the results.

TABLE 6

| | Flame | Flame-blocking | Unnecessary |
|---|---|---|---|
| | retardancy*¹ | property*² | reflection*³ |
| Example 6-1 | ∘ | ∘ | A |
| Example 6-2 | ∘ | ∘ | A |
| Comparative | ∘ | ∘ | D |
| Example 1 | | | |

Each of the antireflection flame-retardant polymer sheet (1) obtained in Example 6-1 and the antireflection flame-retardant polymer sheet (2) obtained in Example 6-2 has excellent antireflection property, and at the same time, a high level of flame retardancy.

### Example 7-1

### Production of Light Selective Transmission Flame-Retardant Polymer Sheet (1)

A multilayer film (multilayer film obtained by alternately laminating a silica (SiO₂) layer and a titania (TiO₂) layer at a lamination number of 25) was formed on the flame-retardant layer side of the flame-retardant polymer sheet (P-1) obtained in Synthesis Example 4 with a vacuum deposition apparatus (manufactured by VACUUM DEVICE INC., model number: VE-2030). Thus, a light selective transmission flame-retardant polymer sheet (1) was produced.

In the resultant light selective transmission flame-retardant polymer sheet (1), the thickness of the polymer layer (B) was 175 μm, the thickness of the flame-retardant layer (A) was 25 μm, and the thickness of the light selective transmission layer (L) was 6 μm.

### Example 7-2

### Production of Light Selective Transmission Flame-Retardant Polymer Sheet (2)

A multilayer film (multilayer film obtained by alternately laminating a silica (SiO₂) layer and a titania (TiO₂) layer at a lamination number of 25) was formed on the flame-retardant layer side of the flame-retardant polymer sheet (P-2) obtained in Synthesis Example 8 with a vacuum deposition apparatus (manufactured by VACUUM DEVICE INC., model number: VE-2030). Thus, a light selective transmission flame-retardant polymer sheet (2) was produced.

In the resultant light selective transmission flame-retardant polymer sheet (2), the thickness of the polymer layer (B) was 85 μm, the thickness of the flame-retardant layer (A) was 15 μm, and the thickness of the light selective transmission layer (L) was 6 μm.

The polymer sheets of the examples and the comparative example were subjected to the evaluations. Table 7 shows the results.

TABLE 7

| | | | Transmittance*³ | |
|---|---|---|---|---|
| | Flame | Flame-blocking | 400 to 600 | 750 to 1,000 |
| | retardancy*¹ | property*² | (nm) | (nm) |
| Example 7-1 | ∘ | ∘ | 85 or more | 5 or less |
| Example 7-2 | ∘ | ∘ | 85 or more | 5 or less |
| Comparative | ∘ | ∘ | 85 or more | 85 or more |
| Example 1 | | | | |

Each of the light selective transmission flame-retardant polymer sheet (1) obtained in Example 7-1 and the light selective transmission flame-retardant polymer sheet (2) obtained in Example 7-2 has excellent light selective transmission property, and at the same time, a high level of flame retardancy.

### Example 8-1

### Production of Alkali-Resistant Flame-Retardant Polymer Sheet (1)

An alkali-resistant paint (trade name: “Silvia WU-200,” aqueous acrylic urethane emulsion paint, manufactured by NIHON TOKUSHU TORYO CO., LTD.) was applied onto the flame-retardant layer of the flame-retardant polymer sheet (P-1) obtained in Synthesis Example 4, and was then dried at 100° C. for 5 minutes to form the alkali-resistant layer (L). Thus, an alkali-resistant flame-retardant polymer sheet (1) was produced.

In the resultant alkali-resistant flame-retardant polymer sheet (1), the thickness of the polymer layer (B) was 175 μm, the thickness of the flame-retardant layer (A) was 25 μm, and the thickness of the alkali-resistant layer (L) was 10 μm.

### Example 8-2

### Production of Alkali-Resistant Flame-Retardant Polymer Sheet (2)

An alkali-resistant paint (trade name: “Silvia WU-200,” aqueous acrylic urethane emulsion paint, manufactured by NIHON TOKUSHU TORYO CO., LTD.) was applied onto the flame-retardant layer of the flame-retardant polymer sheet (P-2) obtained in Synthesis Example 8, and was then dried at 100° C. for 5 minutes to form the alkali-resistant layer (L). Thus, an alkali-resistant flame-retardant polymer sheet (2) was produced.

In the resultant alkali-resistant flame-retardant polymer sheet (2), the thickness of the polymer layer (B) was 85 μm, the thickness of the flame-retardant layer (A) was 15 μm, and the thickness of the alkali-resistant layer (L) was 10 μm.

The polymer sheets of the examples and the comparative example were subjected to the evaluations. Table 8 shows the results.

TABLE 8

| | Flame | Flame-blocking | Alkali |
|---|---|---|---|
| | retardancy*¹ | property*² | resistance*³ |
| Example 8-1 | ∘ | ∘ | ∘ |
| Example 8-2 | ∘ | ∘ | ∘ |
| Comparative | ∘ | ∘ | x |
| Example 1 | | | |

Each of the alkali-resistant flame-retardant polymer sheet (1) obtained in Example 8-1 and the alkali-resistant flame-retardant polymer sheet (2) obtained in Example 8-2 has excellent alkali resistance, and at the same time, a high level of flame retardancy.

### Example 9-1

### Production of Acid-Resistant Flame-Retardant Polymer Sheet (1)

An acid-resistant paint (trade name: “SULPHOTITE 10,” phenol resin-based paint, manufactured by Nippon Paint. Co., Ltd.) was applied onto the flame-retardant layer of the flame-retardant polymer sheet (P-1) obtained in Synthesis Example 4, and was then dried at 120° C. for 1 minute to form the acid-resistant layer (L). Thus, an acid-resistant flame-retardant polymer sheet (1) was produced.

In the resultant acid-resistant flame-retardant polymer sheet (1), the thickness of the polymer layer (B) was 175 μm, the thickness of the flame-retardant layer (A) was 25 μm, and the thickness of the acid-resistant layer (L) was 10 μm.

### Example 9-2

### Production of Acid-Resistant Flame-Retardant Polymer Sheet (2)

An acid-resistant paint (trade name: “SULPHOTITE 10,” phenol resin-based paint, manufactured by Nippon Paint Co., Ltd.) was applied onto the flame-retardant layer of the flame-retardant polymer sheet (P-2) obtained in Synthesis Example 8, and was then dried at 120° C. for 1 minute to form the acid-resistant layer (L). Thus, an acid-resistant flame-retardant polymer sheet (2) was produced.

In the resultant acid-resistant flame-retardant polymer sheet (2), the thickness of the polymer layer (B) was 85 μm, the thickness of the flame-retardant layer (A) was 15 μm, and the thickness of the acid-resistant layer (L) was 10 μm.

The polymer sheets of the examples and the comparative example were subjected to the evaluations. Table 9 shows the results.

TABLE 9

| | Flame | Flame-blocking | Acid |
|---|---|---|---|
| | retardancy*¹ | property*² | resistance*³ |
| Example 9-1 | ∘ | ∘ | ∘ |
| Example 9-2 | ∘ | ∘ | ∘ |
| Comparative | ∘ | ∘ | x |
| Example 1 | | | |

Each of the acid-resistant flame-retardant polymer sheet (1) obtained in Example 9-1 and the acid-resistant flame-retardant polymer sheet (2) obtained in Example 9-2 has excellent acid-resistant property, and at the same time, a high level of flame retardancy.

### Example 10-1

### Production of Solvent-Resistant Flame-Retardant Polymer Sheet (1)

A solvent-resistant paint (trade name: “BONDIC 1310NE,” water-dispersible urethane resin-based paint, manufactured by Dainippon Ink & Chemicals, Inc.) was applied onto the flame-retardant layer of the flame-retardant polymer sheet (P-1) obtained in Synthesis Example 4, and was then dried at 120° C. for 1 minute to form the solvent-resistant layer (L). Thus, a solvent-resistant flame-retardant polymer sheet (1) was produced.

In the resultant solvent-resistant flame-retardant polymer sheet (1), the thickness of the polymer layer (B) was 175 μm, the thickness of the flame-retardant layer (A) was 25 μm, and the thickness of the solvent-resistant layer (L) was 10 μm.

### Example 10-2

### Production of Solvent-Resistant Flame-Retardant Polymer Sheet (2)

A solvent-resistant paint (trade name: “BONDIC 1310NE,” water-dispersible urethane resin-based paint, manufactured by Dainippon Ink & Chemicals, Inc.) was applied onto the flame-retardant layer of the flame-retardant polymer sheet (P-2) obtained in Synthesis Example 8, and was then dried at 120° C. for 1 minute to form the solvent-resistant layer (L). Thus, a solvent-resistant flame-retardant polymer sheet (2) was produced.

In the resultant solvent-resistant flame-retardant polymer sheet (2), the thickness of the polymer layer (B) was 85 μm, the thickness of the flame-retardant layer (A) was 15 μm, and the thickness of the solvent-resistant layer (L) was 10 μm.

The polymer sheets of the examples and the comparative example were subjected to the evaluations. Table 10 shows the results.

TABLE 10

| | Flame | Flame-blocking | Solvent |
|---|---|---|---|
| | retardancy*¹ | property*² | resistance*³ |
| Example 10-1 | ∘ | ∘ | ∘ |
| Example 10-2 | ∘ | ∘ | ∘ |
| Comparative | ∘ | ∘ | x |
| Example 1 | | | |

Each of the solvent-resistant flame-retardant polymer sheet (1) obtained in Example 10-1 and the solvent-resistant flame-retardant polymer sheet (2) obtained in Example 10-2 has excellent solvent-resistant property, and at the same time, has a high level of flame retardancy.

### INDUSTRIAL APPLICABILITY

The physically functional flame-retardant polymer member and chemically functional flame-retardant polymer member of the present invention can make various adherends flame-retardant, and at the same time, can impart physical functionality or chemical functionality to the various adherends, by being attached to the various adherends.

### REFERENCE SIGNS LIST

A flame-retardant layer
B polymer layer
L physically functional layer or chemically functional layer a polymerizable composition layer
a′ polymerizable composition layer
a1 unevenly distributed polymerizable composition layer
a2 unevenly distributed polymer layer
a11, a21 unevenly distributed portion of layered inorganic compound
a12, a22 non-unevenly distributed portion of layered inorganic compound
b monomer-absorbing layer
b′ polymerizable composition layer
b1 monomer-absorbing layer
b2 cured monomer-absorbing layer
C cover film
D base material film
E monomer-absorbable sheet with base material
X laminate
f incompatible layered inorganic compound
m1 polymerizable monomer
m2 polymerizable monomer
p2 polymer

1. A physically functional flame-retardant polymer member, comprising a polymer layer (B), a flame-retardant layer (A), and a physically functional layer (L) in the stated order, wherein the flame-retardant layer (A) comprises a layer containing a layered inorganic compound (f) in a polymer.

2. A physically functional flame-retardant polymer member according to claim 1, wherein the physically functional layer (L) has a thickness of 0.005 to 100 μm.

3. A physically functional flame-retardant polymer member according to claim 1, wherein in a horizontal firing test involving horizontally placing the flame-retardant polymer member with its side of the physically functional layer (L) as a lower surface so that the lower surface is in contact with air, placing a Bunsen burner so that a flame port of the Bunsen burner is positioned at a lower portion distant from the lower surface on the side of the physically functional layer (L) by 45 mm, and bringing a flame of the Bunsen burner having a height of 55 mm from the flame port into contact with the lower surface of the physically functional layer (L) for 30 seconds while preventing the flame from being in contact with an end portion of the flame-retardant polymer member, the flame-retardant polymer member has flame retardancy capable of blocking the flame.

4. A physically functional flame-retardant polymer member according to claim 1, wherein the physically functional layer (L) comprises a conductive layer (L).

5. A physically functional flame-retardant polymer member according to claim 1, wherein the physically functional layer (L) comprises an anti-fingerprint layer (L).

6. A physically functional flame-retardant polymer member according to claim 1, wherein the physically functional layer (L) comprises a hard coat layer (L).

7. A physically functional flame-retardant polymer member according to claim 1, wherein the physically functional layer (L) comprises an ink-absorbing layer (L).

8. A physically functional flame-retardant polymer member according to claim 1, wherein the physically functional layer (L) comprises an inorganic particle-containing layer (L).

9. A physically functional flame-retardant polymer member according to claim 1, wherein the physically functional layer (L) comprises an antireflection layer (L).

10. A physically functional flame-retardant polymer member according to claim 1, wherein the physically functional layer (L) comprises a light selective transmission layer (L).

11. A chemically functional flame-retardant polymer member, comprising a polymer layer (B), a flame-retardant layer (A), and a chemically functional layer (L) in the stated order, wherein the flame-retardant layer (A) comprises a layer containing a layered inorganic compound (f) in a polymer.

12. A chemically functional flame-retardant polymer member according to claim 11, wherein the chemically functional layer (L) has a thickness of 0.1 to 100 μm.

13. A chemically functional flame-retardant polymer member according to claim 11, wherein in a horizontal firing test involving horizontally placing the flame-retardant polymer member with its side of the chemically functional layer (L) as a lower surface so that the lower surface is in contact with air, placing a Bunsen burner so that a flame port of the Bunsen burner is positioned at a lower portion distant from the lower surface on the side of the chemically functional layer (L) by 45 mm, and bringing a flame of the Bunsen burner having a height of 55 mm from the flame port into contact with the lower surface of the chemically functional layer (L) for 30 seconds while preventing the flame from being in contact with an end portion of the flame-retardant polymer member, the flame-retardant polymer member has flame retardancy capable of blocking the flame.

14. A chemically functional flame-retardant polymer member according to claim 11, wherein the chemically functional layer (L) comprises an alkali-resistant layer (L).

15. A chemically functional flame-retardant polymer member according to claim 11, wherein the chemically functional layer (L) comprises an acid-resistant layer (L).

16. A chemically functional flame-retardant polymer member according to claim 11, wherein the chemically functional layer (L) comprises a solvent-resistant layer (L).
